(19) United States
(12) Patent Application Publication
(10) Pub. No.: US 2023/0097205 A1
(43) Pub. Date: Mar. 30, 2023

(54) COMPOSITION AND METHOD FOR PRODUCING SILICONE COMPOUNDS, AND USE THEREOF

(71) Applicant: PolyU GmbH, Oberhausen (DE)

(72) Inventors: Klaus LANGERBEINS, Oberhausen (DE); Michael SENZLOBER, Oberhausen (DE)

(73) Assignee: PolyU GmbH, Oberhausen (DE)

(21) Appl. No.: 17/802,845

(22) PCT Filed: Mar. 2, 2021
(86) PCT No.: PCT/EP2021/055172

§ 371 Date: Sep. 30, 2022

(30) Foreign Application Priority Data
Mar. 3, 2020 (EP) 20160750.4

(51) Int. Cl. C08G 77/16; C08G 77/08; C08L 83/04; C08K 5/5465; C08K 3/36; C09K 3/10

(52) U.S. Cl. CPC C08G 77/16; C08G 77/08; C08L 83/04; C08K 5/5465; C08K 3/36; C09K 3/1018; C08L 2205/06; C08L 2205/025; C08L 2312/08; C09K 2200/0685

(57) ABSTRACT

The invention relates to a composition and a method for producing moisture-crosslinking silicones with catalysis by at least two different catalysts A and B, a related process and the use of the composition, in particular, in sealants, adhesives, joint compounds or coating agents.

Silicone rubber compounds, so-called RTV (room temperature curing or vulcanizing) silicone rubber compounds, have been known for quite some time as materials having elastic properties. They are often used as sealing compounds or adhesives, for example, for glass, metals (for example, aluminum), plastics, wood, ceramics, stone or porcelain. They are widely used as adhesives or sealants in the construction industry (in particular, in the plumbing sector) and as coating materials in the electrical and electronics industry. The so-called one-component RTV silicone rubber compounds are plastically moldable mixtures of α,ω-dihydroxypolyorganosiloxanes and suitable hardeners or, more specifically, crosslinking agents.

Primarily polyorganosiloxanes, which carry two or more functional groups, are used together with a crosslinker, in order to produce silicone rubber compounds. In this case α,ω-dihydroxypolyorganosiloxanes are very important as difunctional polyorganosiloxanes. Known crosslinkers are characterized by at least two hydrolyzable groups, i.e., leaving groups are released by hydrolysis. The leaving groups allow the crosslinkers to be classified into neutral, acidic or basic systems. Known leaving groups are, for example, carboxylic acids, alcohols and oximes.

EP 2 030 976 B1 describes silane compounds as crosslinkers that release α-hydroxycarboxylic acid esters during crosslinking. DE 202015009122 U1 discloses silane crosslinkers having α-hydroxycarboxamides as the leaving group.

It is known that the polymerization (crosslinking, curing) of silicone rubber compounds at room temperature in the presence of atmospheric moisture can be accelerated by the addition of a suitable curing catalyst (catalyst).

In particular, tin compounds are very important in this case. DE 69501063 T2 describes the use of dibutyltin bis(acetylacetonate) and tin octylate in silicone elastomer compositions that cure at room temperature. EP 0298877 B1 describes a tin catalyst comprising tin oxide and beta-dicarbonyl compounds for silicone elastomer compositions. DE 4332037 A1 uses dibutyltin dilaurate as a catalyst in condensation-crosslinking silicone.

Tin compounds are generally characterized by a very high catalytic activity. Due to their toxic properties, however, they are disadvantageous.

Tin-free catalysts are also known, for example, based on aluminum, zinc, zirconium and titanium compounds. DE 4210349 A1 describes the use of tetrabutyl titanate, dibutyl bis(methyl acetoacetate)titanate, diisopropyl bis(methyl acetoacetate)titanate and diisobutyl bis(ethyl acetoacetate)titanate in the production of silicone rubber compounds. EP 0102268 A1 discloses silicone rubber compositions that comprise, for example, organic zirconium compounds as a catalyst.

The drawback with using tin-free catalysts is the fact that the catalytic activities are comparatively low. Such low catalytic activities may also have an adverse effect on the mechanical properties of the resulting silicone rubber compounds.

EP 3392313 A1 describes a catalyst that is based on a metal siloxane-silanol(ate) compound. Metal siloxane-silanol(ate) compounds are basically known to the person skilled in the art, for example, also from WO 2005/060671 A2 and EP 2796493 A1. However, these compounds are difficult to produce and to process. Therefore, they are expensive.

Therefore, one object of the present invention is to provide compositions for the production of silicone rubber compounds that overcome at least one of the disadvantages mentioned above. In particular, it is an object of the present invention to provide compositions for the production of silicone rubber compounds that are effective, on the one hand, but also inexpensive, on the other hand. The desired mechanical properties of the silicone rubber compounds that can be produced with said compositions should not be adversely affected by said compositions. Ideally, the composition should be ecologically and toxicologically acceptable. In another aspect of the invention a composition of the present invention enables an increased processing time, for example, as a result of a longer skin formation time.

The aforesaid object is achieved by using a catalyst mixture of at least two different catalysts, with only one of the catalysts being a metal siloxane-silanol(ate) compound.

Therefore, the subject matter of the invention is a composition for producing curable silicone rubber compositions comprising at least two catalysts A and B, where catalyst A comprises at least one metal siloxane-silanol(ate) compound, and catalyst B is different from said catalyst A. Thus, catalyst B is selected from a group of catalysts that does not comprise metal siloxane-silanol(ate) compounds.

In particular, the subject matter of the present invention is a composition for producing a silicone rubber compound, comprising or obtainable by mixing at least the following components:
a. at least one hydroxy-functionalized polyorganosiloxane compound
b. at least one crosslinker
c. at least two different catalysts A and B, where the catalyst A is selected from the group of metal siloxane-silanol(ate) compounds, and catalyst B is selected from a group of catalysts that does not comprise metal siloxane-silanol(ate) compounds.

Surprisingly it has been found that the catalyst mixture of the present invention has a high catalytic activity when used in silicone rubber compounds. The high catalytic activity makes it possible to reduce the amount or proportion of the metal siloxane-silanol(ate) compound (catalyst A) without having to accept any significant losses in the catalytic activity. This aspect has significant economic advantages.

Advantageously in this case the use of a tin catalyst can be minimized or perhaps avoided altogether. Therefore, it is particularly preferred that the composition of the present invention be free of tin. This aspect is ecologically advantageous and user-friendly.

Furthermore, it could be determined that the curing and complete hardening time of the composition of the present invention is significantly reduced. In addition, the composition of the present invention enables longer skin formation and tack-free times. This aspect allows the user to have a larger processing window in the production of silicone rubber compounds. If catalysts of identical weight are used, then this processing window can be extended, for example, by approx. 30%, with a simultaneous reduction in the complete hardening time of approx. 35%.

An additional advantage of the invention consists of the fact that the silicone rubber compounds, which are produced using the composition of the present invention, are softer than those which are produced when a catalyst A or B is used alone.

The mechanical properties of a silicone rubber compound can also be influenced by using the catalyst mixture of the present invention. Thus, the elongation at break of the silicone rubber compounds is improved as compared to silicone rubber compounds that comprise the customary tin catalysts or when metal siloxane-silanol(ate) compounds are used exclusively as a catalyst.

Therefore, the subject matter of the invention is also a method for providing silicone rubber compounds having
an elongation at break of 100-800%
a Shore A hardness of 0-50.

In one advantageous embodiment the metal siloxane-silanol(ate) compound (catalyst A) is used in a molar concentration of 0.000001 to 0.01 mol/kg, preferably in the range of 0.000005 to 0.005 mol/kg of sealant and particularly preferably in the range of 0.00007 to 0.001 mol/kg.

The proportion by weight of the metal siloxane-silanol compound in the overall composition is advantageously 0.001 to 0.5% by weight, preferably 0.006 to 0.10% by weight.

It is particularly preferred that the catalyst A and the catalyst B be used in a molar ratio of 1:2.2 in a weight ratio of 1:1.66.

It is even more particularly preferred that the catalyst A and the catalyst B be used in a weight ratio of 1.1:0.9 to 0.9:1.1.

It is extremely preferred that the catalysts be used in a weight ratio of 1:1.

In order to increase the viscosity (=setting agent, so that the material does not flow out when, for example, grouting) and for the purpose of building up strength, the composition of the present invention comprises preferably silica, most preferably fumed silica.

In particular, the object of the present invention is achieved and the advantages, described above, are achieved through the use of TiPOSS as catalyst A in combination with a catalyst B, selected from the group of metal catalysts, such as bismuth neodecanoate, zinc(II) 2-ethylhexanoate, titanium tetraisopropylate, titanium tetrabutylate, aluminum tri-sec-butylate, zirconium tetraisopropylate, zirconium tetrabutylate or dibutyltin dilaurate, particularly preferably through the use of TiPOSS (catalyst A) and bismuth(III) tris(neodecanoate) (catalyst B) in a composition of the present invention.

### Definitions

For the purposes of the invention “silanols” are organic silicon compounds, in which at least one hydroxy group (OH) is bonded to the silicon atom (≡Si—OH).

For the purposes of the invention “silanolates” are organic silicon compounds, in which at least one deprotonated hydroxy function (R—O—) is bonded to the silicon atom (≡Si—O—), where this negatively charged oxygen atom can also be bonded to other compounds, such as, for example, metals, and/or can be coordinated.

The term “alkyl group” is to be understood as meaning a saturated hydrocarbon chain. Alkyl groups have, in particular, the general formula —Cₙ H₂ₙ₊ᵢ. The term “C1 to C16 alkyl group” refers, in particular, to a saturated hydrocarbon chain having from 1 to 16 carbon atoms in the chain. Examples of C1 to C16 alkyl groups are methyl, ethyl, n-propyl, n-butyl, isopropyl, isobutyl, sec-butyl, tert-butyl, n-pentyl and ethylhexyl. Correspondingly a “C1 to C8 alkyl group” refers, in particular, to a saturated hydrocarbon chain having from 1 to 8 carbon atoms in the chain. In particular, alkyl groups can also be substituted, even if this is not specifically stated.

“Straight-chain alkyl groups” refer to alkyl groups that have no branches. Examples of straight-chain alkyl groups are methyl, ethyl, n-propyl, n-butyl, n-pentyl, n-hexyl, n-heptyl and n-octyl.

“Branched alkyl groups” refer to alkyl groups that are not straight-chain, i.e., in which, therefore, the hydrocarbon chain has, in particular, a fork. Examples of branched alkyl groups are isopropyl, isobutyl, sec-butyl, tert-butyl, sec-pentyl, 3-pentyl, 2-methylbutyl, isopentyl, 3-methylbut-2-yl, 2-methylbut-2-yl, neopentyl, ethylhexyl, and 2-ethylhexyl.

“Alkenyl groups” refer to hydrocarbon chains that have at least one double bond along the chain. For example, an alkenyl group having a double bond has, in particular, the general formula —CₙH₂ₙ₋₁. However, alkenyl groups may also have more than one double bond. The term “C2 to C16 alkenyl group” refers, in particular, to a hydrocarbon chain having from 2 to 16 carbon atoms in the chain. In this case the number of hydrogen atoms varies as a function of the number of double bonds in the alkenyl group. Examples of alkenyl groups are vinyl, allyl, 2-butenyl and 2-hexenyl.

“Straight-chain alkenyl groups” refer to alkenyl groups that have no branches. Examples of straight-chain alkenyl groups are vinyl, allyl, n-2-butenyl and n-2-hexenyl.

“Branched alkenyl groups” refer to alkenyl groups that are not straight-chain, i.e., in which, therefore, the hydrocarbon chain has, in particular, a fork. Examples of branched alkenyl groups are 2-methyl-2-propenyl, 2-methyl-2-butenyl and 2-ethyl-2-pentenyl.

“Aryl groups” refer to monocyclic (for example, phenyl), bicyclic (for example, indenyl, naphthalenyl, tetrahydronaphthyl or tetrahydroindenyl) and tricyclic (for example, fluorenyl, tetrahydrofluorenyl, anthracenyl or tetrahydroanthracenyl) ring systems, in which the monocyclic ring system or at least one of the rings in a bicyclic or tricyclic ring system is aromatic. In particular, a C4 to C14 aryl group refers to an aryl group having from 4 to 14 carbon atoms. In particular, aryl groups may also be substituted, even if this is not specifically stated.

An “aromatic group” refers to cyclic, planar hydrocarbons having an aromatic system. An aromatic group having from 4 to 14 carbon atoms refers, in particular, to an aromatic group that has from 4 to 14 carbon atoms. The aromatic group may be, in particular, monocyclic, bicyclic or tricyclic. Furthermore, an aromatic group may also have from 1 to 5 heteroatoms, selected from the group consisting of N, O, and S. Examples of aromatic groups are benzene, naphthalene, anthracene, phenanthrene, furan, pyrrole, thiophene, isoxazole, pyridine and quinoline, where in the aforementioned examples the necessary number of hydrogen atoms is removed in each case to allow incorporation into the corresponding structural formula.

A “cycloalkyl group” refers to a hydrocarbon ring that is not aromatic. In particular, a cycloalkyl group having from 4 to 14 carbon atoms refers to a non-aromatic hydrocarbon ring having from 4 to 14 carbon atoms. Cycloalkyl groups may be saturated or partially unsaturated. Saturated cycloalkyl groups are not aromatic and do not have double or triple bonds. In contrast to saturated cycloalkyl groups, partially unsaturated cycloalkyl groups have at least one double or triple bond, but the cycloalkyl group is not aromatic. In particular, cycloalkyl groups may also be substituted, even if this is not specifically stated.

An “aralkyl group” refers to an alkyl group substituted with an aryl group. A “C5 to C15 aralkyl group” refers, in particular, to an aralkyl group having from 5 to 15 carbon atoms and comprising both the carbon atoms of the alkyl group and the aryl group. Examples of aralkyl groups are benzyl and phenylethyl. In particular, aralkyl groups may also be substituted, even if this is not specifically stated.

A “cyclic ring system” refers to a hydrocarbon ring that is not aromatic. In particular, a cyclic ring system having from 4 to 14 carbon atoms refers to a non-aromatic hydrocarbon ring system having from 4 to 14 carbon atoms. A cyclic ring system can consist of a single hydrocarbon ring (monocyclic), two hydrocarbon rings (bicyclic) or three hydrocarbon rings (tricyclic).

In particular, cyclic ring systems can also have from 1 to 5 heteroatoms, selected preferably from the group consisting of N, O, and S.

“Saturated cyclic ring systems” are not aromatic, nor do they have double or triple bonds. Examples of saturated cyclic ring systems are cyclopentane, cyclohexane, decalin, norbornane and 4H-pyran, where in the aforementioned examples the necessary number of hydrogen atoms is removed in each case, in order to allow incorporation into the corresponding structural formula. For example, in a structural formula HOR*—CH3, where R* is a cyclic ring system having 6 carbon atoms, in particular, cyclohexane, two hydrogen atoms would be removed from the cyclic ring system, in particular, cyclohexane, in order to allow incorporation into the structural formula.

Unless stated otherwise, N denotes, in particular, nitrogen. Furthermore, O denotes, in particular, oxygen, unless stated otherwise. S denotes, in particular, sulfur, unless stated otherwise.

“Optionally substituted” means that in the corresponding group or in the corresponding radical, respectively, hydrogen atoms may be replaced by substituents. Substituents may be selected, in particular, from the group consisting of C1 to C4 alkyl, methyl, ethyl, propyl, butyl, phenyl, benzyl, halogen, fluorine, chlorine, bromine, iodine, hydroxy, amino, alkylamino, dialkylamino, C1 to C4 alkoxy, phenoxy, benzyloxy, cyano, nitro, and thio. If a group is referred to as optionally substituted, then 0 to 50, in particular, 0 to 20, hydrogen atoms of the group may be replaced by substituents. If a group is substituted, then at least one hydrogen atom is replaced by a substituent.

“Alkoxy” refers to an alkyl group that is linked to the main carbon chain via an oxygen atom.

The term “an alkylate” is to be understood as meaning an alcoholate or also alkoxide of the corresponding alkane. For example, a methanolate is the alcoholate of methyl. Alcoholates, including alkoxides, are salts of metal cations and alcoholate anions, for example, sodium methanolate (NaOCH₃).

The “tear strength” is one of the mechanical properties of polymers that can be determined by means of various test methods. The tear strength is the quotient (σ_{R}) of the force F_{R}, measured at the moment that the test specimen tears, and the initial cross section A₀ of the test specimen.

The “elongation at break” is the ratio of the change in length to the initial length after the test specimen has broken. Said elongation at break expresses the ability of a material to withstand changes in shape without cracking. It is the quotient (ε_{R}) of the change L_{R}-L₀ in the gauge length L_{R}, measured at the moment that the test specimen tears, and the initial gauge length L₀ of the test specimen.

The “stress value” is the quotient (σᵢ) of the tensile force Fᵢ, which is present when a certain elongation is reached, and the initial cross section A₀.

The determination of the tensile strength, elongation at break and stress values in the tensile test is carried out in accordance with DIN 53504:2017-03.

The “resilience” describes the tendency of a flexible substrate to return partially or totally to its original dimensions after the forces that caused the expansion or deformation have been removed. The average resilience is determined according to DIN EN ISO 7389:2004-04.

“Shore hardness” is a common specification of the hardness of an elastic material. Said Shore hardness is tested using a Shore hardness tester (durometer), comprising a spring-loaded stylus made of hardened steel. Its penetration depth into the material to be tested is a measure of the Shore hardness, which is measured on a scale from 0 Shore (2.5 millimeters penetration depth) to 100 Shore (0 millimeters penetration depth). Thus, a high number denotes a high hardness. A distinction is made between Shore A, Shore B, Shore C and Shore D hardness as a function of the truncated cone that presses into the test specimen and is used for the measurement.

The “Shore A” value is specified for elastomers, measured with a blunt-tipped needle. The end face of the truncated cone has a diameter of 0.79 millimeters; and the opening angle is 35°. Load weight: 1 kg, holding time: 15 seconds. Hand-held measuring devices usually have to be read immediately when pressed on the test specimen. The displayed value decreases as the holding time increases. The value 0 for the Shore A hardness corresponds approximately to the firmness of gelatin; the value 10 corresponds to the firmness of a jelly bean. Values of 50 to 70 correspond to the strength of car tires; and the Shore A value of 100 describes the hardness of hard plastic. Shore A hardness is determined according to ASTM D2240-15.

“Sealing agents” or “sealing compounds” refer to elastic substances, applied in liquid to viscous form or as flexible profiles or webs, for sealing a surface, in particular, against water, gases or other media.

The term “sealant,” as used herein, describes the cured composition of the present invention in accordance with any one of the claims.

The term “adhesive” refers to substances that join mating members through surface adherence (adhesion) and/or internal strength (cohesion). This term covers, in particular, glue, paste, dispersants, solvents, reactants and contact adhesives.

“Coating agents” are any and all agents for coating a surface.

For the purposes of the invention “potting compounds” or also “cable potting compounds” are compounds that are to be processed under hot or cold conditions in order to pot cables and/or cable accessories.

For the purposes of the invention “silicone rubber compounds” are synthetic silicone-comprising rubber compounds, which are also referred to interchangeably as curable silicone compositions in the scope of this invention, a term that includes rubber, polymers, polycondensates, and polyadducts that can be converted into the highly elastic, cured state by crosslinking with suitable crosslinkers. Furthermore, they are plastically moldable mixtures, which comprise, for example, α,ω-dihydroxypolyorganosiloxanes and suitable hardeners or, more specifically, crosslinking agents and which can be stored in the absence of moisture.

However, these silicone rubber compounds polymerize at room temperature under the influence of water or atmospheric moisture.

“RTV silicone rubber compounds” can be divided into one and two component systems. The first group (RTV-1) cures at room temperature under the influence of atmospheric moisture, with crosslinking occurring through condensation of SiOH groups to form Si—O bonds. The SiOH groups are formed by hydrolysis of hydrolyzable groups on the silicon atom of an intermediate species, formed from a polymer with terminal OH groups and a so-called crosslinker Si(R)ₘ(R^{a})₄₋ₘ. Known leaving groups are, for example, carboxylic acids, alcohols and oximes. In the case of two-component rubbers (RTV-2), on the other hand, for example mixtures of silicic acid esters (for example, ethyl silicate) and organotin compounds are used as a crosslinker, with the formation of a Si—O—Si bridge, formed from Si—OR and Si—OH, taking place as a crosslinking reaction through elimination of alcohol.

“Polymers” are chemical compounds consisting of chain or branched molecules (macromolecules), which in turn consist of a number of identical/similar or even dissimilar units, the so-called monomers. In this case polymers also include oligomers. Oligomers are polymers that have a smaller number of units. Unless explicitly defined otherwise, oligomers of the present invention fall under the terminology of polymers. Polymers can occur as homopolymers (=consist of only one monomer unit), copolymers (=consist of two or more monomer units) or as polymer mixtures (=polymer alloys, polymer blends, i.e., mixtures of different polymers and copolymers).

“Silicone rubbers” are compounds that can be converted into the rubber-elastic state and comprise polyorganosiloxanes that have groups that are accessible for crosslinking reactions. Such suitable groups include predominantly hydrogen atoms, hydroxy groups and vinyl groups, which are located at the chain ends, but can also be incorporated into the chain. Silicone rubbers comprise reinforcing substances and fillers, the type and amount of which have a significant impact on the mechanical and chemical properties of the silicone elastomers produced by crosslinking. Silicone rubbers can be colored with suitable pigments. A distinction is made, as a function of the necessary crosslinking temperature, between cold curing (RTV) and hot curing (HTV) silicone rubbers (RTV=room temperature curing, HTV=high temperature curing).

The term “polysiloxane” or “polyorganosiloxane” describes a composition of the present invention that comprises at least one organosilicone compound, preferably two, three or more different organosilicone compounds. One organosilicone compound, present in the composition, is preferably an oligomeric compound or a polymeric compound.

The polymeric organosilicone compound is preferably a difunctional polyorganosiloxane compound, more preferably a hydroxy-functionalized polyorganosiloxane compound, most preferably an α,ω-dihydroxyl-terminated polyorganosiloxane. Extremely strong preference is given to α,ω-dihydroxyl-terminated polydiorganosiloxanes, in particular, α,ω-dihydroxyl-terminated polydialkylsiloxanes, α,ω-dihydroxyl-terminated polydialkenylsiloxanes or α,ω-dihydroxyl-terminated polydiarylsiloxanes. In addition to homopolymeric α,ω-dihydroxyl-terminated polydiorganosiloxanes, heteropolymeric α,ω-dihydroxyl-terminated polydiorganosiloxanes having different organic substituents can also be used. In this case both copolymers, consisting of monomers with the same organic substituents on a silicon atom, and copolymers, consisting of monomers with different organic substituents on a silicon atom, are included, for example, those with mixed alkyl, alkenyl and/or aryl substituents. The preferred organic substituents comprise straight-chain and branched alkyl groups having from 1 to 8 carbon atoms, in particular, methyl, ethyl, n-propyl, isopropyl, and n-, sec- and tert-butyl, vinyl and phenyl. In this case some or all of the carbon-bonded hydrogen atoms can be substituted in the individual organic substituents by conventional substituents, such as halogen atoms or functional groups, such as hydroxyl and/or amino groups. Thus, α,ω-dihydroxyl-terminated polydiorganosiloxanes having partially fluorinated or perfluorinated organic substituents can be used; or α,ω-dihydroxyl-terminated polydiorganosiloxanes having organic substituents, substituted by hydroxyl and/or amino groups, on the silicon atoms are used.

Particularly preferred organosilicone compounds are α,ω-dihydroxyl-terminated polydialkylsiloxanes, such as, for example, α,ω-dihydroxyl-terminated polydimethylsiloxanes, α,ω-dihydroxyl-terminated polydiethylsiloxanes or α,ω-dihydroxyl-terminated polydivinylsiloxanes, as well as α,ω-dihydroxyl-terminated polydiarylsiloxanes, such as, for example, α,ω-dihydroxyl-terminated polydiphenylsiloxanes. In this case polyorganosiloxanes, which have a kinematic viscosity (according to DIN 53019-1:2008-09) of 5,000 to 120,000 cSt (at 25° C.), are particularly preferred, especially those with a viscosity of 20,000 to 100,000 cSt, and most preferably those with a viscosity of 40,000 to 90,000 cSt. Mixtures of polydiorganosiloxanes of different viscosities can also be used.

In a most highly preferred embodiment the hydroxy-functionalized polyorganosiloxane compound that is used in the composition of the present invention is α,ω-dihydroxyl-terminated polydimethylsiloxane, most preferably α,ω-dihydroxyl-terminated polydimethylsiloxane with a kinematic viscosity (according to DIN 53019-1:2008-09) of about 80,000 cSt.

“Crosslinkers” (synonym: hardeners) or, as an alternative, “silane crosslinkers” are to be understood as meaning, in particular, crosslinkable silane compounds that have at least two groups that can be split off by hydrolysis. Possible examples of such crosslinkable silane compounds are Si(OCH₃)₄, Si(CH₃)(OCH₃)₃ and Si(CH₃)(C₂HS)(OCH₃)₂. Crosslinkers can also be referred to as “hardeners.” “Crosslinker” or even “reactive silane crosslinkers” also include, in particular, “crosslinker systems” that may comprise more than one crosslinkable silane compound.

“Hydroxycarboxylic acid ester crosslinkers” are crosslinkers of the general formula Si(R)ₘ(R^{a})₄₋ₘ, where m can be 0, 1 or 2. In particular, m can be an integer from 0 to 3, if at least one R is an alkoxy radical, and R^{a} is a hydroxycarboxylic acid ester radical having the general structural formula (A) and is defined as below.

“Hydroxycarboxamide crosslinkers” are crosslinkers of the general formula Si(R)ₘ(R^{a})₄₋ₘ, where m=0, 1 or 2. In particular, m can be an integer from 0 to 3, if at least one R is an alkoxy radical, and R^{a} is a hydroxycarboxamide radical having the general structural formula (B) and is defined as below.

“Salicylate crosslinkers” are crosslinkers of the general formula Si(R)ₘ(R^{a})₄₋ₘ, where m=0, 1 or 2. In particular, m can be an integer from 0 to 3, if at least one R is an alkoxy radical, and R^{a} is a salicylic acid radical having the general structural formula (C1), (C2) or (C3) and is defined as below.

“Oxime crosslinkers” are crosslinkers of the general formula Si(R)ₘ(R^{a})₄₋ₘ, where m=0, 1 or 2. In particular, m can be an integer from 0 to 3, if at least one R is an alkoxy radical, and R^{a} is an oxime radical having the general structural formula (D) and is defined as below.

“Carboxamide crosslinkers” are crosslinkers of the general formula Si(R)ₘ(R^{a})₄₋ₘ, where m=0, 1 or 2. In particular, m can be an integer from 0 to 3, if at least one R is an alkoxy radical, and R^{a} is a carboxamide radical of the general formula —N(R^{j})—C(O)—R^{j}, where R^{j} is defined as below.

“Acetate crosslinkers” are crosslinkers of the general formula Si(R)ₘ(R^{a})₄₋ₘ, where m=0, 1 or 2. In particular, m can be an integer from 0 to 3, if at least one R is an alkoxy radical, and R^{a} is an acetic acid radical of the general formula —O—C(O)—R^{f}, where R^{f} is methyl.

“Amine crosslinkers” are crosslinkers of the general formula Si(R)ₘ(R^{a})₄₋ₘ, where m can be 0, 1 or 2. In particular, m can be an integer from 0 to 3, if at least one R is an alkoxy radical, and R^{a} is an amine radical having the general formula —NH(R^{l}), where R^{l} is defined as below.

According to the invention, the composition can also comprise a mixture of at least two different crosslinkers. For example, a combination of a salicylate crosslinker and an oxime crosslinker or a combination of two different salicylate crosslinkers can be used. The use of mixtures of crosslinkers in the curing of polyorganosiloxanes can have advantageous properties. Thus, for example, the proportion of a toxicologically unsafe, foul-smelling and/or expensive crosslinker can be reduced. In particular, the combination of different crosslinkers can affect the properties of the resulting silicone rubber compounds. Owing to the different reactivities of the crosslinkers, the material properties of the cured silicone rubber compounds can be controlled accordingly. Oxime crosslinkers tend to produce firmer silicone rubber compounds and have longer tack-free and skin formation times, whereas acetate crosslinkers produce softer silicone rubber compounds and make shorter tack-free and skin formation times possible.

The person skilled in the art knows that exchange reactions between the different groups R^{a} of the different compounds can also occur in mixtures, comprising crosslinkers and having different compounds of the general formula Si(R)ₘ(R^{a})₄₋ₘ. In particular, these exchange reactions can run as far as up to a state of equilibrium. This process can also be referred to as equilibration.

Suitable crosslinkers for the purposes of the invention are crosslinkers of the general formula Si(R)ₘ(R^{a})₄₋ₘ, where each R denotes, independently of each other, an optionally substituted hydrocarbon radical having from 1 to 20 carbon atoms, in particular, an optionally substituted, straight-chain or branched C1 to C16 alkyl group, an optionally substituted, straight-chain or branched C2 to C16 alkenyl group and/or an optionally substituted C4 to C14 aryl group and/or denotes an alkoxy radical —OR^{k}, where R^{k} denotes an optionally substituted hydrocarbon radical having from 1 to 20 carbon atoms, in particular, an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group; and m is an integer from 0 to 2; in particular, m is an integer from 0 to 3. If at least one R is an alkoxy radical, then each R^{a} is selected, independently of each other, from the group consisting of
a hydroxycarboxylic acid ester radical having the general structural formula (A):

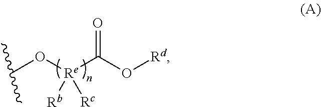

where each R denotes, independently of each other, H or an optionally substituted hydrocarbon radical having from 1 to 20 carbon atoms, in particular, an optionally substituted, straight-chain or branched C1 to C16 alkyl group or an optionally substituted C4 to C14 aryl group,
each R^{c} denotes, independently of each other, H or an optionally substituted hydrocarbon radical having from 1 to 20 carbon atoms, in particular, an optionally substituted, straight-chain or branched C1 to C16 alkyl group or an optionally substituted C4 to C14 aryl group,
R^{d} denotes H or an optionally substituted hydrocarbon radical having from 1 to 20 carbon atoms, in particular, an optionally substituted, straight-chain or branched C1 to C16 alkyl group, an optionally substituted C4 to C14 cycloalkyl group, an optionally substituted C5 to C15 aralkyl group or an optionally substituted C4 to C14 aryl group,
R^{e} denotes a carbon atom or an optionally substituted hydrocarbon radical having from 0 to 20 carbon atoms, in particular, an optionally substituted saturated or partially unsaturated cyclic ring system having from 4 to 14 carbon atoms or an optionally substituted aromatic group having 4 to 14 carbon atoms; and n is an integer from 1 to 10,
or oligomers or polymers of the crosslinker,
where
if R^{e} is a carbon atom, then R^{b} and R^{c} do not denote H; and R^{b} does not denote H; and R^{c} does not denote methyl; and R^{b} does not denote methyl; and R^{c} does not denote H,
a hydroxycarboxamide radical having the general structural formula (B):

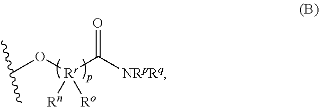

where
each Rⁿ denotes, independently of each other, H or an optionally substituted hydrocarbon radical having from 1 to 20 carbon atoms, in particular, an optionally substituted, straight-chain or branched C1 to C16 alkyl group or an optionally substituted C4 to C14 aryl group,
each R^{o} denotes, independently of each other, H or an optionally substituted hydrocarbon radical having from 1 to 20 carbon atoms, in particular, an optionally substituted, straight-chain or branched C1 to C16 alkyl group or an optionally substituted C4 to C14 aryl group,
R^{p} and R^{q} denote, independently of each other, H or an optionally substituted hydrocarbon radical having from 1 to 20 carbon atoms, in particular, an optionally substituted, straight-chain or branched C1 to C16 alkyl group, an optionally substituted C4 to C14 cycloalkyl group, an optionally substituted C5 to C15 aralkyl group or an optionally substituted C4 to C14 aryl group,
R^{r} denotes a carbon atom or an optionally substituted hydrocarbon radical having from 0 to 20 carbon atoms, in particular, an optionally substituted saturated or partially unsaturated cyclic ring system having from 4 to 14 carbon atoms or an optionally substituted aromatic group having 4 to 14 carbon atoms, and
p is an integer from 1 to 10,
a salicylic acid radical having the general structural formula (C1), (C2), (C3) or mixtures thereof:

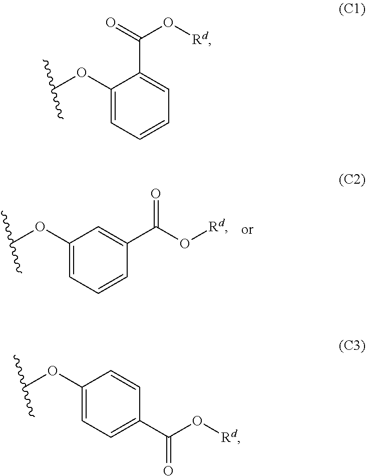

where
each R^{d} denotes, independently of each other, H or an optionally substituted hydrocarbon radical having from 1 to 20 carbon atoms, in particular, an optionally substituted, straight-chain or branched C1 to C16 alkyl group, a C5 to C15 aralkyl group or an optionally substituted C4 to C14 aryl group,
an oxime radical having the general structural formula (D):

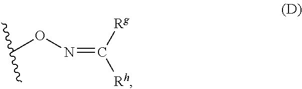

where
R^{g} and R^{h} denote, independently of each other, H or an optionally substituted hydrocarbon radical having from 1 to 20 carbon atoms, in particular, an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group,
a carboxamide radical —N(Rⁱ)—C(O)—R^{j}, where Rⁱ denotes H or an optionally substituted hydrocarbon radical having from 1 to 20 carbon atoms, in particular, an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group; and R¹ denotes H or an optionally substituted hydrocarbon radical having from 1 to 20 carbon atoms, in particular, an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group,
a carboxylic acid radical —O—C(O)—R^{f}, where R^{f} denotes H or an optionally substituted hydrocarbon radical having from 1 to 20 carbon atoms, in particular, an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group,
in particular, an acetic acid radical —O—C(O)—R^{f}, where R^{f} is methyl (acetate crosslinker), and/or
an amine radical —NH(R′), where R^{l} denotes H or an optionally substituted hydrocarbon radical having from 1 to 20 carbon atoms, in particular, an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group, and
R^{j} denotes H or an optionally substituted hydrocarbon radical having from 1 to 20 carbon atoms, in particular, an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group.

### Hydroxycarboxylic Acid Crosslinker

In the general structural formula (A) the hydroxycarboxylic acid ester radical is bonded to the silicon atom via the oxygen atom of the hydroxy group. For example, a compound, present in the crosslinker according to the invention and having the general structural formula Si(R)ₘ(R^{a})₄₋ₘ, in which m=1, can have the general structural formula (Aa):

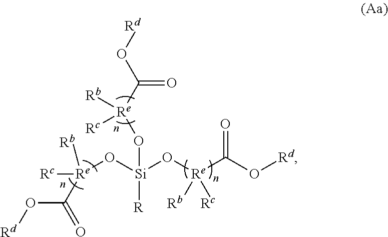

where
each R^{b} denotes, independently of each other, H or an optionally substituted hydrocarbon radical having from 1 to 20 carbon atoms, in particular, an optionally substituted, straight-chain or branched C1 to C16 alkyl group or an optionally substituted C4 to C14 aryl group,
each R^{c} denotes, independently of each other, H or an optionally substituted hydrocarbon radical having from 1 to 20 carbon atoms, in particular, an optionally substituted, straight-chain or branched C1 to C16 alkyl group or an optionally substituted C4 to C14 aryl group,
R^{d} denotes H or an optionally substituted hydrocarbon radical having from 1 to 20 carbon atoms, in particular, an optionally substituted, straight-chain or branched C1 to C16 alkyl group, an optionally substituted C4 to C14 cycloalkyl group, an optionally substituted C5 to C15 aralkyl group or an optionally substituted C4 to C14 aryl group,
R^{e} denotes a carbon atom or an optionally substituted hydrocarbon radical having from 0 to 20 carbon atoms, in particular, an optionally substituted saturated or partially unsaturated cyclic ring system having from 4 to 14 carbon atoms or an optionally substituted aromatic group having 4 to 14 carbon atoms, and n is an integer from 1 to 10,
or oligomers or polymers of the crosslinker,
where
if R^{e} is a carbon atom, then R^{b} and R^{c} do not denote H; and R^{b} does not denote H; and R^{c} does not denote methyl; and R^{b} does not denote methyl; and R^{c} does not denote H.

### Lactate Crosslinker

According to one embodiment of the general structural formula (Ab), R^{a} has the general structural formula (A), described herein, where R^{e} is a carbon atom, R is methyl, and R^{c} is H, where R^{d} denotes H, methyl, ethyl, n-propyl, isopropyl, n-butyl, isobutyl, sec-butyl, tert-butyl, 2-ethylhexyl, vinyl or phenyl; and R is selected preferably from the group consisting of methyl, ethyl, n-propyl, isopropyl, n-butyl, isobutyl, sec-butyl, tert-butyl, 2-ethylhexyl, vinyl or phenyl. It is particularly preferred that R^{d} be selected from the group consisting of methyl and ethyl or n-propyl. It is highly preferred that R^{d} be ethyl, so that the radical (A) in the general structural formula (Ab) or (Ac) stands for 2-hydroxypropionic acid ethyl ester. In particular, said general structural formula comprises, according to the invention, the pure racemates (R)-2-hydroxypropionic acid ethyl ester (D(+)-lactic acid ethyl ester) and (S)-2-hydroxypropionic acid ethyl ester (L(−)-lactic acid ethyl ester) or mixtures thereof, including a racemic mixture. It is particularly preferred that R be selected from the group consisting of methyl, ethyl or vinyl.

Furthermore, a lactate crosslinker can also be present as oligomers or polymers of the crosslinker,

where
if R^{e} is a carbon atom, then R^{b} and R^{c} do not denote H; and R does not denote H; and R^{c} does not denote methyl; and R does not denote methyl; and R^{c} does not denote H.

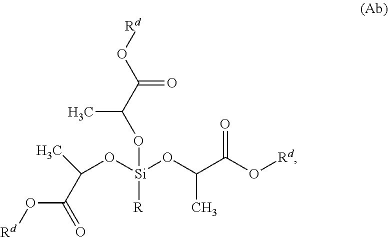

According to another embodiment of the invention, in the compound having the general structural formula Si(R)ₘ(R^{a})₄₋ₘ, m=1, R denotes vinyl; and R^{a} has the general structural formula (A), described herein, where R^{e} denotes C; R^{b} denotes methyl; R^{c} denotes H; and R^{d} denotes methyl. This compound is also referred to, in particular, as tris(methyl lactate)vinylsilane.

According to a further embodiment of the invention, in the compound having the general structural formula Si(R)ₘ(R^{a})₄₋ₘ, m=1, R denotes phenyl; and R^{a} has the general structural formula (A), described herein, where R^{e} denotes C; R^{b} denotes methyl; R^{c} denotes H; and R^{d} denotes methyl. This compound is also referred to, in particular, as tris(methyl lactate)phenylsilane.

According to a further embodiment of the invention, in the compound having the general structural formula Si(R)ₘ(R^{a})₄₋ₘ, m=1, R denotes propyl; and R^{a} has the general structural formula (A), described herein, where R^{e} denotes C; R^{b} denotes methyl; R^{c} denotes H; and R^{d} denotes methyl. This compound is also referred to, in particular, as tris(methyl lactate)propylsilane.

According to a further embodiment of the invention, in the compound having the general structural formula Si(R)ₘ(R^{a})₄₋ₘ, m=1, R denotes methyl; and R^{a} has the general structural formula (A), described herein, where R^{e} denotes C; R^{b} denotes methyl; R^{c} denotes H; and R^{d} denotes methyl. This compound is also referred to, in particular, as tris(methyl lactate)methylsilane.

According to a further embodiment of the invention, in the compound having the general structural formula Si(R)ₘ(R^{a})₄₋ₘ, m=1, R denotes ethyl; and R^{a} has the general structural formula (A), described herein, where R^{e} denotes C; R^{b} denotes methyl; R^{c} denotes H; and R^{d} denotes methyl. This compound is also referred to, in particular, as tris(methyl lactate)ethylsilane.

According to another embodiment of the invention, in the compound having the general structural formula Si(R)ₘ(R^{a})₄₋ₘ, m=1, R denotes vinyl; and R^{a} has the general structural formula (A), described herein, where R^{e} denotes C; R^{b} denotes methyl; R^{c} denotes H; and R^{d} denotes ethyl. This compound is also referred to, in particular, as tris(ethyl lactate)vinylsilane.

According to a further embodiment of the invention, in the compound having the general structural formula Si(R)ₘ(R^{a})₄₋ₘ, m=1, R denotes phenyl; and R^{a} has the general structural formula (A), described herein, where R^{e} denotes C; R^{b} denotes methyl; R^{c} denotes H; and R^{d} denotes ethyl. This compound is also referred to, in particular, as tris(ethyl lactate)phenylsilane.

According to a further embodiment of the invention, in the compound having the general structural formula Si(R)ₘ(R^{a})₄₋ₘ, m=1, R denotes propyl; and R^{a} has the general structural formula (A), described herein, where R^{c} denotes C; R^{b} denotes methyl; R^{c} denotes H; and R^{d} denotes ethyl. This compound is also referred to, in particular, as tris(ethyl lactate)propylsilane.

According to a further embodiment of the invention, in the compound having the general structural formula Si(R)ₘ(R^{a})₄₋ₘ, m=1, R denotes methyl; and R^{a} has the general structural formula (A), described herein, where R^{e} denotes C; R^{b} denotes methyl; R^{c} denotes H; and R^{d} denotes ethyl. This compound is also referred to, in particular, as tris(ethyl lactate)methylsilane.

According to a further embodiment of the invention, in the compound having the general structural formula Si(R)ₘ(R^{a})₄₋ₘ, m=1, R denotes ethyl; and R^{a} has the general structural formula (A), described herein, where R^{e} denotes C; R^{b} denotes methyl; R^{c} denotes H; and R^{d} denotes ethyl. This compound is also referred to, in particular, as tris(ethyl lactate)ethylsilane.

According to one embodiment of the general structural formula (Ac), R^{a} has the general structural formula (A), described herein, where R^{e} is C; R is methyl; and R^{c} is H, where R^{d} denotes H, methyl, ethyl, n-propyl, isopropyl, n-butyl, isobutyl, sec-butyl, tert-butyl, 2-ethylhexyl, vinyl or phenyl. Particular preference is given to R^{d}, selected from the group consisting of methyl and ethyl or n-propyl.

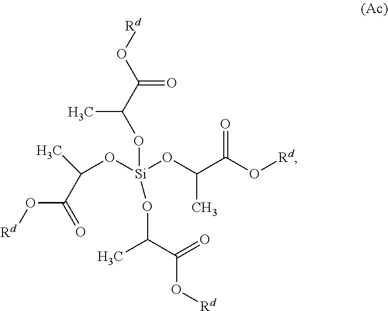

According to another alternative embodiment of the invention, in the compound having the general structural formula Si(R)ₘ(R^{a})₄₋ₘ, m=0. R^{a} has the general structural formula (A), described herein, where R^{e} denotes C; R^{b} denotes methyl; R^{c} denotes H; and R^{d} denotes ethyl. This compound is also referred to, in particular, as tetra(ethyl lactate)silane.

According to another alternative embodiment of the invention, in the compound having the general structural formula Si(R)ₘ(R^{a})₄₋ₘ, m=0. R^{a} has the general structural formula (A), described herein, where R^{c} denotes C; R^{b} denotes methyl; R^{c} denotes H; and R^{d} denotes methyl. This compound is also referred to, in particular, as tetra(methyl lactate)silane.

Furthermore, each radical R^{a} may be different, when multiple radicals R^{a} are bonded to the silicon atom. R^{e}, R^{b}, and R^{c} are defined as above. Furthermore, if R^{e} is a carbon atom, then the radicals R^{b} and R^{c} may be different, independently of each other, for each carbon atom of the chain along the carbon chain —(CR^{b}R^{c})ₙ—, where n is an integer from 1 to 10. R^{d} is defined as described herein. Oligomers and polymers of the crosslinker are, in particular, at least two monomeric compounds having the general structural formula Si(R)ₘ(R^{a})₄₋ₘ, in which at least two silicon atoms of the different monomers are linked to each other via siloxane oxygens. The number of radicals R^{a} is reduced in proportion to the number of binding siloxane oxygens on the silicon atom.

### Salicylate Crosslinker

According to another embodiment of the invention, R^{a} has the general structural formula (C1), where R^{d} is defined as described herein. In the general structural formula (C1), the salicylic acid radical is bonded to the silicon atom via the oxygen atom of the hydroxy group. For example, a compound, present in the crosslinker according to the invention and having the general structural formula Si(R)ₘ(R^{a})₄₋ₘ, in which m=1, can have, according to this embodiment, the general structural formula (Ca):

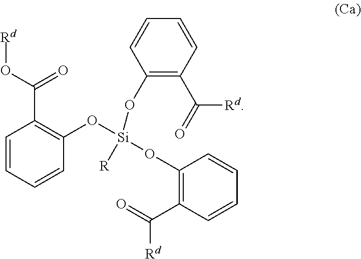

According to an alternative embodiment of the invention, R^{a} has the general structural formula (C1), (C2) or (C3), where R^{a} may be further substituted. In particular, the phenyl ring may be substituted, particularly preferably be substituted with another aryl; and R^{d} is defined as described herein.

In an alternative embodiment of the general structural formula (C1), the salicylic acid radical is bonded to the silicon atom via the oxygen atom of the hydroxy group; and the phenyl ring is further substituted, preferably with another aryl. For example, a compound, present in the crosslinker according to the invention and having the general structural formula Si(R)ₘ(R^{a})₄₋ₘ, in which m=1, can have, according to this embodiment, the general structural formula (Caa):

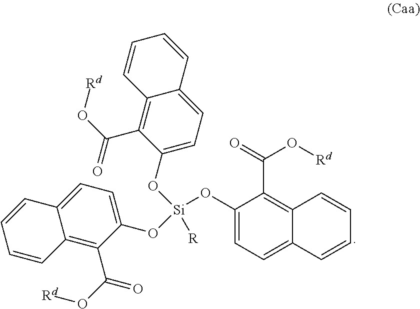

According to another embodiment of the invention, R^{a} has the general structural formula (C2), where R^{d} is defined as described herein. In the general structural formula (C2) the salicylic acid radical is bonded to the silicon atom via the oxygen atom of the hydroxy group. For example, a compound, present in the crosslinker according to the invention and having the general structural formula Si(R)ₘ(R^{a})₄₋ₘ, in which m=1, can have, according to this embodiment, the general structural formula (Cb):

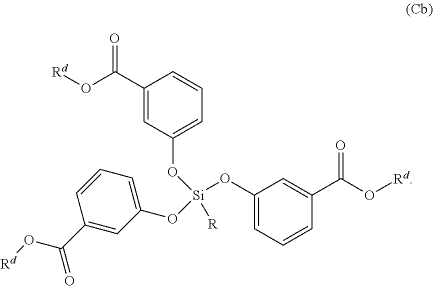

According to another embodiment of the invention, R^{a} has the general structural formula (C3), where R^{d} is defined as described herein. In the general structural formula (C3) the salicylic acid radical is bonded to the silicon atom via the oxygen atom of the hydroxy group. For example, a compound, present in the crosslinker according to the invention and having the general structural formula Si(R)ₘ(R^{a})₄₋ₘ, in which m=1, can have, according to this embodiment, the general structural formula (Cc):

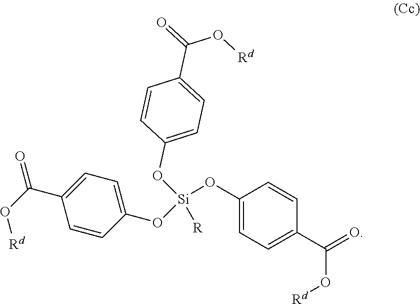

It has been found that such hardeners have positive properties for sealant formulations. On the one hand, such hardeners release salicylic acid derivatives, which are toxicologically harmless, during hydrolysis. In addition, it has been found that such hardeners lead to good mechanical properties of the sealants when used in sealants. Furthermore, sealants, comprising these hardeners, are also colorless and transparent.

According to one embodiment, in the general structural formula (C1), R^{d} is selected, in particular, from the group consisting of methyl, ethyl, n-propyl, isopropyl, n-butyl and 2-ethylhexyl. In the general structural formula (C1) particular preference is given to R^{d}, selected from the group consisting of ethyl and 2-ethylhexyl. It is known that crosslinkers, comprising such compounds, can have particularly positive properties for sealant formulations, in particular, with respect to their mechanical properties.

According to another embodiment of the invention, in the compound having the general structural formula Si(R)ₘ(R^{a})₄₋ₘ, m=1, R denotes vinyl; and R^{a} has the general structural formula (C1), described herein, where R^{d} denotes ethyl. This compound is also referred to, in particular, as tris(ethyl salicylate)vinylsilane or also as ortho-tris(ethyl salicylate)vinylsilane.

According to a further embodiment of the invention, in the compound having the general structural formula Si(R)ₘ(R^{a})₄₋ₘ, m=1, R denotes methyl; and R^{a} has the general structural formula (C1), described herein, where R^{d} denotes ethyl. This compound is also referred to, in particular, as tris(ethyl salicylate)methylsilane or also as ortho-tris(ethyl salicylate)methylsilane.

According to a further embodiment of the invention, in the compound having the general structural formula Si(R)ₘ(R^{a})₄₋ₘ, m=1, R denotes propyl; and R^{a} has the general structural formula (C1), described herein, where R^{d} denotes ethyl. This compound is also referred to, in particular, as tris(ethyl salicylate)propylsilane or also as ortho-tris(ethyl salicylate)propylsilane.

According to a further embodiment of the invention, in the compound having the general structural formula Si(R)ₘ(R^{a})₄₋ₘ, m=1, R denotes phenyl; and R^{a} has the general structural formula (C1), described herein, where R^{d} denotes ethyl. This compound is also referred to, in particular, as tris(ethyl salicylate)phenylsilane or also as ortho-tris(ethyl salicylate)phenylsilane.

According to a further embodiment of the invention, in the compound having the general structural formula Si(R)ₘ(R^{a})₄₋ₘ, m=1, R denotes vinyl; and R^{a} has the general structural formula (C1), described herein, where R^{d} denotes 2-ethylhexyl. This compound is also referred to, in particular, as tris(2-ethylhexyl salicylate)vinylsilane or also as ortho-tris(2-ethylhexyl salicylate)vinylsilane.

According to a further embodiment of the invention, in the compound having the general structural formula Si(R)ₘ(R^{a})₄₋ₘ, m=1, R denotes methyl; and R^{a} has the general structural formula (C1), described herein, where R^{d} denotes 2-ethylhexyl. This compound is also referred to, in particular, as tris(2-ethylhexyl salicylate)methylsilane or also as ortho-tris(2-ethylhexyl salicylate)methylsilane.

According to a further embodiment of the invention, in the compound having the general structural formula Si(R)ₘ(R^{a})₄₋ₘ, m=1, R denotes ethyl; and R^{a} has the general structural formula (C1), described herein, where R^{d} denotes 2-ethylhexyl. This compound is also referred to, in particular, as tris(2-ethylhexyl salicylate)ethylsilane or also as ortho-tris(2-ethylhexyl salicylate)ethylsilane.

According to a further embodiment of the invention, in the compound having the general structural formula Si(R)ₘ(R^{a})₄₋ₘ, m=1, R denotes propyl; and R^{a} has the general structural formula (C1), described herein, where R^{d} denotes 2-ethylhexyl. This compound is also referred to, in particular, as tris(2-ethylhexyl salicylate)propylsilane or also as ortho-tris(2-ethylhexyl salicylate)propylsilane.

According to a further embodiment of the invention, in the compound having the general structural formula Si(R)ₘ(R^{a})₄₋ₘ, m=1, R denotes phenyl; and R^{a} has the general structural formula (C1), described herein, where R^{d} denotes 2-ethylhexyl. This compound is also referred to, in particular, as tris(2-ethylhexyl salicylate)phenylsilane or also as ortho-tris(2-ethylhexyl salicylate)phenylsilane.

According to another embodiment of the invention, in the compound having the general structural formula (Caa), R denotes vinyl; and R^{d} denotes ethyl. This compound is also referred to, in particular, as tris(2-naphthalenecarboxylic acid-3-hydroxyethyl)vinylsilane.

According to a further embodiment of the invention, in the compound having the general structural formula (Caa), R denotes methyl; and R^{d} denotes ethyl. This compound is also referred to, in particular, as tris(2-naphthalenecarboxylic acid-3-hydroxyethyl)methylsilane.

According to a further embodiment of the invention, in the compound having the general structural formula (Caa), R and R^{d} each denote ethyl. This compound is also referred to, in particular, as tris(2-naphthalenecarboxylic acid-3-hydroxyethyl)ethylsilane.

According to a further embodiment of the invention, in the compound having the general structural formula (Caa), R denotes propyl; and R^{d} denotes ethyl. This compound is also referred to, in particular, as tris(2-naphthalenecarboxylic acid-3-hydroxyethyl)propylsilane.

According to a further embodiment of the invention, in the compound having the general structural formula (Caa), R denotes phenyl; and R^{d} denotes ethyl. This compound is also referred to, in particular, as tris(2-naphthalenecarboxylic acid-3-hydroxyethyl)phenylsilane.

According to one embodiment, in the general structural formula (C2), R^{d} is selected, in particular, from the group consisting of methyl, ethyl, n-propyl, isopropyl, n-butyl and 2-ethylhexyl. In the general structural formula (C2) particular preference is given to R^{d}, selected from the group consisting of ethyl and 2-ethylhexyl. It is known that crosslinkers, comprising such compounds, can have particularly positive properties for sealant formulations, in particular, with respect to their mechanical properties.

According to another embodiment of the invention, in the compound having the general structural formula Si(R)ₘ(R^{a})₄₋ₘ, m=1, R denotes vinyl; and R^{a} has the general structural formula (C2), described herein, where R^{d} denotes ethyl. This compound is also referred to, in particular, as meta-tris(ethyl salicylate)vinylsilane.

According to a further embodiment of the invention, in the compound having the general structural formula Si(R)ₘ(R^{a})₄₋ₘ, m=1, R denotes methyl; and R^{a} has the general structural formula (C2), described herein, where R^{d} denotes ethyl. This compound is also referred to, in particular, as meta-tris(ethyl salicylate)methylsilane.

According to a further embodiment of the invention, in the compound having the general structural formula Si(R)ₘ(R^{a})₄₋ₘ, m=1, R denotes ethyl; and R^{a} has the general structural formula (C2), described herein, where R^{d} denotes ethyl. This compound is also referred to, in particular, as meta-tris(ethyl salicylate)ethylsilane.

According to a further embodiment of the invention, in the compound having the general structural formula Si(R)ₘ(R^{a})₄₋ₘ, m=1, R denotes propyl; and R^{a} has the general structural formula (C2), described herein, where R^{d} denotes ethyl. This compound is also referred to, in particular, as meta-tris(ethyl salicylate)propylsilane.

According to a further embodiment of the invention, in the compound having the general structural formula Si(R)ₘ(R^{a})₄₋ₘ, m=1, R denotes phenyl; and R^{a} has the general structural formula (C2), described herein, where R^{d} denotes ethyl. This compound is also referred to, in particular, as meta-tris(ethyl salicylate)phenylsilane.

According to a further embodiment of the invention, in the compound having the general structural formula Si(R)ₘ(R^{a})₄₋ₘ, m=1, R denotes vinyl; and R^{a} has the general structural formula (C2), described herein, where R^{d} denotes 2-ethylhexyl. This compound is also referred to, in particular, as meta-tris(2-ethylhexyl salicylate)vinylsilane.

According to a further embodiment of the invention, in the compound having the general structural formula Si(R)ₘ(R^{a})₄₋ₘ, m=1, R denotes methyl; and R^{a} has the general structural formula (C2), described herein, where R^{d} denotes 2-ethylhexyl. This compound is also referred to, in particular, as meta-tris(2-ethylhexyl salicylate)methylsilane.

According to a further embodiment of the invention, in the compound having the general structural formula Si(R)ₘ(R^{a})₄₋ₘ, m=1, R denotes ethyl; and R^{a} has the general structural formula (C2), described herein, where R^{d} denotes 2-ethylhexyl. This compound is also referred to, in particular, as meta-tris(2-ethylhexyl salicylate)ethylsilane.

According to a further embodiment of the invention, in the compound having the general structural formula Si(R)ₘ(R^{a})₄₋ₘ, m=1, R denotes propyl; and R^{a} has the general structural formula (C2), described herein, where R^{d} denotes 2-ethylhexyl. This compound is also referred to, in particular, as meta-tris(2-ethylhexyl salicylate)propylsilane.

According to a further embodiment of the invention, in the compound having the general structural formula Si(R)ₘ(R^{a})₄₋ₘ, m=1, R denotes phenyl; and R^{a} has the general structural formula (C2), described herein, where R^{d} denotes 2-ethylhexyl. This compound is also referred to, in particular, as meta-tris(2-ethylhexyl salicylate)phenylsilane.

According to one embodiment, in the general structural formula (C3), R^{d} is selected, in particular, from the group consisting of methyl, ethyl, n-propyl, isopropyl, n-butyl and 2-ethylhexyl. In the general structural formula (C3) particular preference is given to R^{d}, selected from the group consisting of ethyl and 2-ethylhexyl. It is known that crosslinkers, comprising such compounds, can have particularly positive properties for sealant formulations, in particular, with respect to their mechanical properties.

According to another embodiment of the invention, in the compound having the general structural formula Si(R)ₘ(R^{a})₄₋ₘ, m=1, R denotes vinyl; and R^{a} has the general structural formula (C3), described herein, where R^{d} denotes ethyl. This compound is also referred to, in particular, as para-tris(ethyl salicylate)vinylsilane.

According to a further embodiment of the invention, in the compound having the general structural formula Si(R)ₘ(R^{a})₄₋ₘ, m=1, R denotes methyl; and R^{a} has the general structural formula (C3), described herein, where R^{d} denotes ethyl. This compound is also referred to, in particular, as para-tris(ethyl salicylate)methylsilane.

According to a further embodiment of the invention, in the compound having the general structural formula Si(R)ₘ(R^{a})₄₋ₘ, m=1, R denotes ethyl; and R^{a} has the general structural formula (C3), described herein, where R^{d} denotes ethyl. This compound is also referred to, in particular, as para-tris(ethyl salicylate)ethylsilane.

According to a further embodiment of the invention, in the compound having the general structural formula Si(R)ₘ(R^{a})₄₋ₘ, m=1, R denotes propyl; and R^{a} has the general structural formula (C3), described herein, where R^{d} denotes ethyl. This compound is also referred to, in particular, as para-tris(ethyl salicylate)propylsilane.

According to a further embodiment of the invention, in the compound having the general structural formula Si(R)ₘ(R^{a})₄₋ₘ, m=1, R denotes phenyl; and R^{a} has the general structural formula (C3), described herein, where R^{d} denotes ethyl. This compound is also referred to, in particular, as para-tris(ethyl salicylate)phenylsilane.

According to a further embodiment of the invention, in the compound having the general structural formula Si(R)ₘ(R^{a})₄₋ₘ, m=1, R denotes vinyl; and R^{a} has the general structural formula (C3), described herein, where R^{d} denotes 2-ethylhexyl. This compound is also referred to, in particular, as para-tris(2-ethylhexyl salicylate)vinylsilane.

According to a further embodiment of the invention, in the compound having the general structural formula Si(R)ₘ(R^{a})₄₋ₘ, m=1, R denotes methyl; and R^{a} has the general structural formula (C3), described herein, where R^{d} denotes 2-ethylhexyl. This compound is also referred to, in particular, as para-tris(2-ethylhexyl salicylate)methylsilane.

According to a further embodiment of the invention, in the compound having the general structural formula Si(R)ₘ(R^{a})₄₋ₘ, m=1, R denotes ethyl; and R^{a} has the general structural formula (C3), described herein, where R^{d} denotes 2-ethylhexyl. This compound is also referred to, in particular, as para-tris(2-ethylhexyl salicylate)ethylsilane.

According to a further embodiment of the invention, in the compound having the general structural formula Si(R)ₘ(R^{a})₄₋ₘ, m=1, R denotes propyl; and R^{a} has the general structural formula (C3), described herein, where R^{d} denotes 2-ethylhexyl. This compound is also referred to, in particular, as para-tris(2-ethylhexyl salicylate)propylsilane.

According to a further embodiment of the invention, in the compound having the general structural formula Si(R)ₘ(R^{a})₄₋ₘ, m=1, R denotes phenyl; and R^{a} has the general structural formula (C3), described herein, where R^{d} denotes 2-ethylhexyl. This compound is also referred to, in particular, as para-tris(2-ethylhexyl salicylate)phenylsilane.

In another embodiment of the invention a salicylate crosslinker can also have four radicals R^{a} on the silicon atom, with the salicylic acid radical being bonded to the silicon atom via the oxygen atom of the hydroxy group, and a compound, present in the crosslinker according to the invention and having the general structural formula Si(R)ₘ(R^{a})₄₋ₘ, in which m=0, where R^{a} has the general structural formula (C1), (C2) or (C3); and R^{d} is defined as described herein.

Practical tests have shown that optimal results are achieved when the compound, present in the crosslinker according to the invention and having the general structural formula Si(R)ₘ(R^{a})₄₋ₘ, is selected from the group consisting of tris(ethyl salicylate)vinylsilane, tris(ethyl salicylate)methylsilane, tris(ethyl salicylate)ethylsilane, tris(ethyl salicylate)propylsilane, tris(ethyl salicylate)phenylsilane, tris(2-ethylhexyl salicylate)vinylsilane, tris(2-ethylhexyl salicylate)methylsilane, tris(2-ethylhexyl salicylate)propylsilane, tris(2-ethylhexyl salicylate)phenylsilane, tris(2-naphthalenecarboxylic acid-3-hydroxyethyl)vinylsilane, tris(2-naphthalenecarboxylic acid-3-hydroxyethyl)methylsilane, tris(2-naphthalenecarboxylic acid-3-hydroxyethyl))ethylsilane, tris(2-naphthalenecarboxylic acid-3-hydroxyethyl)propylsilane, tris(2-naphthalenecarboxylic acid-3-hydroxyethyl)phenylsilane and/or the respective corresponding meta or para compounds thereof. It has been shown that crosslinkers, comprising one of these preferred compounds, produce sealant formulations that have good properties. On the one hand, these sealants release salicylic acid derivatives, which are toxicologically harmless. On the other hand, colorless and transparent sealants can be obtained. In addition, sealant formulations with crosslinkers, comprising one of these preferred compounds, have good mechanical properties.

In a particularly preferred embodiment the salicylate crosslinker that is used in the composition of the present invention is tris(2-ethylhexyl salicylate)vinylsilane, tris(2-ethylhexyl salicylate)methylsilane, tris(2-ethylhexyl salicylate)propylsilane or mixtures thereof, most preferably tris(2-ethylhexyl salicylate)propylsilane.

Oxime Crosslinker

In the general structural formula (D), the oxime radical is bonded to the silicon atom via the oxygen atom of the hydroxy group. For example, a compound, present in the crosslinker according to the invention and having the general structural formula Si(R)ₘ(R^{a})₄₋ₘ, in which m=0, can have the general structural formula (Da):

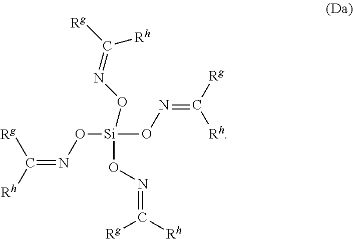

Consequently in the compound having the general structural formula Si(R)ₘ(R^{a})₄₋ₘ, there may also be no R, and correspondingly four radicals R^{a} may be present, when four radicals R^{a} are bonded to the silicon atom. R^{g} and R^{h} are defined as above.

According to one embodiment of the general structural formula (Da), R^{a} has the general structural formula (D), described herein, where R^{g} and R^{h} are selected, independently of each other, in particular, from the group consisting of methyl, ethyl, n-propyl, isopropyl, n-butyl, isobutyl, sec-butyl, tert-butyl, 2-ethylhexyl, vinyl and phenyl. It is particularly preferred that R^{g} and R^{h} be selected, independently of each other, from the group consisting of methyl and ethyl, n-propyl.

According to another embodiment of the invention, in the compound having the general structural formula Si(R)ₘ(R^{a})₄₋ₘ, m=0. R^{a} has the general structural formula (D), described herein, where R^{g} denotes n-propyl; and R^{h} denotes methyl. This compound is also referred to, in particular, as tetra(2-pentanone oxime)silane.

According to a further embodiment of the invention, in the compound having the general structural formula Si(R)ₘ(R^{a})₄₋ₘ, m=0. R^{a} has the general structural formula (D), described herein, where R^{g} denotes ethyl; and R^{h} denotes methyl. This compound is also referred to, in particular, as tetra(2-butanone oxime)silane.

According to a further embodiment of the invention, in the compound having the general structural formula Si(R)ₘ(R^{a})₄₋ₘ, m=0. R^{a} has the general structural formula (D), described herein, where R^{g} and R^{h} each denote methyl. This compound is also referred to, in particular, as tetra(2-propanone oxime)silane.

According to a further embodiment of the invention, in the compound having the general structural formula Si(R)ₘ(R^{a})₄₋ₘ, m=0. R^{a} has the general structural formula (D), described herein, where R^{g} and R^{h} each are ethyl. This compound is also referred to, in particular, as tetra(3-pentanone oxime)silane.

According to a further embodiment of the invention, in the compound having the general structural formula Si(R)ₘ(R^{a})₄₋ₘ, m=0. R^{a} has the general structural formula (D), described herein, where R^{g} denotes methyl; and R^{h} denotes isobutyl. This compound is also referred to, in particular, as tetra(4-methyl-2-pentanone oxime)silane.

In the general structural formula (D), the oxime radical is bonded to the silicon atom via the oxygen atom of the hydroxy group. For example, a compound, present in the crosslinker according to the invention and having the general structural formula Si(R)ₘ(R^{a})₄₋ₘ, in which m=1, can have the general structural formula (Db):

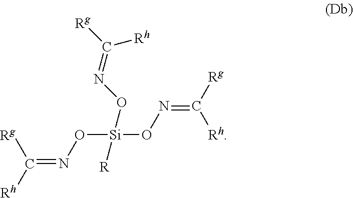

It has been found that such hardeners have positive properties for sealant formulations. Thus, the resulting cured sealants have improved mechanical properties—Shore A hardness of at least 3 and an elongation at break of at least 100%. Furthermore, sealants, comprising these hardeners, are also colorless and transparent.

According to one embodiment, in the general structural formula (Db), each R is selected, independently of each other, in particular, from the group consisting of methyl, ethyl, n-propyl, isopropyl, n-butyl, isobutyl, sec-butyl, tert-butyl, 2-ethylhexyl, vinyl, phenyl, methoxy or ethoxy; and R^{a} has the general structural formula (D), described herein, where R^{g} and R^{h} are selected, independently of each other, in particular, from the group consisting of methyl, ethyl, n-propyl, isopropyl, n-butyl, isobutyl, 2-ethylhexyl, vinyl and phenyl. In this case it is particularly preferred that R be selected from the group consisting of methyl, ethyl, vinyl and methoxy, most preferably vinyl, methyl and/or methoxy; and particularly preferred that R^{g} and R^{h} be selected, independently of each other, from the group consisting of methyl, ethyl, propyl and isobutyl. It is known that crosslinkers, comprising such compounds, can have particularly positive properties for sealant formulations, in particular, with respect to their mechanical properties.

According to another embodiment of the invention, in the compound having the general structural formula Si(R)ₘ(R^{a})₄₋ₘ, m=1, R denotes vinyl; and R^{a} has the general structural formula (D), described herein, where R^{g} denotes n-propyl; and R^{h} denotes methyl. This compound is also referred to, in particular, as vinyl tris(2-pentanone oxime)silane.

According to a further embodiment of the invention, in the compound having the general structural formula Si(R)ₘ(R^{a})₄₋ₘ, m=1, R denotes methyl; and R^{a} has the general structural formula (D), described herein, where R^{g} denotes n-propyl; and R^{h} denotes methyl. This compound is also referred to, in particular, as methyl tris(2-pentanone oxime)silane.

According to a further embodiment of the invention, in the compound having the general structural formula Si(R)ₘ(R^{a})₄₋ₘ, m=1, R denotes ethyl; and R^{a} has the general structural formula (D), described herein, where R^{g} denotes n-propyl; and R^{h} denotes methyl. This compound is also referred to, in particular, as ethyl tris(2-pentanone oxime)silane.

According to a further embodiment of the invention, in the compound having the general structural formula Si(R)ₘ(R^{a})₄₋ₘ, m=1, R denotes propyl; and R^{a} has the general structural formula (D), described herein, where R^{g} denotes n-propyl; and R^{h} denotes methyl. This compound is also referred to, in particular, as propyl tris(2-pentanone oxime)silane.

According to a further embodiment of the invention, in the compound having the general structural formula Si(R)ₘ(R^{a})₄₋ₘ, m=1, R denotes phenyl; and R^{a} has the general structural formula (D), described herein, where R^{g} denotes n-propyl; and R^{h} denotes methyl. This compound is also referred to, in particular, as phenyl tris(2-pentanone oxime)silane.

According to another embodiment of the invention, in the compound having the general structural formula Si(R)ₘ(R^{a})₄₋ₘ, m=1, R denotes vinyl; and R^{a} has the general structural formula (D), described herein, where R^{g} and R^{h} each denote methyl. This compound is also referred to, in particular, as vinyl tris(2-propanone oxime)silane.

According to a further embodiment of the invention, in the compound having the general structural formula Si(R)ₘ(R^{a})₄₋ₘ, m=1, R denotes methyl; and R^{a} has the general structural formula (D), described herein, where R^{g} and R^{h} each denote methyl. This compound is also referred to, in particular, as methyl tris(2-propanone oxime)silane.

According to a further embodiment of the invention, in the compound having the general structural formula Si(R)ₘ(R^{a})₄₋ₘ, m=1, R denotes ethyl; and R^{a} has the general structural formula (D), described herein, where R^{g} and R^{h} each denote methyl. This compound is also referred to, in particular, as ethyl tris(2-propanone oxime)silane.

According to a further embodiment of the invention, in the compound having the general structural formula Si(R)ₘ(R^{a})₄₋ₘ, m=1, R denotes propyl; and R^{a} has the general structural formula (D), described herein, where R^{g} and R^{h} each denote methyl. This compound is also referred to, in particular, as propyl tris(2-propanone oxime)silane.

According to a further embodiment of the invention, in the compound having the general structural formula Si(R)ₘ(R^{a})₄₋ₘ, m=1, R denotes phenyl; and R^{a} has the general structural formula (D), described herein, where R^{g} and R^{h} each denote methyl. This compound is also referred to, in particular, as phenyl tris(2-propanone oxime)silane.

According to another embodiment of the invention, in the compound having the general structural formula Si(R)ₘ(R^{a})₄₋ₘ, m=1, R denotes vinyl; and R^{a} has the general structural formula (D), described herein, where R^{g} denotes ethyl; and R^{h} denotes methyl. This compound is also referred to, in particular, as vinyl tris(2-butanone oxime)silane.

According to a further embodiment of the invention, in the compound having the general structural formula Si(R)ₘ(R^{a})₄₋ₘ, m=1, R denotes methyl; and R^{a} has the general structural formula (D), described herein, where R^{g} denotes ethyl; and R^{h} denotes methyl. This compound is also referred to, in particular, as methyl tris(2-butanone oxime)silane.

According to a further embodiment of the invention, in the compound having the general structural formula Si(R)ₘ(R^{a})₄₋ₘ, m=1, R denotes ethyl; and R^{a} has the general structural formula (D), described herein, where R^{g} denotes ethyl; and R^{h} denotes methyl. This compound is also referred to, in particular, as ethyl tris(2-butanone oxime)silane.

According to a further embodiment of the invention, in the compound having the general structural formula Si(R)ₘ(R^{a})₄₋ₘ, m=1, R denotes propyl; and R^{a} has the general structural formula (D), described herein, where R^{g} denotes ethyl; and R^{h} denotes methyl. This compound is also referred to, in particular, as propyl tris(2-butanone oxime)silane.

According to a further embodiment of the invention, in the compound having the general structural formula Si(R)ₘ(R^{a})₄₋ₘ, m=1, R denotes phenyl; and R^{a} has the general structural formula (D), described herein, where R^{g} denotes ethyl; and R^{h} denotes methyl. This compound is also referred to, in particular, as phenyl tris(2-butanone oxime)silane.

According to another embodiment of the invention, in the compound having the general structural formula Si(R)ₘ(R^{a})₄₋ₘ, m=1, R denotes vinyl; and R^{a} has the general structural formula (D), described herein, where R^{g} and R^{h} each denote ethyl. This compound is also referred to, in particular, as vinyl tris(3-pentanone oxime)silane.

According to a further embodiment of the invention, in the compound having the general structural formula Si(R)ₘ(R^{a})₄₋ₘ, m=1, R denotes methyl; and R^{a} has the general structural formula (D), described herein, where R^{g} and R^{h} each denote ethyl. This compound is also referred to, in particular, as methyl tris(3-pentanone oxime)silane.

According to a further embodiment of the invention, in the compound having the general structural formula Si(R)ₘ(R^{a})₄₋ₘ, m=1, R denotes ethyl; and R^{a} has the general structural formula (D), described herein, where R^{g} and R^{h} each denote ethyl. This compound is also referred to, in particular, as ethyl tris(3-pentanone oxime)silane.

According to a further embodiment of the invention, in the compound having the general structural formula Si(R)ₘ(R^{a})₄₋ₘ, m=1, R denotes propyl; and R^{a} has the general structural formula (D), described herein, where R^{g} and R^{h} each denote ethyl. This compound is also referred to, in particular, as propyl tris(3-pentanone oxime)silane.

According to a further embodiment of the invention, in the compound having the general structural formula Si(R)ₘ(R^{a})₄₋ₘ, m=1, R denotes phenyl; and R^{a} has the general structural formula (D), described herein, where R^{g} and R^{h} each denote ethyl. This compound is also referred to, in particular, as phenyl tris(3-pentanone oxime)silane.

According to another embodiment of the invention, in the compound having the general structural formula Si(R)ₘ(R^{a})₄₋ₘ, m=1, R denotes vinyl; and R^{a} has the general structural formula (D), described herein, where R^{g} denotes methyl; and R^{h} denotes isobutyl. This compound is also referred to, in particular, as vinyl tris(4-methyl-2-pentanone oxime)silane.

According to a further embodiment of the invention, in the compound having the general structural formula Si(R)ₘ(R^{a})₄₋ₘ, m=1, R denotes methyl; and R^{a} has the general structural formula (D), described herein, where R^{g} denotes methyl; and R^{h} denotes isobutyl. This compound is also referred to, in particular, as methyl tris(4-methyl-2-pentanone oxime)silane.

According to a further embodiment of the invention, in the compound having the general structural formula Si(R)ₘ(R^{a})₄₋ₘ, m=1, R denotes ethyl; and R^{a} has the general structural formula (D), described herein, where R^{g} denotes methyl; and R^{h} denotes isobutyl. This compound is also referred to, in particular, as ethyl tris(4-methyl-2-pentanone oxime)silane.

According to a further embodiment of the invention, in the compound having the general structural formula Si(R)ₘ(R^{a})₄₋ₘ, m=1, R denotes propyl; and R^{a} has the general structural formula (D), described herein, where R^{g} denotes methyl; and R^{h} denotes isobutyl. This compound is also referred to, in particular, as propyl tris(4-methyl-2-pentanone oxime)silane.

According to a further embodiment of the invention, in the compound having the general structural formula Si(R)ₘ(R^{a})₄₋ₘ, m=1, R denotes phenyl; and R^{a} has the general structural formula (D), described herein,

where R^{g} denotes methyl; and R^{h} denotes isobutyl. This compound is also referred to, in particular, as phenyl tris(4-methyl-2-pentanone oxime)silane.

In the general structural formula (D), the oxime radical is bonded to the silicon atom via the oxygen atom of the hydroxy group. For example, a compound, present in the crosslinker according to the invention and having the general structural formula Si(R)ₘ(R^{a})₄₋ₘ, in which m=2, can have the general structural

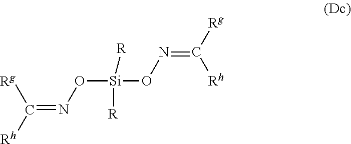

Furthermore, each radical R may be different, when multiple radicals R are bonded to the silicon atom. R^{g} and R^{h} are defined as above.

According to this embodiment, in the general structural formula (Dc), each R is selected, independently of each other, in particular, from the group consisting of methyl, ethyl, n-propyl, isopropyl, n-butyl, isobutyl, sec-butyl, tert-butyl, 2-ethylhexyl, vinyl, phenyl, methoxy or ethoxy; and R^{a} has the general structural formula (D), described herein, where R^{g} and R^{h} are selected, independently of each other, in particular, from the group consisting of methyl, ethyl, n-propyl, isopropyl, n-butyl, isobutyl, sec-butyl, tert-butyl, 2-ethylhexyl, vinyl and phenyl. In this case it is particularly preferred that R be selected from the group consisting of methyl, vinyl and methoxy, most preferably vinyl and/or methoxy; and particularly preferred that R^{g} and R^{h} be selected, independently of each other, from the group consisting of methyl, ethyl and isobutyl.

According to another embodiment of the invention, in the compound having the general structural formula Si(R)ₘ(R^{a})₄₋ₘ, m=2. R denotes vinyl and methyl. In particular, one R denotes vinyl and another radical R denotes methyl; and R^{a} has the general structural formula (D), described herein, where R^{g} and R^{h} each are methyl. This compound is also referred to, in particular, as methyl vinyl di(2-propanone oxime)silane.

According to a further embodiment of the invention, in the compound having the general structural formula Si(R)ₘ(R^{a})₄₋ₘ, m=2. R denotes vinyl and methyl. In particular, one R denotes vinyl and another radical R denotes methyl; and R^{a} has the general structural formula (D), described herein, where R^{g} denotes ethyl; and R^{h} denotes methyl. This compound is also referred to, in particular, as methyl vinyl di(2-butanone oxime)silane.

According to a further embodiment of the invention, in the compound having the general structural formula Si(R)ₘ(R^{a})₄₋ₘ, m=2. R denotes vinyl and methyl. In particular, one R denotes vinyl and another radical R denotes methyl; and R^{a} has the general structural formula (D), described herein, where R^{g} denotes n-propyl; and R^{h} denotes methyl. This compound is also referred to, in particular, as methyl vinyl di(2-pentanone oxime)silane.

According to a further embodiment of the invention, in the compound having the general structural formula Si(R)ₘ(R^{a})₄₋ₘ, m=2. R denotes vinyl and methyl. In particular, one R denotes vinyl and another radical R denotes methyl; and R^{a} has the general structural formula (D), described herein, where R^{g} and R^{h} each denote ethyl. This compound is also referred to, in particular, as methyl vinyl di(3-pentanone oxime)silane.

According to a further embodiment of the invention, in the compound having the general structural formula Si(R)ₘ(R^{a})₄₋ₘ, m=2. R denotes vinyl and methoxy. In particular, one R denotes vinyl and another radical R denotes methoxy; and R^{a} has the general structural formula (D), described herein, where R^{g} and R^{h} each denote methyl. This compound is also referred to, in particular, as methoxyvinyl di(2-propanone oxime)silane.

According to a further embodiment of the invention, in the compound having the general structural formula Si(R)ₘ(R^{a})₄₋ₘ, m=2. R denotes vinyl and methoxy. In particular, one R denotes vinyl and another radical R denotes methoxy; and R^{a} has the general structural formula (D), described herein, where R^{g} denotes ethyl; and R^{h} denotes methyl. This compound is also referred to, in particular, as methoxyvinyl di(2-butanone oxime)silane.

According to a further embodiment of the invention, in the compound having the general structural formula Si(R)ₘ(R^{a})₄₋ₘ, m=2. R denotes vinyl and methoxy. In particular, one R denotes vinyl and another radical R denotes methoxy; and R^{a} has the general structural formula (D), described herein, where R^{g} denotes n-propyl; and R^{h} denotes methyl. This compound is also referred to, in particular, as methoxyvinyl di(2-pentanone oxime)silane.

According to a further embodiment of the invention, in the compound having the general structural formula Si(R)ₘ(R^{a})₄₋ₘ, m=2. R denotes vinyl and methoxy. In particular, one R denotes vinyl and another radical R denotes methoxy; and R^{a} has the general structural formula (D), described herein, where R^{g} and R^{h} each denote ethyl. This compound is also referred to, in particular, as methoxyvinyl di(3-pentanone oxime)silane.

According to another embodiment of the invention, in the compound having the general structural formula Si(R)ₘ(R^{a})₄₋ₘ, m=2. R denotes vinyl and phenyl. In particular, one R denotes vinyl and another radical R denotes phenyl; and R^{a} has the general structural formula (D), described herein, where R^{g} and R^{h} each denote methyl. This compound is also referred to, in particular, as phenyl vinyl di(2-propanone oxime)silane.

According to another embodiment of the invention, in the compound having the general structural formula Si(R)ₘ(R^{a})₄₋ₘ, m=2. R denotes vinyl and phenyl. In particular, one R denotes vinyl and another radical R denotes phenyl; and R^{a} has the general structural formula (D), described herein, where R^{g} denotes ethyl; and R^{h} denotes methyl. This compound is also referred to, in particular, as phenyl vinyl di(2-butanone oxime)silane.

According to another embodiment of the invention, in the compound having the general structural formula Si(R)ₘ(R^{a})₄₋ₘ, m=2. R denotes vinyl and phenyl. In particular, one R denotes vinyl and another radical R denotes phenyl; and R^{a} has the general structural formula (D), described herein, where R^{g} denotes n-propyl; and R^{h} denotes methyl. This compound is also referred to, in particular, as phenyl vinyl di(2-pentanone oxime)silane.

According to another embodiment of the invention, in the compound having the general structural formula Si(R)ₘ(R^{a})₄₋ₘ, m=2. R denotes vinyl and phenyl. In particular, one R denotes vinyl and another radical R denotes phenyl; and R^{a} has the general structural formula (D), described herein, where R^{g} and R^{h} each denote ethyl. This compound is also referred to, in particular, as phenyl vinyl di(3-pentanone oxime)silane.

In the general structural formula (Dd), the oxime radical is bonded to the silicon atom via the oxygen atom of the hydroxy group. For example, a compound, present in the crosslinker according to the invention and having the general structural formula Si(R)ₘ(R^{a})₄₋ₘ, in which m=3, can have the general structural formula (Dd):

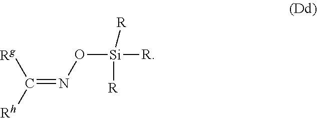

Furthermore, each radical R may be different, with at least one radical R denoting a hydrolyzable leaving group (for example, an alkoxy radical —OR^{k}), when three radicals R are bonded to the silicon atom. R^{g} and R^{h} are defined as above.

According to this embodiment, in the general structural formula (Dd), each R is selected, independently of each other, in particular, from the group consisting of methyl, ethyl, n-propyl, isopropyl, n-butyl, isobutyl, 2-ethylhexyl, vinyl, phenyl and —OR^{k} (alkoxy radical), of which at least one R is an alkoxy radical —OR^{k}, where R^{k} denotes an optionally substituted hydrocarbon radical having from 1 to 20 carbon atoms, in particular, an optionally substituted, straight-chain or branched C1 to C16 alkyl group, an optionally substituted C4 to C14 cycloalkyl group or an optionally substituted C4 to C14 aryl group or an optionally substituted C5 to C15 aralkyl group. Preferably the alkoxy radical denotes methoxy or ethoxy; and R^{a} has the general structural formula (D), described herein, where R^{g} and R^{h} are selected, independently of each other, in particular, from the group consisting of methyl, ethyl, n-propyl, isopropyl, n-butyl, isobutyl, 2-ethylhexyl, vinyl and phenyl. In this case it is particularly preferred that R be selected from the group consisting of methyl, vinyl and methoxy, ethoxy, most preferably vinyl and/or methoxy, and particularly preferred that R^{g} and R^{h} be selected, independently of each other, from the group consisting of methyl, ethyl and isobutyl.

According to another embodiment of the invention, in the compound having the general structural formula Si(R)ₘ(R^{a})₄₋ₘ, m=3. R denotes vinyl and methoxy. In particular, one R denotes vinyl and two other radicals R each denote methoxy; and R^{a} has the general structural formula (D), described herein, where R^{g} and R^{h} each denote methyl. This compound is also referred to, in particular, as dimethoxyvinyl (2-propanone oxime)silane.

According to a further embodiment of the invention, in the compound having the general structural formula Si(R)ₘ(R^{a})₄₋ₘ, m=3. R denotes vinyl and methoxy. In particular, one R denotes vinyl and two other radicals R each denote methoxy; and R^{a} has the general structural formula (D), described herein, where R^{g} denotes ethyl; and R^{h} denotes methyl. This compound is also referred to, in particular, as dimethoxyvinyl (2-butanone oxime)silane.

According to a further embodiment of the invention, in the compound having the general structural formula Si(R)ₘ(R^{a})₄₋ₘ, m=3. R denotes vinyl and methoxy. In particular, one R denotes vinyl and two other radicals R each denote methoxy; and R^{a} has the general structural formula (D), described herein, where R^{g} denotes n-propyl; and R^{h} denotes methyl. This compound is also referred to, in particular, as dimethoxyvinyl (2-pentanone oxime)silane.

According to a further embodiment of the invention, in the compound having the general structural formula Si(R)ₘ(R^{a})₄₋ₘ, m=3. R denotes vinyl and methoxy. In particular, one R denotes vinyl and two other radicals R each denote methoxy; and R^{a} has the general structural formula (D), described herein, where R^{g} and R^{h} each denote ethyl. This compound is also referred to, in particular, as dimethoxyvinyl (3-propanone oxime)silane.

According to a further embodiment of the invention, in the compound having the general structural formula Si(R)ₘ(R^{a})₄₋ₘ, m=3. R denotes vinyl and methoxy. In particular, one R denotes vinyl and two other radicals R each denote methoxy; and R^{a} has the general structural formula (D), described herein, where R^{g} denotes ethyl; and R^{h} denotes methyl. This compound is also referred to, in particular, as dimethoxyvinyl (3-butanone oxime)silane.

According to a further embodiment of the invention, in the compound having the general structural formula Si(R)ₘ(R^{a})₄₋ₘ, m=3. R denotes vinyl and methoxy. In particular, one R denotes vinyl and two other radicals R each denote methoxy; and R^{a} has the general structural formula (D), described herein, where R^{g} and R^{h} each denote ethyl. This compound is also referred to, in particular, as dimethoxyvinyl (3-pentanone oxime)silane.

In a preferred embodiment of the invention the crosslinker comprises a combination of the preferred compounds consisting of vinyl tris(2-propanone oxime)silane, methoxyvinyl di(2-propanone oxime)silane and dimethoxyvinyl (2-propanone oxime)silane. It is particularly preferred that the crosslinker consist of this combination.

In another preferred embodiment of the invention the crosslinker comprises the compound vinyl tris(2-pentanone oxime)silane. It is particularly preferred that the crosslinker consist thereof.

In an alternative preferred embodiment of the invention the crosslinker comprises the compound methyl tris(2-pentanone oxime)silane. It is particularly preferred that the crosslinker consist thereof.

In another preferred embodiment of the invention the crosslinker comprises a combination of the preferred compounds consisting of vinyl tris(2-pentanone oxime)silane and methyl tris(2-pentanone oxime)silane. It is particularly preferred that the crosslinker consist of this combination.

Practical tests have shown that optimal results are achieved when the compound, present in the crosslinker according to the invention and having the general structural formula Si(R)ₘ(R^{a})₄₋ₘ, is selected from the group consisting of vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane. It has been shown that crosslinkers, comprising one of these preferred compounds, produce sealant formulations that have good properties. On the one hand, colorless and transparent sealants can be obtained; and, on the other hand, sealant formulations having crosslinkers, comprising one of these preferred compounds, have good mechanical properties.

### Acetate Crosslinker

In an alternative embodiment of the general structural formula Si(R)ₘ(R^{a})₄₋ₘ, in which each radical R^{a} may be different, when several radicals R^{a} are bonded to the silicon atom, and each R^{a} is a carboxylic acid radical —O—C(O)—R^{f}, said carboxylic acid radical is bonded to the silicon atom via the oxygen atom of the hydroxy group; and R is selected from the group consisting of methyl, ethyl, n-propyl, isopropyl, n-butyl, isobutyl, sec-butyl, tert-butyl, 2-ethylhexyl, vinyl and phenyl. In this case, m can be an integer from 0 to 2, is preferably equal to 1; and R^{f} is methyl. Preferably m=1; R is methyl, ethyl, propyl or vinyl; and R^{f} is methyl. It is most particularly preferred that m=1; R is methyl or vinyl; and R^{f} is methyl. It is known that crosslinkers, comprising such compounds, can have particularly positive properties for sealant formulations, in particular, with respect to toxicological safety.

According to another embodiment of the invention is a preferred compound of the general structural formula Si(R)ₘ(R^{a})₄₋ₘ, where m=1, R denotes vinyl and R^{a} is a carboxylic acid radical —O—C(O)—R^{f}; and R^{f} denotes methyl therein. This compound is also referred to, in particular, as vinyltriacetoxysilane.

According to a further embodiment of the invention, in the compound having the general structural formula Si(R)ₘ(R^{a})₄₋ₘ, m=1, R denotes methyl; and R^{a} is a carboxylic acid radical —O—C(O)—R^{f}; and R^{f} denotes methyl. This compound is also referred to, in particular, as methyltriacetoxysilane.

According to a further embodiment of the invention, in the compound having the general structural formula Si(R)ₘ(R^{a})₄₋ₘ, m=1, R denotes ethyl; and R^{a} is a

carboxylic acid radical —O—C(O)—R^{f}; and R^{f} denotes methyl. This compound is also referred to, in particular, as ethyltriacetoxysilane.

According to a further embodiment of the invention, in the compound having the general structural formula Si(R)ₘ(R^{a})₄₋ₘ, m=1, R denotes propyl; and R^{a} is a carboxylic acid radical —O—C(O)—R; and R^{f} denotes methyl. This compound is also referred to, in particular, as propyltriacetoxysilane.

According to a further embodiment of the invention, in the compound having the general structural formula Si(R)ₘ(R^{a})₄₋ₘ, m=1, R denotes phenyl; and R^{a} is a carboxylic acid radical —O—C(O)—R; and R^{f} denotes methyl. This compound is also referred to, in particular, as phenyltriacetoxysilane.

In a preferred embodiment of the invention the crosslinker comprises a combination of the compounds consisting of vinyltriacetoxysilane and methyltriacetoxysilane. It is particularly preferred that the crosslinker consist of this combination.

In a preferred embodiment of the invention the crosslinker comprises a combination of the compounds consisting of methyltriacetoxysilane and ethyltriacetoxysilane. It is particularly preferred that the crosslinker consist of this combination.

In a preferred embodiment of the invention the crosslinker comprises a combination of the compounds consisting of ethyltriacetoxysilane and propyltriacetoxysilane. It is particularly preferred that the crosslinker consist of this combination.

In a further preferred embodiment of the invention the crosslinker comprises the compound vinyltriacetoxysilane. It is particularly preferred that the crosslinker consist thereof.

In an alternative preferred embodiment of the invention the crosslinker comprises the compound methyltriacetoxysilane. It is particularly preferred that the crosslinker consist thereof.

In an alternative preferred embodiment of the invention the crosslinker comprises the compound ethyltriacetoxysilane. It is particularly preferred that the crosslinker consist thereof.

In an alternative preferred embodiment of the invention the crosslinker comprises the compound propyltriacetoxysilane. It is particularly preferred that the crosslinker consist thereof.

Crosslinkers from the group of oxime crosslinkers and crosslinkers from the group of acetate crosslinkers are particularly preferred.

Therefore, in a very highly preferred embodiment the crosslinker is selected from the group consisting of oxime crosslinkers, such as vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane, or mixtures thereof or acetate crosslinkers, such as methyltriacetoxysilane or ethyltriacetoxysilane.

In an extremely preferred embodiment the crosslinker is selected from the group consisting of vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane or mixtures thereof or methyltriacetoxysilane.

Crosslinkers from the group of oxime crosslinkers are particularly well suited for producing the silicone rubber compounds of the invention. Therefore, extremely strong preference is given to vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane or mixtures thereof.

The term “catalyst” refers to a substance that reduces the activation energy of a specific reaction and, in so doing, increases the reaction speed or makes a reaction possible at all.

In one embodiment the composition of the present invention comprises at least one catalyst A and at least one catalyst B. A preferred embodiment comprises only one catalyst A and only one catalyst B.

In an alternative embodiment a composition of the present invention comprises a mixture of three or four different catalysts, selected from the group, comprising catalyst A and catalyst B. The use of three or four different catalysts in the curing of polyorganosiloxanes can have advantageous properties. Thus, for example, the proportion of a toxicologically unsafe and/or expensive catalyst can be reduced. In particular, the combination of different catalysts can affect the properties of the resulting silicone rubber compounds. As a result, the different reactivities of the catalysts make it possible to control the material properties of the cured silicone rubber compounds accordingly.

According to the invention, catalyst A comprises at least one metal siloxane-silanol(ate) compound.

The term “metal siloxane-silanol(ate) compound” refers to any metal siloxane compound that comprises either one or more silanol and/or silanolate groups. In one embodiment of the invention it is also possible for only metal siloxane-silanolates to be present. All combinations are included, unless a detailed distinction is made between these different constellations.

In one embodiment of the present invention the metal siloxane-silanol(ate) compound may be present as a monomer, oligomer and/or polymer for producing the silylated polymers (SiP) of the composition of the present invention, with the transition from oligomers to polymers taking place seamlessly in accordance with the general definition.

The metal or metals in the oligomeric and/or polymeric metal siloxane-silanol(ate) compound was/were present preferably at the end of the chain and/or within the chain.

In the composition of the present invention as well as in the production of silicone rubber compounds, the chain-shaped metal siloxane-silanol(ate) compound is linear and/or branched and/or a cage.

In a preferred embodiment the chain-shaped metal siloxane-silanol(ate) compound has a cage structure in the composition of the present invention and/or in the production of the silicone rubber compounds of the composition of the present invention.

For the purposes of the invention a “cage” or an oligomeric or a polymeric “cage structure” is to be understood as meaning a three dimensional arrangement of the chain-shaped metal siloxane-silanol(ate) compound, with the individual atoms of the chain forming the vertices of a multifaceted basic structure of the compound. In this case at least two surfaces are defined by the atoms linked to one another, so that the result is a common intersection. In one embodiment of the compound, for example, a cube-shaped basic structure of the compound is formed. A one-cage structure or, more specifically, a cage structure in singular form, i.e., a compound that has an isolated cage, is represented by the structure (IVc). Compounds, which have multiple cages within the compound, may be described by the compounds (I) as well as (Ia) to (Id). According to the invention, a cage may be “open” or “closed,” depending on whether all vertices are bonded, joined or coordinated so as to form a closed cage structure. An example of a closed cage is represented by the structures (II), (IV), (IVb), (IVc).

According to the invention, the term “nuclear” describes the nuclearity of a compound, how many metal atoms are present therein. A mononuclear compound has one metal atom, whereas a dinuclear compound has two metal atoms within a compound. In this case the metals may be bonded directly to one another or linked via their substituents. An example of a mononuclear compound of the invention is represented, for example, by the structures (IV), (IVb), (IVc), (Ia), (Ib) or (Ic). A dinuclear compound is represented by the structure (Id).

A mononuclear one-cage structure is represented by the metal siloxane-silanol(ate) compounds (IV), (IVb) and (IVc). Mononuclear two-cage structures are, for example, the structures (Ia), (Ib) or (Ic).

The metal siloxane-silanol(ate) compound comprises preferably an oligomeric metal silsesquioxane in the production of the silicone rubber compounds of the composition of the present invention.

The metal siloxane-silanol(ate) compound comprises, in particular, a polyhedral metal silsesquioxane in the production of the silicone rubber compounds of the composition of the present invention.

In one embodiment the metal siloxane-silanol(ate) compound in the composition of the present invention and/or in the production of the silicone rubber compounds has the general formula R*_{q}SiᵣOₛMₜ, where each R* is selected, independently of each other, from the group consisting of optionally substituted C1 to C20 alkyl, optionally substituted C3 to C8 cycloalkyl, optionally substituted C2 to C20 alkenyl, optionally substituted C5 to C10 aryl, —OH and —O—(C1 to C10 alkyl), each M being selected, independently of each other, from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,

q is an integer from 4 to 19,
r is an integer from 4 to 10,
s is an integer from 8 to 30, and
t is an integer from 1 to 8.

In a further embodiment the metal siloxane-silanol(ate) compound in the composition of the present invention and/or in the production of the silicone rubber compounds has the general formula R^{#}₄Si₄O₁₁Y₂Q₂X₄Z₃, where each X is selected, independently of each other, from the group consisting of Si, M¹, -M³L¹_{Δ}, M³ or —Si(R⁸)—O-M³L¹_{Δ}, where M¹ and M³ are selected, independently of each other, from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, and where L¹ is selected from the group consisting of —OH and —O—(C1 to C10 alkyl), in particular, —O—(C1 to C8 alkyl) or —O—(C1 to C6 alkyl), or where L¹ is selected from the group consisting of —OH, —O-methyl, —O-ethyl, —O-propyl, —O-butyl, —O-octyl, —O-isopropyl and —O-isobutyl, and where R⁸ is selected from the group consisting of optionally substituted C1 to C20 alkyl, optionally substituted C3 to C8 cycloalkyl, optionally substituted C2 to C20 alkenyl and optionally substituted C5 to C10 aryl;
each Z is selected, independently of each other, from the group consisting of L², R⁵, R⁶ and R7, where L² is selected from the group consisting of —OH and —O—(C1 to C10 alkyl), in particular, —O—(C1 to C8 alkyl) or —O—(C1 to C6 alkyl), or where L² is selected from the group consisting of —OH, —O— methyl, —O-ethyl, —O-propyl, —O-butyl, —O-octyl, —O-isopropyl and —O-isobutyl;
each R^{#}, R⁵, R⁶ and R7 is selected, independently of each other, from the group consisting of optionally substituted C1 to C20 alkyl, optionally substituted C3 to C8 cycloalkyl, optionally substituted C2 to C20 alkenyl and optionally substituted C5 to C10 aryl; each Y denotes, independently of each other, —O-M²-L³_{Δ}; or two Y's are taken together and together denote —O-M²(L³_{Δ})-O— or —O—, where L³ is selected from the group consisting of —OH and —O—(C1 to C10 alkyl), in particular, —O—(C1 to C8 alkyl) or —O—(C1 to C6 alkyl), or where L³ is selected from the group consisting of —OH, —O-methyl, —O-ethyl, —O-propyl, —O-butyl, —O-octyl, —O-isopropyl and —O— isobutyl, and each M² is selected, independently of each other, from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,
   each Q denotes, independently of each other, H, M⁴L⁴_{Δ}, —SiR⁸, -M³L¹_{Δ}, a single bond attached to M3 of X, or a single bond attached to the Si atom of the radical —Si(R⁸)—O-M³L¹_{Δ}, where M³, R⁸ and L¹ are defined as for X, where M⁴ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, and where L⁴ is selected from the group consisting of —OH and —O—(C1 to C10 alkyl), in particular, —O—(C1 to C8 alkyl) or —O—(C1 to C6 alkyl), or where L⁴ is selected from the group consisting of —OH, —O-methyl, —O-ethyl, —O-propyl, —O-butyl, —O-octyl, —O-isopropyl and —O— isobutyl,
   with the proviso that at least one X denotes M³, -M³L¹_{Δ} or —Si(R⁸)—O-M³L¹_{Δ}.

The person skilled in the art knows that the number (Δ) of possible ligands for L¹_{Δ}, L²_{Δ}, L³_{Δ}, L⁴_{Δ} is determined directly from the number of free valences of the metal atom used, the valence number describing the valency of the metal.

In a further embodiment the metal siloxane-silanol(ate) compound in the composition of the present invention and/or in the production of the silicone rubber compounds has the general formula (Y_{0.25}R^{#}SiO_{1.25})₄(Z_{0.75}Y_{0.25}XO)₄(OQ)₂, where each X is selected, independently of each other, from the group consisting of Si, M¹, -M³L¹_{Δ}, M³ or —Si(R⁸)—O-M³L¹_{Δ}, where M¹ and M³ are selected, independently of each other, from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, and where L¹ is selected from the group consisting of —OH and —O—(C1 to C10 alkyl), in particular, —O—(C1 to C8 alkyl) or —O—(C1 to C6 alkyl), or where L¹ is selected from the group consisting of —OH, —O-methyl, —O-ethyl, —O-propyl, —O-butyl, —O-octyl, —O-isopropyl and —O— isobutyl, and where R⁸ is selected from the group consisting of optionally substituted C1 to C20 alkyl, optionally substituted C3 to C6 cycloalkyl, optionally substituted C2 to C20 alkenyl and optionally substituted C6 to C10 aryl;

each Z is selected, independently of each other, from the group consisting of L², R⁵, R⁶ and R7, where L² is selected from the group consisting of —OH and —O—(C1 to C10 alkyl), in particular, —O—(C1 to C8 alkyl) or —O—(C1 to C6 alkyl), or where L² is selected from the group consisting of —OH, —O— methyl, —O-ethyl, —O-propyl, —O-butyl, —O-octyl, —O-isopropyl and —O-isobutyl;
each R^{#}, R⁵, R⁶, and R⁷ is selected, independently of each other, from the group consisting of optionally substituted C1 to C20 alkyl, optionally substituted C3 to C6 cycloalkyl, optionally substituted C2 to C20 alkenyl, and optionally substituted C6 to C10 aryl;
each Y denotes, independently of each other, —O-M²-L³_{Δ}, or two Y's are taken together and together denote —O-M²(L³_{Δ})-O— or —O—, where L³ is selected from the group consisting of —OH and —O—(C1 to C10 alkyl), in particular, —O—(C1 to C8 alkyl) or —O—(C1 to C6 alkyl), or where L³ is selected from the group consisting of —OH, —O-methyl, —O-ethyl, —O-propyl, —O-butyl, —O-octyl, —O-isopropyl and —O-isobutyl; and each M² is selected, independently of each other, from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,
each Q denotes, independently of each other, H, M⁴L⁴_{Δ}, —SiR⁸, -M³L¹_{Δ}, a single bond attached to M³ of X, or a single bond attached to the Si atom of the radical —Si(R⁸)—O-M³L¹_{Δ}, where M³, R⁸ and L¹ are defined as for X, where M⁴ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, and where L⁴ is selected from the group consisting of —OH and —O—(C1 to C10 alkyl), in particular, —O—(C1 to C8 alkyl) or —O—(C1 to C6 alkyl), or where L⁴ is selected from the group consisting of —OH, —O-methyl, —O-ethyl, —O-propyl, —O-butyl, —O-octyl, —O-isopropyl and —O— isobutyl, with the proviso that at least one X denotes M³, -M³L¹_{Δ} or —Si(R⁸)—O-M³L¹_{Δ}.

The metal siloxane-silanol(ate) compound in the composition of the present invention and/or in the production of the silicone rubber compounds has preferably the general formula Si₄O₉R¹R²R³R⁴X¹X²X³X⁴OQ¹OQ²Y¹Y²Z¹Z²Z³, where X¹, X² and X³ are selected, independently of each other, from Si or M¹, where M¹ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,

Z¹, Z² and Z³ are selected, independently of each other, from the group consisting of L², R⁵, R⁶ and R⁷, where L² is selected from the group consisting of —OH and —O—(C1 to C10 alkyl), in particular, —O—(C1 to C8 alkyl) or —O—(C1 to C6 alkyl), or where L² is selected from the group consisting of —OH, —O-methyl, —O-ethyl, —O-propyl, —O-butyl, —O-octyl, —O-isopropyl and —O-isobutyl;
R¹, R², R³, R⁴, R⁵, R⁶ and R⁷ are selected, independently of each other, from the group consisting of optionally substituted C1 to C20 alkyl, optionally substituted C3 to C8 cycloalkyl, optionally substituted C2 to C20 alkenyl and optionally substituted C5 to C10 aryl;
Y¹ and Y² denote, independently of each other, —O-M²-L³_{Δ}, or Y¹ and Y² are taken together and together denote —O-M²(L³_{Δ})-O— or —O—, where L³ is selected from the group consisting of —OH and —O—(C1 to C10 alkyl), in particular, —O—(C1 to C8 alkyl) or —O—(C1 to C6 alkyl), or where L³ is selected from the group consisting of —OH, —O-methyl, —O-ethyl, —O-propyl, —O-butyl, —O-octyl, —O-isopropyl and —O-isobutyl; and M² is selected from the group consisting of s and p block metals, d and f block transition metals, lanthanide and actinide metals and
semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi; and X⁴ denotes -M³L¹_{Δ} or M³; and Q¹ and Q² each denote H or a single bond attached to M³, where L¹ is selected from the group consisting of —OH and —O—(C1 to C10 alkyl), in particular, —O—(C1 to C8 alkyl) or —O—(C1 to C6 alkyl), or where L¹ is selected from the group consisting of —OH, —O-methyl, —O-ethyl, —O-propyl, —O-butyl, —O-octyl, —O-isopropyl and —O-isobutyl, and where M³ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,
or
X⁴ denotes -M³L¹_{Δ}; and Q² denotes H or a single bond attached to M³; and Q¹ denotes H, M⁴L⁴_{Δ} or —SiR⁸, where M⁴ is selected from the group consisting of s and p block metals, d and f block transition metals, lanthanide and actinide metals and semimetals, in particular, from the group consisting of metals of the 2nd, 3rd, 4th, 5th and 8th subgroup and metals of the 1st, 2nd, 3rd, 4th and 5th main group, in particular, from the group consisting of Zn, Sc, Ti, Zr, Hf, V, Pt, Ga, Sn and Bi, where L⁴ is selected from the group consisting of —OH and —O—(C1 to C10 alkyl), in particular, —O—(C1 to C8 alkyl) or —O—(C1 to C6 alkyl), or where L⁴ is selected from the group consisting of —OH, —O-methyl, —O-ethyl, —O-propyl, —O-butyl, —O-octyl, —O-isopropyl and —O-isobutyl, and where R⁸ is selected from the group consisting of optionally substituted C1 to C20 alkyl, optionally substituted C3 to C8 cycloalkyl, optionally substituted C2 to C20 alkenyl and optionally substituted C5 to C10 aryl, or
X⁴, Q¹ and Q² denote, independently of each other, -M³L¹_{Δ},
or
X⁴ denotes —Si(R⁸)—O-M³L¹_{Δ}; Q² denotes a single bond attached to the Si atom of X⁴; and Q¹ denotes -M⁴L⁴_{Δ},
or
X⁴ denotes —Si(R⁸)—O-M³L¹; Q² denotes a single bond attached to the Si atom of X⁴; and Q¹ denotes a single bond attached to the M³ atom of X⁴.

In another embodiment the metal silsesquioxane in the composition of the present invention and/or in the production of the silicone rubber compounds has the general formula (X⁴)(Z¹Y¹X²O)(Z²X¹O₂)(Z³X³O₂)(R¹Y²SiO)(R³SiO)(R⁴SiO₂)(R²SiO₂)(Q¹)(Q²), where X¹, X² and X³ are selected, independently of each other, from Si or M¹, where M¹ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi;

Z¹, Z² and Z³ are selected, independently of each other, from the group consisting of L², R⁵, R⁶ and R⁷, where L² is selected from the group consisting of —OH and —O—(C1 to C10 alkyl), in particular, —O—(C1 to C8 alkyl) or —O—(C1 to C6 alkyl), or where L² is selected from the group consisting of —OH, —O-methyl, —O-ethyl, —O-propyl, —O-butyl, —O-octyl, —O-isopropyl and —O-isobutyl; R¹, R², R³, R⁴, R⁵, R⁶ and R⁷ are selected, independently of each other, from the group consisting of optionally substituted C1 to C20 alkyl, optionally substituted C3 to C6 cycloalkyl, optionally substituted C2 to C20 alkenyl and optionally substituted C6 to C10 aryl;
Y¹ and Y² denote, independently of each other, —O-M²-L³_{Δ}; or Y¹ and Y² are taken together and together denote —O-M²(L³_{Δ})-O— or —O—, where L³ is selected from the group consisting of —OH and —O—(C1 to C10 alkyl), in particular, —O—(C1 to C8 alkyl) or —O—(C1 to C6 alkyl), or where L³ is selected from the group consisting of —OH, —O-methyl, —O-ethyl, —O-propyl, —O-butyl, —O-octyl, —O-isopropyl and —O-isobutyl; and M² is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, and
X⁴ denotes -M³L¹_{Δ} or M³; and Q¹ and Q² each denote H or a single bond attached to M³, where L¹ is selected from the group consisting of —OH and —O—(C1 to C10 alkyl), in particular, —O—(C1 to C8 alkyl) or —O—(C1 to C6 alkyl), or where L¹ is selected from the group consisting of —OH, —O-methyl, —O-ethyl, —O-propyl, —O-butyl, —O-octyl, —O-isopropyl and —O-isobutyl, and where M³ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, or
X⁴ denotes -M³L¹_{Δ}; and Q² denotes H or a single bond attached to M³; and Q¹ denotes H, M⁴L⁴_{Δ} or —SiR⁸, where M⁴ is selected from the group consisting of s and p block metals, d and f block transition metals, lanthanide and actinide metals and semimetals, in particular, from the group consisting of metals of the 2nd, 3rd, 4th, 5th and 8th subgroup and metals of the 1st, 2nd, 3rd, 4th and 5th main group, in particular, from the group consisting of Zn, Sc, Ti, Zr, Hf, V, Pt, Ga, Sn and Bi, where L⁴ is selected from the group consisting of —OH and —O—(C1 to C10 alkyl), in particular, —O—(C1 to C8 alkyl) or —O—(C1 to C6 alkyl), or where L⁴ is selected from the group consisting of —OH, —O-methyl, —O-ethyl, —O-propyl, —O-butyl, —O-octyl, —O-isopropyl and —O-isobutyl, and where R⁸ is selected from the group consisting of optionally substituted C1 to C20 alkyl, optionally substituted C3 to C6 cycloalkyl, optionally substituted C2 to C20 alkenyl and optionally substituted C6 to C10 aryl,
or
X⁴, Q¹ and Q² denote, independently of each other, -M³L¹_{Δ},
or
X⁴ denotes —Si(R⁸)—O-M³L¹_{Δ}; Q² denotes a single bond attached to the Si atom of X⁴; and Q¹ denotes -M⁴L⁴_{Δ}, or
X⁴ denotes —Si(R⁸)—O-M³L¹_{Δ}; Q² denotes a single bond attached to the Si atom of X⁴; and Q¹ denotes a single bond attached to the M³ atom of X⁴.

In a broader sense of the invention the catalyst A, used in accordance with the invention and based on a metal siloxane-silanol(ate) compound, can be described by the structure (I),

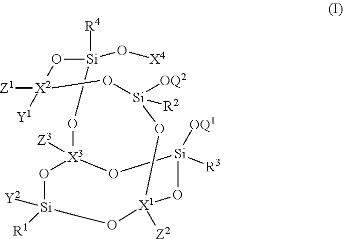

where
X¹, X² and X³ are selected, independently of each other, from Si or M¹, where M¹ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,
Z¹, Z² and Z³ are selected, independently of each other, from the group consisting of L², R⁵, R⁶ and R⁷, where L² is selected from the group consisting of —OH and —O—(C1 to C10 alkyl), in particular, —O—(C1 to C8 alkyl) or —O—(C1 to C6 alkyl), or where L² is selected from the group consisting of —OH, —O-methyl, —O-ethyl, —O— propyl, —O-butyl, —O-octyl, —O-isopropyl and —O-isobutyl;
R¹, R², R³, R⁴, R⁵, R⁶ and R⁷ are selected, independently of each other, from the group consisting of optionally substituted C1 to C20 alkyl, optionally substituted C3 to C8 cycloalkyl, optionally substituted C2 to C20 alkenyl and optionally substituted C5 to C10 aryl;
Y¹ and Y² denote, independently of each other, —O-M²-L³_{Δ}; or Y¹ and Y² are taken together and together denote —O-M²(L³_{Δ})-O or —O—, where L³ is selected from the group consisting of —OH and —O—(C1 to C10 alkyl), in particular, —O—(C1 to C8 alkyl) or —O—(C1 to C6 alkyl), or where L³ is selected from the group consisting of —OH, —O-methyl, —O-ethyl, —O-propyl, —O-butyl, —O-octyl, —O-isopropyl and —O-isobutyl, and where M² is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn, Bi;
and X⁴ denotes -M³L¹_{Δ} or M³; and Q¹ and Q² each denote H or a single bond attached to M³, where L¹ is selected from the group consisting of —OH and —O—(C1 to C10 alkyl), in particular, —O—(C1 to C8 alkyl) or —O—(C1 to C6 alkyl), or where L¹ is selected from the group consisting of —OH, —O-methyl, —O-ethyl, —O-propyl, —O-butyl, —O-octyl, —O-isopropyl and —O-isobutyl, and where M³ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn, Bi,
or
X⁴ denotes -M³L¹_{Δ}; and Q² denotes H or a single bond attached to M³; and Q¹ denotes H, M⁴L⁴_{Δ} or —SiR^{B}, where M⁴ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, and
where L⁴ is selected from the group consisting of —OH and —O—(C1 to C10 alkyl), in particular, —O—(C1 to C8 alkyl) or —O—(C1 to C6 alkyl), or where L⁴ is selected from the group consisting of —OH, —O-methyl, —O-ethyl, —O-propyl, —O-butyl, —O-octyl, —O-isopropyl and —O-isobutyl, and where R⁸ is selected from the group consisting of optionally substituted C1 to C20 alkyl, optionally substituted C3 to C6 cycloalkyl, optionally substituted C2 to C20 alkenyl and optionally substituted C6 to C10 aryl,
or
X⁴, Q¹ and Q² denote, independently of each other, -M³L¹_{Δ},
or
X⁴ denotes —Si(R⁸)—O-M³L¹_{Δ}; Q² denotes a single bond attached to the Si atom of X⁴; and Q¹ denotes -M⁴L⁴_{Δ},
or
X⁴ denotes —Si(R⁸)—O-M³L¹_{Δ}; Q² denotes a single bond attached to the Si atom of X⁴; and Q¹ denotes a single bond attached to the M³ atom of X⁴.

In another preferred embodiment the metal siloxane-silanol(ate) compound, used in the production of the silicone rubber compounds, has the general formula (I), where X¹, X² and X³ denote, independently of each other, Si, X⁴ denotes -M³L¹_{Δ}; and Q¹ and Q² each denote a single bond attached to M³, where L¹ is selected from the group consisting of —OH and —O—(C1 to C10 alkyl), in particular, —O—(C1 to C8 alkyl) or —O—(C1 to C6 alkyl), or where L¹ is selected from the group consisting of —OH, —O-methyl, —O-ethyl, —O-propyl, —O-butyl, —O-octyl, —O-isopropyl and —O-isobutyl, and where M³ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,

Z¹, Z² and Z³ each are selected, independently of each other, from optionally substituted C1 to C20 alkyl, optionally substituted C3 to C8 cycloalkyl, optionally substituted C2 to C20 alkenyl and optionally substituted C5 to C10 aryl,
R¹, R², R³ each are selected, independently of each other, from optionally substituted C1 to C20 alkyl, optionally substituted C3 to C8 cycloalkyl, optionally substituted C2 to C20 alkenyl and optionally substituted C5 to C10 aryl,
Y¹ and Y² are taken together and together form —O—.

In one embodiment the metal siloxane-silanol(ate) compound of the formula (I) may be present, depending on the metal equivalents, in mononuclear form as a monomer or in polynuclear form as a dimer (dinuclear), trimer (trinuclear), multimer (multinuclear) and/or mixtures thereof in the composition of the present invention and/or in the production of the silicone rubber compounds, so that, for example, structures in accordance with the formulas (Ia) to (Id) are possible.

Other polynuclear metal siloxane-silanol(ate) compounds that can be used in accordance with the invention are the structures (Ia), (Ib), (Ic) or (Id),

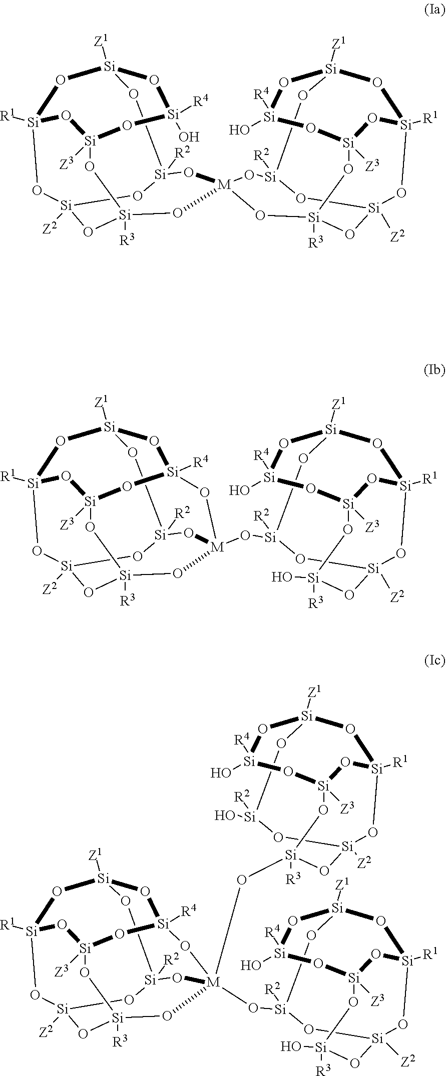

where
M is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi; and each R (R¹ to R⁴) is selected, independently of each other, from the group consisting of optionally substituted C1 to C20 alkyl, optionally substituted C3 to C8 cycloalkyl, optionally substituted C2 to C20 alkenyl, optionally substituted C5 to C10 aryl, —OH and —O—(C1 to C10 alkyl). In this case the tetravalent metal M represents a common part of several cages. The person skilled in the art knows that the number of bonds to the metal M depends on the valency of the metal M. The structural formulas (Ia) to (Ic) may have to be adapted accordingly.

In one embodiment of the composition of the present invention a mixture of the metal siloxane-silanol(ate) compounds of the formula (I), (Ia), (Ib) and (Ic) is used in said composition and/or in the production of the silicone rubber compounds.

Furthermore, the polynuclear metal siloxane-silanol(ate) compound of the formula (Id) can have 6-fold coordinated metal centers in the composition of the present invention and/or in the production of the silicone rubber compounds so that structures of the formula (Id) are possible:

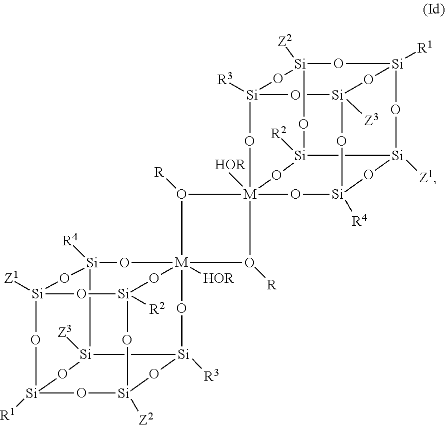

where each M is selected, independently of each other, from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi; and each R is selected, independently of each other, from the group consisting of optionally substituted C1 to C20 alkyl, optionally substituted C3 to C8 cycloalkyl, optionally substituted C2 to C20 alkenyl, optionally substituted C5 to C10 aryl, —OH and —O—(C1 to C10 alkyl).

For the purposes of the invention the term “mononuclear” describes the isolated, cage structure, i.e., present in singular form, of the inventive catalyst that is based on a metal siloxane-silanol(ate) compound. Mononuclear catalysts that are based on a metal siloxane-silanol(ate) compound can be encompassed by the structure (IV) as well as by the structures (I) and (II).

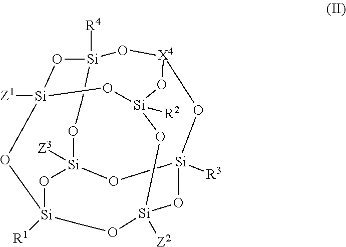

where
X⁴ denotes -M³L¹_{Δ}, where L¹ is selected from the group consisting of —OH and —O—(C1 to C10 alkyl), in particular, —O—(C1 to C8 alkyl) or —O—(C1 to C6 alkyl); or where L¹ is selected from the group consisting of —OH, —O-methyl, —O-ethyl, —O-propyl, —O-butyl, —O-octyl, —O-isopropyl and —O-isobutyl; and where M³ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,
Z¹, Z² and Z³ are selected, independently of each other, from the group consisting of optionally substituted C1 to C20 alkyl, optionally substituted C3 to C8 cycloalkyl, optionally substituted C2 to C20 alkenyl and optionally substituted C5 to C10 aryl;
R¹, R², R³ and R⁴ each are selected, independently of each other, from the group consisting of optionally substituted C1 to C20 alkyl, optionally substituted C3 to C8 cycloalkyl, optionally substituted C2 to C20 alkenyl and optionally substituted C5 to C10 aryl.

Furthermore, the invention relates to the metal siloxane-silanol(ate) compounds of the general structural formula (II) that are used in the production of the silylated polymers of the invention, where X⁴ denotes -M³L¹_{Δ}, where L¹ is selected from the group consisting of —OH and —O—(C1 to C10 alkyl), in particular, —O—(C1 to C8 alkyl) or —O—(C1 to C6 alkyl); or where L¹ is selected from the group consisting of —OH, —O— methyl, —O-ethyl, —O-propyl, —O-butyl, —O-octyl, —O-isopropyl and —O-isobutyl; and where M³ is selected from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,

Z¹, Z² and Z³ are selected, independently of each other, from the group consisting of L², R⁵, R⁶ and R⁷, where L² is selected from the group consisting of —OH and —O—(C1 to C10 alkyl), in particular, —O—(C1 to C8 alkyl) or —O—(C1 to C6 alkyl), or where L² is selected from the group consisting of —OH, —O-methyl, —O-ethyl, —O— propyl, —O-butyl, —O-octyl, —O-isopropyl and —O-isobutyl, and
R¹, R², R³, R⁴, R⁵, R⁶ and R⁷ are selected, independently of each other, from the group consisting of optionally substituted C1 to C20 alkyl, optionally substituted C3 to C8 cycloalkyl, optionally substituted C2 to C20 alkenyl and optionally substituted C5 to C10 aryl.

In a particularly advantageous embodiment the silylated polymers (SiP) of the composition of the present invention may have been produced by a catalyzed reaction with heptaisobutyl POSS titanium(IV) ethoxide (TiPOSS) as a metal siloxane-silanol(ate) compound; and/or the composition may include the latter. In this case the abbreviation “TiPOSS” stands for the mononuclear titanium-metallized silsesquioxane of the structural formula (IV) and may be used in an equivalent manner to “heptaisobutyl POSS titanium(IV) ethoxide” for the purposes of the invention.

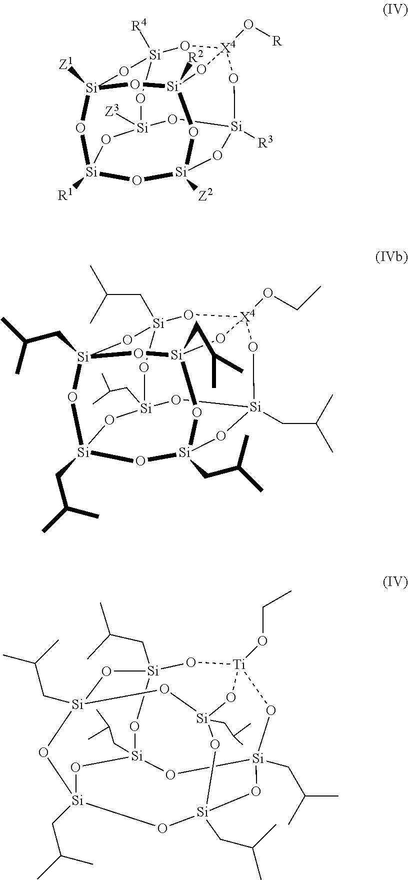

In the composition of the present invention and/or in the production of the silicone rubber compounds the metal siloxane-silanol(ate) compound may be a mixture comprising the structures (I), (la), (Ib), (Ic), (Id), (II), (IV), (IVb), (IVc).

In a preferred embodiment the metal in the metal siloxane-silanol(ate) compound is a titanium.

Very highly preferred catalysts from the group of metal siloxane-silanol(ate) compounds are heptaisobutyl POSS titanium(IV) ethoxide (TiPOSS) and heptaisobutyl POSS tin(IV) ethoxide (SnPOSS). Of these, preference is given to heptaisobutyl POSS titanium(IV) ethoxide (TiPOSS).

The catalyst B is preferably an organometallic compound. Particular preference is given to organic tin, bismuth, zinc, calcium, sodium, zirconium, aluminum or titanium compounds. Particular preference is given to tin, bismuth, zinc, calcium, sodium, zirconium, aluminum, lead, vanadium or titanium carboxylates. Extreme preference is given to bismuth carboxylates or aluminum carboxylates.

“Carboxylates” are salts of a carboxylic acid. The carboxy group (—COO—) is negatively charged; and positively charged counterions that may be considered are, for example, metal ions.

The catalyst B can be selected from the group consisting of tetraalkyl titanates, such as tetramethyl titanate, tetraethyl titanate, tetra-n-propyl titanate, tetraisopropyl titanate, tetra-n-butyl titanate, tetraisobutyl titanate, tetra-sec-butyl titanate, tetraoctyl titanate, tetra(2-ethylhexyl)titanate, dialkyl titanates ((RO)₂TiO₂, where R stands, for example, for isopropyl, n-butyl, isobutyl), such as isopropyl-n-butyl titanate; titanium acetylacetonate chelates, such as diisopropoxy bis(acetylacetonate)titanate, diisopropoxy bis(ethyl acetylacetonate)titanate, di-n-butyl bis(acetylacetonate)titanate, di-n-butyl bis(ethyl acetoacetate)titanate, triisopropoxide bis(acetylacetonate)titanate, zirconium tetraalkylates, such as zirconium tetraethylate, zirconium tetrabutylate, zirconium tetrabutyrate, zirconium tetrapropylate, zirconium carboxylates, such as zirconium diacetate; zirconium acetylacetonate chelates, such as zirconium tetra(acetylacetonate), tributoxyzirconium acetylacetonate, dibutoxyzirconium (bisacetylacetonate), aluminum trisalicylates, such as aluminum triisopropylate, aluminum sec-butylate; aluminum acetylacetonate chelates, such as aluminum tris(acetylacetonate) and aluminum tris(ethyl acetylacetonate); organotin compounds, such as dibutyltin dilaurate (DBTL), dibutyltin maleate, dibutyltin diacetate, tin(II) 2-ethylhexanoate (tin octoate), tin naphthenate, dimethyltin dineodecanoate, dioctyltin dineodecanoate, dimethyltin dioleate, dioctyltin dilaurate, dimethyltin mercaptides, dibutyltin mercaptides, dioctyltin mercaptides, dibutyltin dithioglycolate, dioctyltin glycolate, dimethyltin glycolates, a solution of dibutyltin oxide, reaction products of zinc salts and organic carboxylic acids (carboxylates), such as zinc(II) 2-ethylhexanoate or zinc(II) neodecanoate, mixtures of bismuth and zinc carboxylates, reaction products of calcium salts and organic carboxylic acids (carboxylates), such as calcium bis(2-ethylhexanoate) or calcium neodecanoate, reaction products of sodium salts and organic carboxylic acids (carboxylates), such as sodium (2-ethylhexanoate) or sodium neodecanoate, mixtures of calcium and sodium carboxylates, reaction products of bismuth salts and organic carboxylic acids, such as bismuth(III) tris(2-ethylhexanoate) and bismuth(III) tris(neodecanoate) as well as bismuth complex compounds, organolead compounds, such as lead octylate, organovanadium compounds or mixtures thereof; selected preferably from bismuth, zinc, aluminum, calcium, sodium and/or zirconium carboxylates; selected most preferably from dibutyltin dilaurate (DBTL), tin(II) 2-ethylhexanoate (tin octoate), zinc(II) 2-ethylhexanoate, zinc(II) neodecanoate (tin neodecanoate), bismuth(III) tris(2-ethylhexanoate), bismuth(III) tris(neodecanoate) (bismuth neodecanoate), titanium tetraisopropylate, titanium tetrabutylate, aluminum sec-butylate, zirconium tetraisopropylate, zirconium tetrabutylate, calcium bis(2-ethylhexanoate), sodium (2-ethylhexanoate) or mixtures thereof; extremely preferably bismuth(III) tris(neodecanoate), bismuth(III) tris(2-ethylhexanoate) or mixtures thereof; bismuth(III) tris(neodecanoate) being extremely preferred.

The catalyst B can be selected preferably from the group consisting of dibutyltin dilaurate (DBTL), tin(II) 2-ethylhexanoate (tin octoate), zinc(II) 2-ethylhexanoate, zinc(II) neodecanoate, bismuth(III) tris(2-ethylhexanoate), bismuth(III) tris(neodecanoate), titanium tetraisopropylate, titanium tetrabutylate, aluminum tri-sec-butylate, zirconium tetraisopropylate, zirconium tetrabutylate or mixtures thereof.

Catalyst B is particularly preferably bismuth(III) tris(neodecanoate), dibutyltin dilaurate (DBTL), zinc(II) 2-ethylhexanoate, zirconium tetraisopropylate, zirconium tetrabutylate or mixtures thereof.

The catalyst B is most preferably bismuth(III) tris(neodecanoate).

In a preferred composition of the present invention catalyst A is preferably TiPOSS or SnPOSS; and catalyst B is selected from the group consisting of bismuth(III) tris(neodecanoate), dibutyltin dilaurate (DBTL), zinc(II) 2-ethylhexanoate, zirconium tetraisopropylate, zirconium tetrabutylate or mixtures thereof; catalyst A being particularly preferably TiPOSS, and catalyst B being particularly preferably bismuth(III) tris(neodecanoate).

In this case the aforementioned catalysts A and B are present preferably in a relative ratio between 1:10 and 10:1. More preferably the catalysts A and B are present in a relative ratio between 1:8 and 8:1. Particularly preferably the catalysts A and B are present in a relative ratio between 1:5 and 5:1; and even more particularly preferably the catalysts A and B are in a relative ratio between 1:2 and 2:1; most preferably in a relative ratio of 0.9:1.1 to 1.1:0.9, extremely preferably in a relative ratio of 1:1, based on percent by weight.

In another preferred composition of the present invention the total amount of catalyst, composed of at least one catalyst A and one catalyst B, is between 5 and 30,000 ppm, more preferably between 15 and 20,000 ppm, particularly preferably between 20 and 15,000 ppm, most preferably between 20 and 10,000 ppm, based on the total weight of the composition.

In an alternative embodiment of a composition of the present invention three catalysts, one catalyst A and two catalysts B, are used.

In a further alternative embodiment of a composition of the present invention three catalysts, two catalysts A and one catalyst B, are used.

In a further alternative embodiment of a composition of the present invention four catalysts, two catalysts A and two catalysts B, are used.

In a further alternative embodiment of a composition of the present invention four catalysts, one catalyst A and three catalysts B, are used.

In a further alternative embodiment of a composition of the present invention four catalysts, three catalysts A and one catalyst B, are used.

In a particularly preferred embodiment the crosslinker is selected from the group consisting of oxime crosslinkers, such as vinyl tris(2-pentanone oxime)silane, methyl tris(2-pentanone oxime)silane, vinyl tris(2-propanone oxime)silane, ethyl tris(2-propanone oxime)silane, methoxyvinyl di(2-propanone oxime)silane, dimethoxyvinyl (2-propanone oxime)silane, methyl tris(2-butanone oxime)silane, phenyl tris(2-butanone oxime)silane, vinyl tris(2-butanone oxime)silane and tetra(2-butanone oxime)silane or mixtures thereof; acetate crosslinkers, such as methyltriacetoxysilane, ethyltriacetoxysilane, propyltriacetoxysilane or vinyltriacetoxysilane or mixtures thereof; lactate crosslinkers, such as tris(ethyl lactate)methylsilane or tris(ethyl lactate)vinylsilane or mixtures thereof; salicylate crosslinkers, such as tris(2-ethylhexyl salicylate)vinylsilane, tris(2-ethylhexyl salicylate)methylsilane, tris(2-ethylhexyl salicylate)propylsilane or mixtures thereof; or a mixture of all of the aforementioned crosslinkers; and catalyst A is selected from the group consisting of mononuclear metallized silsesquioxanes of the structural formula (IV) or mixtures thereof; and catalyst B is selected from the group consisting of dibutyltin dilaurate (DBTL), tin(II) 2-ethylhexanoate (tin octoate), zinc(II) 2-ethylhexanoate, zinc(II) neodecanoate, bismuth(III) tris(2-ethylhexanoate), bismuth(III) tris(neodecanoate), titanium tetraisopropylate, titanium tetrabutylate, aluminum tri-sec-butylate, zirconium tetraisopropylate, zirconium tetrabutylate or mixtures thereof.

In a very highly preferred embodiment the crosslinker is selected from the group consisting of oxime crosslinkers, such as vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane, or mixtures thereof; or acetate crosslinkers, such as methyltriacetoxysilane; and catalyst A is selected from the group consisting of mononuclear metallized silsesquioxanes of the structural formula (IV) or mixtures thereof; and catalyst B is selected from the group consisting of dibutyltin dilaurate (DBTL), tin(II) 2-ethylhexanoate (tin octoate), zinc(II) 2-ethylhexanoate, zinc(II) neodecanoate, bismuth(III) tris(2-ethylhexanoate), bismuth(III) tris(neodecanoate), titanium tetraisopropylate, titanium tetrabutylate, aluminum tri-sec-butylate, zirconium tetraisopropylate, zirconium tetrabutylate or mixtures thereof.

In an extremely preferred embodiment the crosslinker is selected from the group consisting of vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane, or mixtures thereof or methyltriacetoxysilane; and catalyst A is selected from the group consisting of mononuclear titanium or tin-metallized silsesquioxanes of the structural formula (IVb) or mixtures thereof; and catalyst B is selected from the group consisting of bismuth(III) tris(neodecanoate), dibutyltin dilaurate (DBTL), zinc(II) 2-ethylhexanoate, zirconium tetraisopropylate, zirconium tetrabutylate or mixtures thereof.

In a very highly preferred embodiment the crosslinker is selected from the group consisting of vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane or mixtures thereof; and catalyst A is TiPOSS or SnPOSS; and catalyst B is bismuth(III) tris(neodecanoate).

If desired, the composition of the present invention may comprise other conventional additives. Conventional additives are fillers, colorants, plasticizers, thixotropic agents, wetting agents, bonding agents, catalysts, and others.

Both reinforcing and non-reinforcing fillers as well as fillers that influence thixotropy can be used as fillers. Preference is given to the use of such inorganic fillers as, for example, highly dispersed, fumed or precipitated silicas, carbon black, quartz powder, chalk, or metal salts or metal oxides, such as, for example, titanium oxides. In addition, hollow plastic spheres and glass spheres, as well as fatty acid amides and hydrogenated castor oil are also used as thixotropic agents. A particularly preferred filler is a highly dispersed silica, such as that available, for example, under the name CAB-O-SIL 150 from Cabot or Aerosil 150 or Aerosil 200. Extremely strong preference is given to fumed silica (150 and 200 m²/g, Aerosil, Evonik). Fillers, such as highly dispersed silicas, in particular, fumed silicas, can also be used as thixotropic agents. Metal oxides can also be used as colorants, for example, titanium oxides as white colorants. The fillers can also be surface-modified by conventional methods. For example, silicas, hydrophobized with silanes, can be used.

Plasticizers that can be used include well-known polydiorganosiloxanes without functional end groups, which are, thus, different from the hydroxy-functionalized polyorganosiloxane compounds that are used in accordance with the invention, and/or liquid aliphatic or aromatic hydrocarbons, preferably those having molecular weights of about 50 to about 5,000, the volatility of which is low and which are sufficiently compatible with polysiloxanes. Plasticizers have preferably a kinematic viscosity of 1 to 5,000 cSt (at 25° C.), in particular, 50 to 500 cSt, and particularly preferably 90 to 200 cSt. Examples of plasticizers include polydimethylsiloxanes having a viscosity of 90 to 120 cSt, in particular, 100 cSt, paraffin oils, phthalates (diisononyl phthalate) and diisononyl cyclohexane esters DINCH® and polysubstituted alkyl benzenes.

Wetting agents and/or bonding agents (adhesion promoters) that may be used comprise well-known silane compounds, which have organic substituents on the silicon atom and which are different from the hydroxy-functionalized polyorganosiloxane compounds that are used in accordance with the invention. For example, organosilanes having reactive amine, carboxylic acid, epoxy or thiol groups can be used. Specific examples of bonding agents (adhesion promoters) having amine, carboxylic acid or thiol reactive groups include aminosilanes, such as aminoethylaminopropyltrialkoxysilanes. Concrete examples of such bonding agents (adhesion promoters) are 3-aminopropyltriethoxysilane, 3-aminopropyltrimethoxysilane, aminoethylaminopropyltrimethoxysilane, butylaminopropyltriethoxysilane, butylaminopropyltrimethoxysilane, propylaminopropyltriethoxysilane, propylaminopropyltrimethoxysilane, N-cyclohexyl-3-aminopropyltrimethoxysilane, N-cyclohexyl-3-aminopropyltriethoxysilane, and so-called co-oligomeric diamino/alkyl functional silane, which is available as Dynasylan 1146 from Evonik.

Bonding agents (adhesion promoters) that may also be used include the following silane compounds having other functional groups. For example, organosilanes having tertiary amine, urea, amide, carbamate, or isocyanurate groups can be used. Concrete examples of such bonding agents (adhesion promoters) are N,N′-bis(triethoxysilylpropyl)urea, tris(triethoxysilylpropyl)diethylenetriurea, dimethylaminopropyltrimethoxysilane, 1,3,5-tris(trimethoxysilylpropyl)isocyanurate, N-methyl(3-trimethoxysilylpropyl)carbamate and N-ethyl(3-triethoxysilylpropyl)carbamate. In particular, mixtures of these substances can also be used as bonding agents (adhesion promoters).

Furthermore, the mixtures can include UV stabilizers (for example, Hals=hindered amine lights stabilizers) and desiccants (for example, vinyltrimethoxysilane).

The composition of the present invention can comprise 30 to 80% by weight, preferably 35 to 70% by weight, more preferably 40 to 60% by weight, of the hydroxy-functionalized polyorganosiloxane compound, based in each case on the total weight of the composition of the present invention.

The composition of the present invention can also comprise 5 to 50% by weight, preferably 10 to 40% by weight, of filler, in particular, as a thixotropic agent, based in each case on the total weight of the composition of the present invention.

The composition of the present invention can also comprise 10 to 50% by weight, preferably 20 to 40% by weight, of plasticizer, based in each case on the total weight of the composition of the present invention.

Advantageous embodiments of the invention are explained in detail below.

One embodiment of the invention is a composition comprising the following components:
at least one hydroxy-functionalized polyorganosiloxane compound,
at least one crosslinker,
at least two different catalysts A and B, where the catalyst A is selected from the group of metal siloxane-silanol(ate) compounds, and catalyst B is selected from a group of catalysts that does not comprise metal siloxane-silanol(ate) compounds.

Another embodiment of the invention is a composition comprising the following components:
at least one α,ω-dihydroxypolyorganosiloxane compound,
at least one crosslinker,
at least two different catalysts A and B, where the catalyst A comprises at least one metal siloxane-silanol(ate) compound of the general formula R*_{q}SiᵣOₛMₜ and is defined as herein, and catalyst B is selected from the group of organometal compounds.

Another embodiment of the invention is a composition comprising the following components:
at least one α,ω-dihydroxypolyorganosiloxane that has a kinematic viscosity, according to DIN 53019-1:2008-09, of at least 10,000 cSt, preferably at least 20,000 cSt, particularly preferably at least 50,000 cSt, most preferably a kinematic viscosity of about 80,000 cSt,
at least one crosslinker selected from the group consisting of hydroxycarboxylic acid ester crosslinker, hydroxycarboxamide crosslinker, salicylate crosslinker, oxime crosslinker, carboxamide crosslinker, acetate crosslinker, amine crosslinker or mixed crosslinker,
at least two catalysts A and B, where the catalyst A comprises at least one siloxane-silanol(ate) compound, a metal silsesquioxane, of the structure (IV) and is defined as herein.

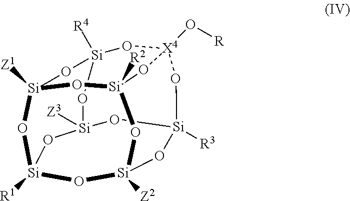

A further embodiment of the invention is a composition comprising the following components:
at least one α,ω-dihydroxypolyorganosiloxane, which has a kinematic viscosity, according to DIN 53019-1:2008-09, of at least 50,000 cSt, most preferably a kinematic viscosity of about 80,000 cSt,
at least one crosslinker selected from the group consisting of salicylate crosslinker, oxime crosslinker, and/or acetate crosslinker,
at least two catalysts A and B, where the catalyst A comprises at least one metal siloxane-silanol(ate) compound of the structure (IVb) and is defined as herein,

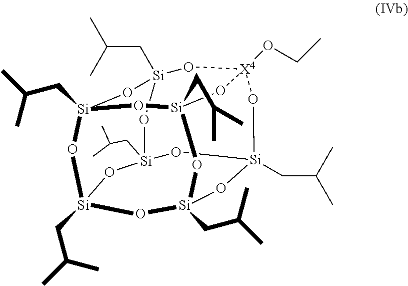

and catalyst B is selected from the group consisting of tetraalkyl titanates, such as tetramethyl titanate, tetraethyl titanate, tetra-n-propyl titanate, tetraisopropyl titanate, tetra-n-butyl titanate, tetraisobutyl titanate, tetra-sec-butyl titanate, tetraoctyl titanate, tetra(2-ethylhexyl)titanate, dialkyl titanates ((RO)₂TiO₂, where R stands, for example, for isopropyl, n-butyl, isobutyl), such as isopropyl-n-butyl titanate; titanium acetylacetonate chelates, such as diisopropoxy bis(acetylacetonate)titanate, diisopropoxy bis(ethyl acetylacetonate)titanate, di-n-butyl bis(acetylacetonate)titanate, di-n-butyl bis(ethyl acetoacetate)titanate, triisopropoxide bis(acetylacetonate)titanate, zirconium tetraalkylates, such as zirconium tetraethylate, zirconium tetrabutylate, zirconium tetrabutyrate, zirconium tetrapropylate, zirconium carboxylates, such as zirconium diacetate; zirconium acetylacetonate chelates, such as zirconium tetra(acetylacetonate), tributoxyzirconium acetylacetonate, dibutoxyzirconium (bisacetylacetonate), aluminum trisalicylates, such as aluminum triisopropylate, aluminum sec-butylate; aluminum acetylacetonate chelates, such as aluminum tris(acetylacetonate) and aluminum tris(ethyl acetylacetonate); organotin compounds, such as dibutyltin dilaurate (DBTL), dibutyltin maleate, dibutyltin diacetate, tin(II) 2-ethylhexanoate (tin octoate), tin naphthenate, dimethyltin dineodecanoate, dioctyltin dineodecanoate, dimethyltin dioleate, dioctyltin dilaurate, dimethyltin mercaptide, dibutyltin mercaptide, dioctyltin mercaptide, dibutyltin dithioglycolate, dioctyltin glycolate, dimethyltin glycolates, a solution of dibutyltin oxide, reaction products of zinc salts and organic carboxylic acids (carboxylates), such as zinc(II) 2-ethylhexanoate or zinc(II) neodecanoate, mixtures of bismuth and zinc carboxylates, reaction products of calcium salts and organic carboxylic acids (carboxylates), such as calcium bis(2-ethylhexanoate) or calcium neodecanoate, reaction products of sodium salts and organic carboxylic acids (carboxylates), such as sodium (2-ethylhexanoate) or sodium neodecanoate, mixtures of calcium and sodium carboxylates, reaction products of bismuth salts and organic carboxylic acids, such as bismuth(III) tris(2-ethylhexanoate) and bismuth(III) tris(neodecanoate) as well as bismuth complex compounds, organolead compounds, such as lead octylate, organovanadium compounds or mixtures thereof; selected preferably from bismuth, zinc, aluminum, calcium, sodium, and/or zirconium carboxylates; selected most preferably from dibutyltin dilaurate (DBTL), tin(II) 2-ethylhexanoate (tin octoate), zinc(II) 2-ethylhexanoate, zinc(II) neodecanoate (tin neodecanoate), bismuth(III) tris(2-ethylhexanoate), bismuth(III) tris(neodecanoate) (bismuth neodecanoate), titanium tetraisopropylate, titanium tetrabutylate, aluminum sec-butylate, zirconium tetraisopropylate, zirconium tetrabutylate, calcium bis(2-ethylhexanoate), sodium (2-ethylhexanoate) or mixtures thereof; extremely preferably bismuth(III) tris(neodecanoate), bismuth(III) tris(2-ethylhexanoate) or mixtures thereof; bismuth(III) tris(neodecanoate) being extremely preferred.

A preferred embodiment of the invention is a composition comprising the following components:
at least one α,ω-dihydroxypolyorganosiloxane, which has a kinematic viscosity, according to DIN 53019-1:2008-09, of at least 50,000 cSt, most preferably a kinematic viscosity of about 80,000 cSt,
at least one crosslinker selected from the group consisting of salicylate crosslinker, oxime crosslinker, and/or acetate crosslinker,
at least two catalysts A and B, where the catalyst A comprises heptaisobutyl POSS tin(IV) ethoxide (SnPOSS) or heptaisobutyl POSS titanium(IV) ethoxide (TiPOSS); and catalyst B is selected from the group consisting of dibutyltin dilaurate (DBTL), tin(II) 2-ethylhexanoate (tin octoate), zinc(II) 2-ethylhexanoate, zinc(II) neodecanoate (tin neodecanoate), bismuth(III) tris(2-ethylhexanoate), bismuth(III) tris(neodecanoate) (bismuth neodecanoate), titanium tetraisopropylate, titanium tetrabutylate, aluminum sec-butylate, zirconium tetraisopropylate, zirconium tetrabutylate or mixtures thereof, bismuth(III) tris(neodecanoate) being extremely preferred.

A sealant formulation of the composition of the present invention comprises the following components:
at least one hydroxy-functionalized polyorganosiloxane compound,
at least one crosslinker,
at least two catalysts A and B, where the catalyst A is selected from the group of metal siloxane-silanol(ate) compounds; and catalyst B is selected from a group of catalysts that does not comprise metal siloxane-silanol(ate) compounds,
plasticizers,
fillers and
adhesion promoters.

Another sealant formulation of the composition of the present invention comprises the following components:
at least one α,ω-dihydroxypolyorganosiloxane compound,
at least one crosslinker,
at least two catalysts A and B, where the catalyst A comprises at least one metal siloxane-silanol(ate) compound of the general formula R*_{q}SiᵣOₛMₜ and is defined as herein, and catalyst B is selected from the group of organometallic compounds,
plasticizers, such as polydiorganosiloxanes without functional end groups, which are, thus, different from the hydroxy-functionalized polyorganosiloxane compounds that are used in accordance with the invention, and/or liquid aliphatic or aromatic hydrocarbons, preferably those with molecular weights of about 50 to about 5,000, the volatility of which is low and which are sufficiently compatible with polysiloxanes,
fillers, such as highly dispersed, fumed or precipitated silicas, carbon black, quartz powder, chalk, and/or metal salts or metal oxides, such as, for example, titanium oxides, and
adhesion promoters, such as silane compounds, which have organic substituents on the silicon atom and which are different from the hydroxy-functionalized polyorganosiloxane compounds that are used in accordance with the invention.

A preferred sealant formulation of the composition of the present invention comprises the following components:
at least one α,ω-dihydroxypolyorganosiloxane that has a kinematic viscosity, according to DIN 53019-1:2008-09, of at least 50,000 cSt, most preferably a kinematic viscosity of about 80,000 cSt,
at least one crosslinker selected from the group consisting of salicylate crosslinker, oxime crosslinker, and/or acetate crosslinker,
at least two catalysts A and B, where the catalyst A is heptaisobutyl POSS tin(IV) ethoxide (SnPOSS) or heptaisobutyl POSS titanium(IV) ethoxide (TiPOSS); and catalyst B is selected from the group consisting of dibutyltin dilaurate (DBTL), tin(II) 2-ethylhexanoate (tin octoate), zinc(II) 2-ethylhexanoate, zinc(II) neodecanoate (tin neodecanoate), bismuth(III) tris(2-ethylhexanoate), bismuth(III) tris(neodecanoate) (bismuth neodecanoate), titanium tetraisopropylate, titanium tetrabutylate, aluminum sec-butylate, zirconium tetraisopropylate, zirconium tetrabutylate or mixtures thereof, bismuth(III) tris(neodecanoate) being extremely preferred,
   plasticizers, such as polydiorganosiloxanes without functional end groups, which are, thus, different from the hydroxy-functionalized polyorganosiloxane compounds that are used in accordance with the invention, and/or liquid aliphatic or aromatic hydrocarbons, preferably those with molecular weights of about 50 to about 5,000, the volatility of which is low and which are sufficiently compatible with polysiloxanes,
   fillers, such as highly dispersed, fumed or precipitated silicas, carbon black, quartz powder, chalk, and/or metal salts or metal oxides, such as, for example, titanium oxides, and
   adhesion promoters, such as silane compounds, which have organic substituents on the silicon atom and which are different from the hydroxy-functionalized polyorganosiloxane compounds that are used in accordance with the invention.

A particularly preferred sealant formulation of the composition of the present invention comprises the following components:
at least one α,ω-dihydroxypolyorganosiloxane compound, which has a kinematic viscosity, according to DIN 53019-1:2008-09, of at least 50,000 cSt, most preferably a kinematic viscosity of about 80,000 cSt,
at least one crosslinker selected from the group consisting of oxime crosslinkers and acetate crosslinkers,
at least two catalysts A and B, where the catalyst A is heptaisobutyl POSS tin(IV) ethoxide (SnPOSS) or heptaisobutyl POSS titanium(IV) ethoxide (TiPOSS); and catalyst B is selected from the group consisting of dibutyltin dilaurate (DBTL), tin(II) 2-ethylhexanoate (tin octoate), zinc(II) 2-ethylhexanoate, zinc(II) neodecanoate (tin neodecanoate), bismuth(III) tris(2-ethylhexanoate), bismuth(III) tris(neodecanoate) (bismuth neodecanoate), titanium tetraisopropylate, titanium tetrabutylate, aluminum sec-butylate, zirconium tetraisopropylate, zirconium tetrabutylate or mixtures thereof, bismuth(III) tris(neodecanoate) being extremely preferred,
plasticizers, such as polydiorganosiloxanes without functional end groups, which are, thus, different from the hydroxy-functionalized polyorganosiloxane compounds that are used in accordance with the invention, and/or liquid aliphatic or aromatic hydrocarbons, preferably those with molecular weights of about 50 to about 5,000, the volatility of which is low and which are sufficiently compatible with polysiloxanes,
   fillers, such as highly dispersed, fumed or precipitated silicas, carbon black, quartz powder, chalk, and/or metal salts or metal oxides, such as, for example, titanium oxides, and
   adhesion promoters, such as silane compounds, which have organic substituents on the silicon atom and which are different from the hydroxy-functionalized polyorganosiloxane compounds that are used in accordance with the invention.

### EMBODIMENTS

1. Composition, comprising at least one hydroxy-functionalized polyorganosiloxane compound, at least one crosslinker and at least two catalysts A and B, where the catalyst A is selected from the group of metal siloxane-silanol(ate) compounds; and catalyst B is selected from a group of catalysts that does not comprise metal siloxane-silanol(ate) compounds.
2. Composition, according to embodiment 1, characterized in that the catalyst B is selected from the group of organometallic compounds.
3. Composition, according to embodiment 1 or 2, characterized in that the catalyst B is selected from the group consisting of catalysts comprising bismuth, zinc, calcium, sodium, tin, aluminum, zirconium, lead, vanadium and/or titanium.
4. Composition, according to any one of the preceding embodiments, characterized in that the catalyst B is selected from the group consisting of tetraalkyl titanates, such as tetramethyl titanate, tetraethyl titanate, tetra-n-propyl titanate, tetraisopropyl titanate, tetra-n-butyl titanate, tetraisobutyl titanate, tetra-sec-butyl titanate, tetraoctyl titanate, tetra(2-ethylhexyl)titanate, dialkyl titanates ((RO)₂TiO₂, where R stands, for example, for isopropyl, n-butyl, isobutyl), such as isopropyl-n-butyl titanate; titanium acetylacetonate chelates, such as diisopropoxy bis(acetylacetonate)titanate, diisopropoxy bis(ethyl acetylacetonate)titanate, di-n-butyl bis(acetylacetonate)titanate, di-n-butyl bis(ethyl acetoacetate)titanate, triisopropoxide bis(acetylacetonate)titanate, zirconium tetraalkylates, such as zirconium tetraethylate, zirconium tetrabutylate, zirconium tetrabutyrate, zirconium tetrapropylate, zirconium carboxylates, such as zirconium diacetate; zirconium acetylacetonate chelates, such as zirconium tetra(acetylacetonate), tributoxyzirconium acetylacetonate, dibutoxyzirconium (bisacetylacetonate), aluminum trisalicylates, such as aluminum triisopropylate, aluminum sec-butylate; aluminum acetylacetonate chelates, such as aluminum tris(acetylacetonate) and aluminum tris(ethyl acetylacetonate); organotin compounds, such as dibutyltin dilaurate (DBTL), dibutyltin maleate, dibutyltin diacetate, tin(II) 2-ethylhexanoate (tin octoate), tin naphthenate, dimethyltin dineodecanoate, dioctyltin dineodecanoate, dimethyltin dioleate, dioctyltin dilaurate, dimethyltin mercaptides, dibutyltin mercaptides, dioctyltin mercaptides, dibutyltin dithioglycolate, dioctyltin glycolate, dimethyltin glycolates, a solution of dibutyltin oxide, reaction products of zinc salts and organic carboxylic acids (carboxylates), such as zinc(II) 2-ethylhexanoate or zinc(II) neodecanoate, mixtures of bismuth and zinc carboxylates, reaction products of calcium salts and organic carboxylic acids (carboxylates), such as calcium bis(2-ethylhexanoate) or calcium neodecanoate, reaction products of sodium salts and organic carboxylic acids (carboxylates), such as sodium (2-ethylhexanoate) or sodium neodecanoate, mixtures of calcium and sodium carboxylates, reaction products of bismuth salts and organic carboxylic acids, such as bismuth(III) tris(2-ethylhexanoate) and bismuth(III) tris(neodecanoate) as well as bismuth complex compounds, organolead compounds, such as lead octylate, organovanadium compounds or mixtures thereof; selected preferably from bismuth, zinc, aluminum, calcium, sodium, and/or zirconium carboxylates; selected most preferably from dibutyltin dilaurate (DBTL), tin(II) 2-ethylhexanoate (tin octoate), zinc(II) 2-ethylhexanoate, zinc(II) neodecanoate (tin neodecanoate), bismuth(III) tris(2-ethylhexanoate), bismuth(III) tris(neodecanoate) (bismuth neodecanoate), titanium tetraisopropylate, titanium tetrabutylate, aluminum sec-butylate, zirconium tetraisopropylate, zirconium tetrabutylate, calcium bis(2-ethylhexanoate), sodium (2-ethylhexanoate) or mixtures thereof; extremely preferably bismuth(III) tris(neodecanoate), bismuth(III) tris(2-ethylhexanoate) or mixtures thereof; bismuth(III) tris(neodecanoate) being extremely preferred.
5. Composition, according to any one of the preceding embodiments, characterized in that the composition can be obtained by mixing the components comprised therein.
6. Composition, according to any one of the preceding embodiments, characterized in that the hydroxy-functionalized polyorganosiloxane compound is an α,ω-dihydroxypolyorganosiloxane.
7. Composition, according to embodiment 6, characterized in that the α,ω-dihydroxypolyorganosiloxane has a kinematic viscosity, according to DIN 53019-1:2008-09, of at least 10,000 cSt, preferably at least 20,000 cSt, more preferably at least 50,000 cSt, most preferably a kinematic viscosity of about 80,000 cSt.
8. Composition, according to any one of the preceding claims, characterized in that the crosslinker is selected from the group consisting of oxime crosslinkers, such as vinyl tris(2-pentanone oxime)silane, ethyl tris(2-propanone oxime)silane, methyl tris(2-pentanone oxime)silane, vinyl tris(2-propanone oxime)silane, methoxyvinyl di(2-propanone oxime)silane, dimethoxyvinyl (2-propanone oxime)silane, methyl tris(2-butanone oxime)silane, phenyl tris(2-butanone oxime)silane, vinyl tris(2-butanone oxime)silane and tetra(2-butanone oxime)silane or mixtures thereof; acetate crosslinkers, such as methyltriacetoxysilane, ethyltriacetoxysilane, propyltriacetoxysilane or vinyltriacetoxysilane or mixtures thereof; lactate crosslinkers, such as tris(ethyl lactate)methylsilane or tris(ethyl lactate)vinylsilane or mixtures thereof; salicylate crosslinkers, such as tris(2-ethylhexyl salicylate)vinylsilane, tris(2-ethylhexyl salicylate)methylsilane, tris(2-ethylhexyl salicylate) propylsilane or mixtures thereof; or a mixture of all of the aforementioned crosslinkers.
9. Composition, according to any one of the preceding claims, characterized in that the crosslinker is selected from the group consisting of oxime crosslinkers, such as vinyl tris(2-pentanone oxime)silane, ethyl tris(2-propanone oxime)silane, methyl tris(2-pentanone oxime)silane, vinyl tris(2-propanone oxime)silane, methoxyvinyl di(2-propanone oxime)silane, dimethoxyvinyl (2-propanone oxime)silane, methyl tris(2-butanone oxime)silane, phenyl tris(2-butanone oxime)silane, vinyl tris(2-butanone oxime)silane and tetra(2-butanone oxime)silane or mixtures thereof; acetate crosslinkers, such as methyltriacetoxysilane, ethyltriacetoxysilane, propyltriacetoxysilane or vinyltriacetoxysilane or mixtures thereof; or a mixture of all of the aforementioned crosslinkers.
10. Composition, according to any one of the preceding claims, characterized in that the crosslinker is selected from the group consisting of oxime crosslinkers, such as vinyl tris(2-pentanone oxime)silane, ethyl tris(2-propanone oxime)silane, methyl tris(2-pentanone oxime)silane, vinyl tris(2-propanone oxime)silane, methoxyvinyl di(2-propanone oxime)silane, dimethoxyvinyl (2-propanone oxime)silane, methyl tris(2-butanone oxime)silane, phenyl tris(2-butanone oxime)silane, vinyl tris(2-butanone oxime)silane and tetra(2-butanone oxime)silane or mixtures thereof.
11. Composition, according to any one of the preceding embodiments, characterized in that the metal siloxane-silanol(ate) compound has the general formula R*_{q}SiᵣOₛMₜ, where each R* is selected, independently of each other, from the group consisting of optionally substituted C1 to C20 alkyl, optionally substituted C3 to C6 cycloalkyl, optionally substituted C2 to C20 alkenyl, optionally substituted C6 to C10 aryl, —OH and —O—(C1 to C10 alkyl), each M being selected, independently of each other, from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,
   q is an integer from 4 to 19,
   r is an integer from 4 to 10,
   s is an integer from 8 to 30, and
   t is an integer from 1 to 8.
12. Composition, according to embodiment 11, characterized in that the metal siloxane-silanol(ate) compound has a general structure (I),

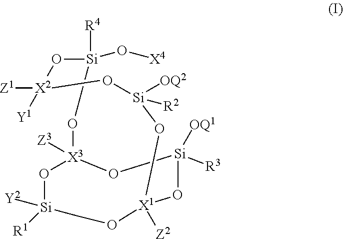

where
X¹, X² and X³ are selected, independently of each other, from Si or M¹, where M¹ is selected from the group consisting of s and p block metals, d and f block transition metals, lanthanide and actinide metals and semimetals,
in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,
Z¹, Z² and Z³ are selected, independently of each other, from the group consisting of L², R⁵, R⁶ and R⁷, where L² is selected from the group consisting of —OH and —O—(C1 to C10 alkyl), in particular, —O—(C1 to C8 alkyl) or —O—(C1 to C6 alkyl), or
where L² is selected from the group consisting of —OH, —O-methyl, —O-ethyl, —O-propyl, —O-butyl, —O— octyl, —O-isopropyl and —O-isobutyl;
R¹, R², R³, R⁴, R⁵, R⁶ and R⁷ are selected, independently of each other, from the group consisting of optionally substituted C1 to C20 alkyl, optionally substituted C3 to C8 cycloalkyl, optionally substituted C2 to C20 alkenyl and optionally substituted C5 to C10 aryl;
Y¹ and Y² denote, independently of each other, —O-M²-L³_{Δ}, or Y¹ and Y² are taken together and together denote —O-M²(L³_{Δ})-O— or —O—, where L³ is selected from the group consisting of —OH and —O—(C1 to C10 alkyl), in particular, —O—(C1 to C8 alkyl) or —O—(C1 to C6 alkyl), or where L³ is selected from the group consisting of —OH, —O-methyl, —O-ethyl, —O-propyl, —O-butyl, —O-octyl, —O-isopropyl and —O-isobutyl, and where M² is selected from the group consisting of s and p block metals, d and f block transition metals, lanthanide and actinide metals and semimetals,
in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, and
X⁴ denotes -M³L¹_{Δ} or M³; and Q¹ and Q² denote H or each a single bond attached to M³, where L¹ is selected from the group consisting of —OH and —O—(C1 to C10 alkyl), in particular, —O—(C1 to C8 alkyl) or —O—(C1 to C6 alkyl), or where L¹ is selected from the group consisting of —OH, —O-methyl, —O— ethyl, —O-propyl, —O-butyl, —O-octyl, —O-isopropyl and —O-isobutyl, and where M³ is selected from the group consisting of s and p block metals, d and f block transition metals, lanthanide and actinide metals and semimetals,
in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,
or
X⁴ denotes -M³L¹_{Δ}; and Q² denotes H or a single bond attached to M³; and Q¹ denotes H, M⁴L⁴_{Δ} or —SiR^{B}, where M⁴ is selected from the group consisting of s and p block metals, d and f block transition metals, lanthanide and actinide metals and semimetals,
in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, and where L⁴ is selected from the group consisting of —OH and —O—(C1 to C10 alkyl), in particular, —O—(C1 to C8 alkyl) or —O—(C1 to C6 alkyl), or where L⁴ is selected from the group consisting of —OH, —O-methyl, —O-ethyl, —O-propyl, —O-butyl, —O-octyl, —O-isopropyl and —O-isobutyl, and where R⁸ is selected from the group consisting of optionally substituted C1 to C20 alkyl, optionally substituted C3 to C8 cycloalkyl, optionally substituted C2 to C20 alkenyl and optionally substituted C5 to C10 aryl,
or
X⁴, Q¹ and Q² denote, independently of each other, -M³L¹_{Δ},
or
X⁴ denotes —Si(R⁸)—O-M³L¹_{Δ}; Q² denotes a single bond attached to the Si atom of X⁴; and Q¹ denotes -M⁴L⁴_{Δ},
or
X⁴ denotes —Si(R⁸)—O-M³L¹_{Δ}; Q² denotes a single bond attached to the Si atom of X⁴; and Q¹ denotes a single bond attached to the M³ atom of X⁴.
13. Composition, according to any one of the preceding embodiments, characterized in that the metal siloxane-silanol(ate) compound has the structural formula (II)

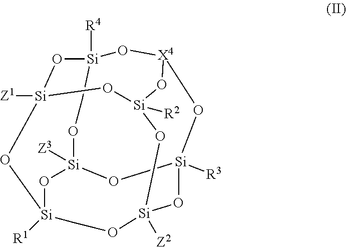

where X⁴, R¹, R², R³, R⁴, Z¹, Z² and Z³ are defined according to embodiment 12.
14. Composition, according to embodiment 13, characterized in that the metal siloxane-silanol(ate) compound is a metal silsesquioxane of the structure (IV),

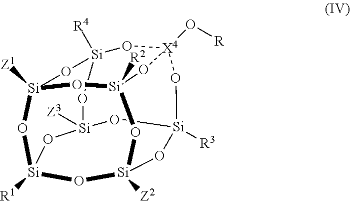

where
X⁴ is selected from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, most preferably from the group consisting of Ti and Sn, Ti being most preferred, and
X⁴ is linked to OR, where R is selected from the group consisting of H, methyl, ethyl, propyl, butyl, octyl, isopropyl and isobutyl; Z¹, Z² and Z³ each denote, independently of each other, C1 to C20 alkyl, C3 to C8 cycloalkyl, C2 to C20 alkenyl and C5 to C10 aryl, in particular, are selected from the group consisting of methyl, ethyl, propyl, isopropyl, butyl, isobutyl, hexyl, heptyl, octyl, vinyl, allyl, butenyl and phenyl, and benzyl; and R¹, R², R³ and R⁴ each denote, independently of each other, C1 to C20 alkyl, C3 to C8 cycloalkyl, C2 to C20 alkenyl, and C5 to C10 aryl; in particular, are selected from the group consisting of methyl, ethyl, propyl, isopropyl, butyl, isobutyl, hexyl, heptyl, octyl, vinyl, allyl, butenyl and phenyl, and benzyl.
15. Composition, according to embodiment 14, characterized in that the metal siloxane-silanol(ate) compound is a metal silsesquioxane of the structure (IVb),

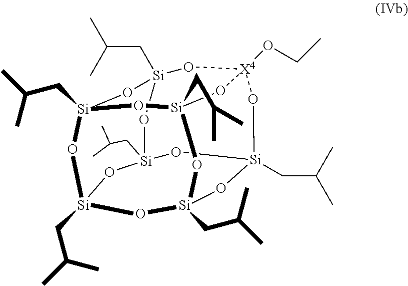

where
X⁴ is selected from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, most preferably from the group consisting of Ti (and is, therefore, heptaisobutyl POSS titanium(IV) ethoxide (TiPOSS)) and Sn (and is, therefore, heptaisobutyl POSS tin(IV) ethoxide (SnPOSS)); and most preferably Ti (and is, therefore, heptaisobutyl POSS titanium(IV) ethoxide (TiPOSS)).
16. Composition, according to any one of the preceding embodiments, characterized in that the metal siloxane-silanol(ate) compound is present in a molar concentration in the range of 0.000001 to 0.01 mol/kg, in particular, 0.00005 to 0.005 mol/kg or 0.00007 to 0.001 mol/kg, in each case based on the total weight of the composition.
17. Composition, according to any one of the preceding embodiments, characterized in that the metal siloxane-silanol(ate) compound is present in a proportion by weight of 0.001 to 0.5%, preferably 0.006 to 0.1%.
18. Composition, according to any one of the preceding embodiments, characterized in that the crosslinker is selected from the group consisting of oxime crosslinkers, such as vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane or mixtures thereof; or acetate crosslinkers, such as methyltriacetoxysilane; and catalyst A is selected from the group consisting of mononuclear metallized silsesquioxanes of the structural formula (IV) or mixtures thereof; and catalyst B is selected from the group consisting of dibutyltin dilaurate (DBTL), tin(II) 2-ethylhexanoate (tin octoate), zinc(II) 2-ethylhexanoate, zinc(II) neodecanoate, calcium bis(2-ethylhexanoate), sodium (2-ethylhexanoate), bismuth(III) tris(2-ethylhexanoate), bismuth(III) tris(neodecanoate), titanium tetraisopropylate, titanium tetrabutylate, aluminum sec-butylate, zirconium tetraisopropylate, zirconium tetrabutylate or mixtures thereof. 19. Composition, according to embodiment 18, characterized in that the crosslinker is selected from the group consisting of vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane or mixtures thereof, methyltriacetoxysilane and ethyltriacetoxysilane or mixtures thereof; and catalyst A is selected from the group consisting of mononuclear titanium or tin-metallized silsesquioxanes of the structural formula (IVb) or mixtures thereof; and catalyst B is selected from the group consisting of bismuth(III) tris(neodecanoate), dibutyltin dilaurate (DBTL), zinc(II) 2-ethylhexanoate, zirconium tetraisopropylate, zirconium tetrabutylate or mixtures thereof.
20. Composition, according to embodiment 18 or 19, characterized in that the crosslinker is selected from the group consisting of vinyl tris(2-pentanone oxime)silane, methyl tris(2-pentanone oxime)silane, vinyl tris(2-propanone oxime)silane, methoxyvinyl di(2-propanone oxime)silane, dimethoxyvinyl (2-propanone oxime)silane or mixtures thereof or methyltriacetoxysilane; and catalyst A is TiPOSS or SnPOSS, is preferably TiPOSS; and catalyst B is bismuth(III) tris(neodecanoate).
21. Composition, according to any one of the preceding embodiments, characterized in that the hydroxy-functionalized polyorganosiloxane compound is an α,ω-dihydroxypolyorganosiloxane and has a kinematic viscosity, according to DIN 53019-1:2008-09, of at least 50,000 cSt; the crosslinker is selected from the group consisting of vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane or mixtures thereof or methyltriacetoxysilane; and catalyst A is TiPOSS or SnPOSS, is preferably TiPOSS; and catalyst B is bismuth(III) tris(neodecanoate).
22. Composition, according to any one of the preceding embodiments, characterized in that the catalysts A and B are present in a relative ratio between 1:10 and 10:1; more preferably the catalysts A and B are present in a relative ratio between 1:8 and 8:1; particularly preferably the catalysts A and B are present in a relative ratio between 1:5 and 5:1; more preferably the catalysts A and B are present in a relative ratio between 1:2 and 2:1; most preferably in a relative ratio of 0.9:1.1 to 1.1:0.9; extremely preferably in a relative ratio of 1:1, based on percent by weight.
23. Composition, according to embodiment 22, characterized in that catalyst A is TiPOSS or SnPOSS; and catalyst B is selected from the group consisting of bismuth(III) tris(neodecanoate), dibutyltin dilaurate (DBTL), zinc(II) 2-ethylhexanoate, zirconium tetraisopropylate, zirconium tetrabutylate or mixtures thereof; it is particularly preferred that catalyst A be TiPOSS and that catalyst B be bismuth(III) tris(neodecanoate).
24. Use of a catalyst A, comprising a metal siloxane-silanol(ate) compound, and a catalyst B, where the catalyst A is defined according to any one of the embodiments 1, 11 to 15, 19 to 21 or 23; and the catalyst B, which is defined according to any one of the embodiments 2 to 4, 18 to 21 or 23, for crosslinking a composition obtainable by admixture with a hydroxy-functionalized polyorganosiloxane compound, defined according to any one of the embodiments 6, 7 or 21, and with at least one crosslinker, defined according to any one of the embodiments 8 or 18 to 20.
25. Use of TiPOSS or SnPOSS, as catalyst A, and a catalyst B, selected from the group consisting of dibutyltin dilaurate (DBTL), tin(II) 2-ethylhexanoate (tin octoate), zinc(II) 2-ethylhexanoate, zinc(II) neodecanoate, bismuth(III) tris(2-ethylhexanoate), bismuth(III) tris(neodecanoate), titanium tetraisopropylate, titanium tetrabutylate, aluminum sec-butylate, zirconium tetraisopropylate, zirconium tetrabutylate or mixtures thereof.
26. Method for producing a composition, wherein said method comprises the following process steps:
   a. providing a composition comprising
      i. at least one hydroxy-functionalized polyorganosiloxane compound, defined according to embodiment 6, 7 or 21,
      ii. a catalyst A, where the catalyst comprises at least one metal siloxane-silanol(ate) compound, where the metal siloxane-silanol(ate) compound is defined according to any one of the embodiments 1, 11 to 15, 19 to 21 or 23,
      iii. a catalyst B, where the catalyst is defined according to any one of the embodiments 2 to 4 or 18 to 21 or 23,
      iv. at least one crosslinker, according to any one of the embodiments 8 or 18 to 20,
   b. mixing the composition, provided in a., using mechanical and/or thermal energy.
27. Method for producing a composition, wherein said method comprises the following process steps:
   a. providing a composition comprising
      i. at least one α,ω-dihydroxypolyorganosiloxane, which has a kinematic viscosity, according to DIN 53019-1:2008-09, of at least 50,000 cSt,
      ii. a catalyst A, where the catalyst is TiPOSS or SnPOSS, TiPOSS being preferred,
      iii. a catalyst B, where the catalyst is dibutyltin dilaurate (DBTL), tin(II) 2-ethylhexanoate (tin octoate), zinc(II) 2-ethylhexanoate, zinc(II) neodecanoate, bismuth(III) tris(2-ethylhexanoate), bismuth(III) tris(neodecanoate), titanium tetraisopropylate, titanium tetrabutylate, aluminum sec-butylate, zirconium tetraisopropylate, zirconium tetrabutylate or mixtures thereof, bismuth(III) tris(neodecanoate) being preferred,
      iv. at least one crosslinker selected from the group consisting of oxime crosslinkers, such as vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane or mixtures thereof; or acetate crosslinkers, such as methyltriacetoxysilane,
   b. mixing the composition, provided in a., using mechanical and/or thermal energy.
28. Composition, obtainable by a method according to embodiment 26 or 27.
29. Use of a composition, according to any one of the embodiments 1 to 23 and/or 28, as a joint compound or sealant, adhesive or coating agent.
30. Sealant formulation comprising the following components:
   at least one hydroxy-functionalized polyorganosiloxane compound, according to any one of the embodiments 6, 7 or 21,
   at least one crosslinker, according to any one of the embodiments 8 or 18 to 20,
   at least two catalysts A and B, according to any one of the embodiments 1, 11 to 15, 19 to 21, 23, or 2 to 4, 18 to 21, 23,
   at least one plasticizer,
   at least one filler and
   at least one adhesion promoter.
31. Sealant formulation, according to embodiment 30, characterized in that the
   plasticizer is selected from the group of polydiorganosiloxanes without functional end groups, which are, thus, different from the hydroxy-functionalized polyorganosiloxane compounds that are used according to the invention, and/or liquid aliphatic or aromatic hydrocarbons, preferably those with molecular weights from about 50 to about 5,000, the volatility of which is low and which are sufficiently compatible with polysiloxanes or mixtures thereof,
   the fillers are selected from the group of highly dispersed, fumed or precipitated silicas, carbon black, quartz powder, chalk, and/or metal salts or metal oxides or mixtures thereof and
   the adhesion promoter is selected from the group of silane compounds, which have organic substituents on the silicon atom and which are different from the hydroxy-functionalized polyorganosiloxane compounds used according to the invention, or mixtures thereof.
32. Use of at least two catalysts A and B, according to any one of the embodiments 9 to 13, 17 to 19, 21, or 2 to 4, 16 to 19, 21, for the production of silicone compounds having a Shore A hardness of <50, preferably <25, particularly preferably ≤15.
33. Use, according to embodiment 30, for the production of silicone compounds having an elongation at break, according to DIN 53504:2017-03, S2 test geometry, of at least 150%, preferably at least 200%, particularly preferably at least 250%.
34. Sealants after the use of at least two catalysts A and B, according to any one of the embodiments 11 to 15, 19 to 21, 23, or 2 to 4, 18 to 21, 23, wherein the sealants have a curing time, the period of time, in which a 4 mm thick polymer test specimen is no longer gel-like internally and has hardened completely, of a maximum of 48 hours, preferably a maximum of 36 hours, particularly preferably a maximum of 24 hours.
35. Sealants, according to embodiment 34, wherein the sealants have a Shore A hardness of <50, preferably <25, particularly preferably ≤15.
36. Sealants, according to embodiment 34 or 35, wherein the sealants have an elongation at break, according to DIN 53504: 2017-03, S2 test geometry, of at least 150%, preferably at least 200%, particularly preferably at least 250%.

### EXAMPLES

### Example I

The catalytic effect of TiPOSS on the moisture-induced polymerization reaction of hydroxy-functionalized α,ω-dihydroxypolyorganosiloxanes with crosslinkers to form silicone polymers is well-known. Surprisingly, however, it has been found that the moisture-induced polymerization reaction of α,ω-dihydroxypolyorganosiloxanes with crosslinkers that have hydrolyzable leaving groups can be accelerated by using a mixture of heptaisobutyl POSS titanium(IV) ethoxide (TiPOSS) and catalysts based on titanium, bismuth, zinc, aluminum, zirconium and tin. Surprisingly it was found that the silicone polymers, which are produced using catalyst mixtures of TiPOSS and organometallic compounds, such as bismuth(III) tris(neodecanoate), have advantageous properties during processing and in the product properties. In essence, this means a larger processing window with generally faster curing. In addition, soft products become available that have a significantly increased stretch/elasticity.

The study of the activity of the catalyst mixtures of TiPOSS and the organometallic compounds consisting of titanium, bismuth, zinc, aluminum, zirconium and tin for curing the silicone compounds was conducted in comparison with the curing process with the use of just TiPOSS alone. For this purpose basic RTV-1 silicone formulations were used as an example, where said formulations were composed of an α,ω-dihydroxypolydimethylsiloxane (80,000 cSt) and a polydimethylsiloxane plasticizer (100 cSt). The crosslinkers that were used included oxime-releasing silanes (vinyl tris(2-pentanone oxime)silane and methyl tris(2-pentanone oxime)silane), a mixture of vinyl tris(2-propanone oxime)silane, methoxyvinyl di(2-propanone oxime)silane, dimethoxyvinyl (2-propanone oxime)silane as well as an acetate-releasing silane, methyltriacetoxysilane.

Then the addition of adhesion promoters (for example, 3-aminopropyltrimethoxysilane) and a fumed silica was initially omitted, in order to rule out the influence of these compounds on the curing speed. The impact of adhesion promoter and silica on the curing process was verified by means of an illustrative formulation using a catalyst mixture of TiPOSS and bismuth(III) tris(neodecanoate).

Experimental Part:

Raw materials used to produce the silicone polymers SP:

α,ω-dihydroxypolydimethylsiloxane, 80,000 cSt (CAS 70131-67-8)
polydimethylsiloxane, 100 cSt, Sigma-Aldrich (CAS 63148-62-9)
vinyl tris(2-pentanone oxime)silane, OS 1600, Nitrochemie (CAS 37859-55-5)
methyl tris(2-pentanone oxime)silane, OS 2600, Nitrochemie (CAS 58190-62-8)
mixture of vinyl tris(2-propanone oxime)silane, methoxyvinyl di(2-propanone oxime)silane,
dimethoxyvinyl (2-propanone oxime)silane, LM 100, Nitrochemie (CAS 795571-44-1) methyltriacetoxysilane, TCI Chemicals (CAS 4253-34-3)
fumed silica, 200 m²/g, Evonik (CAS 112945-52-5)
TiPOSS, 20%, dissolved in Hexamoll DINCH, BASF (CAS 166412-78-8, DINCH)
dibutyltin dilaurate, DBTL; Kosmos 19, Evonik (CAS 7758-7)
bismuth neodecanoate, Kat 315EU, Borchers (CAS 34364-26-6)
zinc(II) 2-ethylhexanoate, Kat 22, Borchers (CAS 301-10-0)
titanium tetraisopropylate, TCI Chemicals (CAS 546-68-9)
titanium tetrabutylate, TCI Chemicals (CAS 5593-70-4)
aluminum tri-sec-butylate, TCI Chemicals (CAS 2269-22-9)
zirconium tetraisopropylate, TCI Chemicals (CAS 23519-77-9)
zirconium tetrabutylate, TCI Chemicals (CAS 1071-76-7)
3-aminopropyltrimethoxysilane (AMMO), TCI Chemicals (CAS 13822-56-5)

### Production of the Necessary Silicone Compounds SP1 to SP5, SP16 to SP39 (Pentanone Oxime Crosslinker) and SP6 to SP10 (Propanone Oxime Crosslinker) for the Curing Tests

α,ω-dihydroxypolydimethylsiloxane 80,000 cSt and polydimethylsiloxane 100 cSt were mixed with the crosslinkers vinyl tris(2-pentanone oxime)silane and methyl tris(2-pentanone oxime)silane (SP1 to SP5, SP16 to SP39) or a mixture of vinyl tris(2-propanone oxime)silane, methoxyvinyl di(2-propanone oxime)silane and dimethoxyvinyl (2-propanone oxime)silane (SP6 to SP10) in the absence of air.

### Production of the Necessary Silicone Compounds SP11 to SP15 (Acetate Crosslinker) for the Curing Tests

α,ω-dihydroxypolydimethylsiloxane 80,000 cSt and polydimethylsiloxane 100 cSt were mixed in the absence of air. TiPOSS and the specified amount of mixture of TiPOSS and bismuth(III) tris(neodecanoate) as well as TiPOSS and DBTL, according to Table 1, were incorporated by stirring into the compound obtained.

### Testing of the Curing Characteristics of the Silicone Compounds SP1 to SP10, SP16 to SP35 and SP36 to SP39

The testing of the curing characteristics of the silicone compounds SP1 to SP10, SP16 to SP35 and SP36 to SP39 was conducted by determining the skin formation time, the tack-free time TF and the curing time on ˜4 mm thick test specimens at 23° C./50% relative humidity. The test specimens were formulated with TiPOSS, DBTL, bismuth neodecanoate, zinc(II) 2-ethylhexanoate, titanium tetraisopropylate, titanium tetrabutylate, aluminum tri-sec-butylate, zirconium tetraisopropylate, zirconium tetrabutylate and mixtures of TiPOSS and the aforementioned catalysts, according to Table 1, Table 2 and Table 3, and then cured.

### Testing of the Curing Characteristics of the Silicone Compounds SP11 to SP15

The testing of the curing characteristics of the silicone compounds SP11 to SP15 was conducted by determining the skin formation time, the tack-free time TF and the curing time on ˜4 mm thick test specimens at 23° C./50% relative humidity. The test specimens were mixed with the appropriate amount of methyltriacetoxysilane crosslinker and cured.

### Production and Testing of the Curing Characteristics of the Silicone Compounds SP40 to SP43

α,ω-dihydroxypolydimethylsiloxane 80,000 cSt and polydimethylsiloxane 100 cSt were mixed with the crosslinkers vinyl tris(2-pentanone oxime)silane and methyl tris(2-pentanone oxime)silane (SP40 and SP41) or a mixture of vinyl tris(2-propanone oxime)silane, methoxyvinyl di(2-propanone oxime)silane and dimethoxyvinyl (2-propanone oxime)silane (SP42 to SP43). Then silica, TiPOSS and the specified amount of mixture of TiPOSS and bismuth(III) tris(neodecanoate) and adhesion promoter were added and mixed. The silicone polymers, which were obtained, were cured at 23° C./50% relative humidity; and the skin formation time, the tack-free time TF and the curing time were determined on ˜4 mm thick test specimens.

TABLE 1
Components of the Silicone Compounds SP1 to SP15, Curing Characteristics at 23° C./50% Relative Humidity and Technical Specifications

| | Pentanone Oxime Crosslinker | | | | | Propanone Oxime crosslinker | | |
|---|---|---|---|---|---|---|---|---|
| Component | SP1 | SP2 | SP3 | SP4 | SP5 | SP6 | SP7 | SP8 |
| 1α,ω- | 62.1 | 62 | 62.1 | 62.1 | 62.1 | 62.1 | 62 | 62 |
| dihydroxydimethyl- | | | | | | | | |
| polysiloxane | | | | | | | | |
| 80,000 cSt | | | | | | | | |
| polydimethylsiloxane | 33.4 | 33 | 33.4 | 33.4 | 33.4 | 33.9 | 34 | 34 |
| 100 cSt | | | | | | | | |
| vinyl tris(2-pentanone | 2.2 | 2.2 | 2.2 | 2.2 | 2.2 | — | — | — |
| oxime)silane | | | | | | | | |
| methyl tris(2-pentanone | 2.2 | 2.2 | 2.2 | 2.2 | 2.2 | — | — | — |
| oxime)silane | | | | | | | | |
| mixture of vinyl | — | — | — | — | — | 4 | 4 | 4 |
| tris(2-propanone | | | | | | | | |
| oxime)silane; | | | | | | | | |
| methoxyvinyl | | | | | | | | |
| di(2-propanone | | | | | | | | |
| oxime)silane; | | | | | | | | |
| dimethoxyvinyl | | | | | | | | |
| (2-propanone | | | | | | | | |
| oxime)silane | | | | | | | | |
| methyltriacetoxysilane | — | — | — | — | — | — | — | — |
| TiPOSS | 0.05 | 0.1 | 0.05 | 0.05 | 0.05 | 0.05 | 0.1 | 0.05 |
| DBTL | — | — | 0.05 | — | — | — | — | 0.05 |
| bismuth neodecanoate | — | — | — | 0.05 | 0.083 | — | — | — |
| skin formation | 150 | 100 | 60 | 120 | 100 | 300 | 180 | 75 |
| time [min]¹ | | | | | | | | |
| tack-free time [min]² | 360 | 300 | 150 | 330 | 300 | 540 | 480 | 180 |
| curing time [h]³ | 24 | 24 | 20 | 20 | 16 | 48 | 48 | 22 |
| Shore A | 10 | 10 | 6 | 6 | 5 | 8 | 8 | 8 |
| [after 7 days]⁴ | | | | | | | | |
| tensile strength [kPa]⁵ | — | 160 | — | — | 130 | — | 180 | — |
| elongation at break [%]⁵ | — | 250 | — | — | 400 | — | 320 | — |
| | | Propanone Oxime crosslinker | | Acetate Oxime Crosslinker | | | | |
| | Component | SP9 | SP10 | SP11 | SP12 | SP13 | SP14 | SP15 |
| | 1α,ω- | 62.1 | 62.1 | 62.1 | 62.1 | 62.1 | 62.1 | 62.1 |
| | dihydroxydimethyl- | | | | | | | |
| | polysiloxane | | | | | | | |
| | 80,000 cSt | | | | | | | |
| | polydimethylsiloxane | 33.9 | 33.9 | 33.9 | 33.9 | 33.9 | 33.9 | 33.9 |
| | 100 cSt | | | | | | | |
| | vinyl tris(2-pentanone | — | — | — | — | — | — | — |
| | oxime)silane | | | | | | | |
| | methyl tris(2-pentanone | — | — | — | — | — | — | — |
| | oxime)silane | | | | | | | |
| | mixture of vinyl | 4 | 4 | — | — | — | — | — |
| | tris(2-propanone | | | | | | | |
| | oxime)silane; | | | | | | | |
| | methoxyvinyl | | | | | | | |
| | di(2-propanone | | | | | | | |
| | oxime)silane; | | | | | | | |
| | dimethoxyvinyl | | | | | | | |
| | (2-propanone | | | | | | | |
| | oxime)silane | | | | | | | |
| | methyltriacetoxysilane | — | — | 4 | 4 | 4 | 4 | 4 |
| | TiPOSS | 0.05 | 0.05 | 0.0025 | 0.005 | 0.005 | 0.0025 | 0.0025 |
| | DBTL | — | — | — | — | 0.005 | — | — |
| | bismuth neodecanoate | 0.05 | 0.083 | — | — | — | 0.0025 | 0.004 |
| | skin formation | 240 | 180 | 17 | 12 | 10 | 12 | 12 |
| | time [min]¹ | | | | | | | |
| | tack-free time [min]² | 540 | 480 | 80 | 60 | 50 | 80 | 60 |
| | curing time [h]³ | 30 | 24 | 30 | 30 | 24 | 24 | 22 |
| | Shore A | 4 | 3 | 7 | 6 | 7 | 6 | 4 |
| | [after 7 days]⁴ | | | | | | | |
| | tensile strength [kPa]⁵ | — | 120 | — | 113 | — | — | 105 |
| | elongation at break [%]⁵ | — | 450 | — | 300 | — | — | 325 |

— not determined
¹Period of time, during which the polymer surface is irreversibly lifted by touching it lightly with a wooden spatula.
²Period of time, during which the polymer surface has no tendency to stick after touching it lightly with a wooden spatula.
³Period of time, during which a 4 mm thick polymer test specimen is no longer gel-like internally and has completely hardened.
⁴ASTM D2240-15
⁵Based on DIN 53504: 2017-03, S2 test geometry

TABLE 2
Components of the Silicone Compounds SP16 to SP35, Curing Characteristics at 23° C./50% Relative Humidity

| | Component | SP16 | SP17 | SP18 | SP19 | SP20 | SP21 | SP22 | SP23 | SP24 | SP25 | SP26 | SP27 | SP28 | SP29 | SP30 | SP31 | SP32 | SP33 | SP34 | SP35 |
|---|---|---|---|---|---|---|---|---|---|---|---|---|---|---|---|---|---|---|---|---|---|
| 1 | α,ω | 62.1 | 62.1 | 62.1 | 62.1 | 62.1 | 62.1 | 62.1 | 62.1 | 62.1 | 62.1 | 62.1 | 62.1 | 62.1 | 62.1 | 62.1 | 62.1 | 62.1 | 62.1 | 62.1 | 62.1 |
| | dihydroxydimethyl- | | | | | | | | | | | | | | | | | | | | |
| | polysiloxane | | | | | | | | | | | | | | | | | | | | |
| | 80,000 cSt | | | | | | | | | | | | | | | | | | | | |
| 2 | polydimethylsiloxane | 33.4 | 33.4 | 33.4 | 33.4 | 33.4 | 33.4 | 33.4 | 33.4 | 33.4 | 33.4 | 33.4 | 33.4 | 33.4 | 33.4 | 33.4 | 33.4 | 33.4 | 33.4 | 33.4 | 33.4 |
| | 100 cSt | | | | | | | | | | | | | | | | | | | | |
| 3 | vinyl tris(2- | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 |
| | pentanone | | | | | | | | | | | | | | | | | | | | |
| | oxime)silane | | | | | | | | | | | | | | | | | | | | |
| 4 | methyl tris(2- | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 | 2.2 |
| | pentanone | | | | | | | | | | | | | | | | | | | | |
| | oxime)silane | | | | | | | | | | | | | | | | | | | | |
| 5 | TiPOSS | — | — | — | — | — | — | — | — | 0.05 | 0.05 | 0.05 | 0.05 | 0.05 | 0.05 | 0.05 | 0.05 | 0.05 | 0.05 | 0.05 | 0.05 |
| 6 | DBTL | 0.1 | — | — | — | — | — | — | — | — | — | — | — | — | — | — | — | — | — | — | — |
| 7 | bismuth | — | 0.1 | — | — | — | — | — | — | — | — | — | — | — | — | — | — | — | — | — | — |
| | neodecanoate | | | | | | | | | | | | | | | | | | | | |
| 8 | zinc 2-ethylhexanoate | — | — | 0.01 | — | — | — | — | — | 0.05 | 0.083 | — | — | — | — | — | — | — | — | — | — |
| 9 | titanium | — | — | — | 0.01 | — | — | — | — | — | — | 0.05 | 0.083 | — | — | — | — | — | — | — | — |
| | tetraisopropylate | | | | | | | | | | | | | | | | | | | | |
| 10 | titanium | — | — | — | — | 0.1 | — | — | — | — | — | — | — | 0.05 | 0.083 | — | — | — | — | — | — |
| | tetrabutylate | | | | | | | | | | | | | | | | | | | | |
| 11 | aluminum | — | — | — | — | — | 0.1 | — | — | — | — | — | — | — | — | 0.05 | 0.083 | — | — | — | — |
| | tri-sec-butylate | | | | | | | | | | | | | | | | | | | | |
| 12 | zirconium | — | — | — | — | — | — | 0.1 | — | — | — | — | — | — | — | — | — | 0.005 | 0.083 | — | — |
| | tetrabutylate | | | | | | | | | | | | | | | | | | | | |
| 13 | ziroconium | — | — | — | — | — | — | — | 0.1 | — | — | — | — | — | — | — | — | — | — | 0.05 | 0.083 |
| | tetrobutylate | | | | | | | | | | | | | | | | | | | | |
| 14 | skin | 50 | 100 | 100 | 90 | 100 | 120 | 220 | 230 | 120 | 90 | 90 | 90 | 100 | 90 | 100 | 90 | 140 | 130 | 130 | 130 |
| | formation | | | | | | | | | | | | | | | | | | | | |
| | time [min]¹ | | | | | | | | | | | | | | | | | | | | |
| 15 | tack-free time | 80 | 300 | 260 | 250 | 320 | 320 | — | — | 225 | 180 | 250 | 250 | 240 | 225 | 260 | 240 | 300 | 300 | 300 | 300 |
| | [min]² | | | | | | | | | | | | | | | | | | | | |
| 16 | curing time [h]³ | 28 | 23 | 24 | 24 | 22 | 21 | 23 | 23 | 22 | 24 | 24 | 24 | 24 | 20 | 24 | 22 | 24 | 24 | 24 | 24 |
| 17 | Shore A | 5 | 5 | 7 | 7 | 8 | 7 | 7 | 7 | 7 | 8 | 9 | 7 | 8 | 8 | 9 | 8 | 7 | 8 | 8 | 8 |
| | [after 7 days]⁴ | | | | | | | | | | | | | | | | | | | | |

^{1 to 4}See footnote to Table 1

Table 3 describes the curing of silicone polymers comprising catalyst systems that have, in addition to TiPOSS and DBTL, a third metal catalyst component (SP36 to SP39). The third catalyst component, used for this purpose, was bismuth neodecanoate, titanium tetrabutylate, aluminum tri-sec-butylate and zirconium tetrabutylate, since they show increased catalytic activity as individual catalysts. Here, too, it can be noted, in general, that the skin formation time, the tack-free time and the curing time are reduced. However, the result is not an extended processing window.

TABLE 3
Components of the Silicone Compounds SP36 to SP39, Curing
Characteristics at 23° C./50% Relative Humidity

| | Component | SP36 | SP37 | SP38 | SP39 |
|---|---|---|---|---|---|
| 1 | α,ω-dihydroxydimethylpolysiloxane 80,000 cSt | 62.1 | 62.1 | 62.1 | 62.1 |
| 2 | polydimethylsiloxane 100 cSt | 33.4 | 33.4 | 33.4 | 33.4 |
| 3 | vinyl tris(2-pentanone oxime)silane | 2.2 | 2.2 | 2.2 | 2.2 |
| 4 | methyl tris(2-pentanone oxime)silane | 2.2 | 2.2 | 2.2 | 2.2 |
| 5 | TiPOSS | 0.05 | 0.05 | 0.05 | 0.05 |
| 6 | DBTL | 0.025 | 0.025 | 0.025 | 0.025 |
| 7 | bismuth neodecanoate | 0.025 | — | — | 0.025 |
| 8 | titanium tetrabutylate | — | 0.025 | — | — |
| 9 | aluminum tri-sec-butylate | — | — | 0.025 | — |
| 10 | zirconium tetrabutylate | — | — | — | 0.025 |
| 11 | skin formation time [min]¹ | 90 | 60 | 90 | 100 |
| 12 | tack-free time [min]² | 210 | 180 | 200 | 220 |
| 13 | curing time [h]³ | 24 | 20 | 20 | 22 |
| 14 | Shore A [after 7 days]⁴ | 10 | 7 | 6 | 4 |

^{1 to 4}See footnote to Table 1

Table 4 lists the curing characteristics and the technical specifications of industry standard silicone polymer formulations (including sealants) that comprise silica and adhesion promoter, in addition to the components of the formulations specified in the Tables 1 to 3, SP2, SP5, SP7 and SP10. In these cases faster curing of the TiPOSS/bismuth(III) tris(neodecanoate) could also be determined. Softer products are obtained with simultaneously improved elongation properties.

TABLE 4
Curing Characteristics and Technical Specifications of Exemplary
Silicone Formulations, determined at 23° C./50% Relative Humidity

| | Component | SP40 | SP41 | SP42 | SP43 |
|---|---|---|---|---|---|
| 1 | α,ω-dihydroxydimethylpolysiloxane 80,000 cSt | 56.1 | 56.1 | 62.1 | 62.1 |
| 2 | polydimethylsiloxane 100 cSt | 33.4 | 33.4 | 33.9 | 33.9 |
| 3 | vinyl tris(2-pentanone oxime)silane | 2.2 | 2.2 | — | — |
| 4 | methyl tris(2-pentanone oxime)silane | 2.2 | 2.2 | — | — |
| 5 | mixture of vinyl tris(2-propanone oxime)silane; | — | — | 4 | 4 |
| | methoxyvinyl di(2-propanone oxime)silane; | | | | |
| | dimethoxyvinyl (2-propanone oxime)silane | | | | |
| 6 | silica 200 m²/g | 5 | 5 | 5 | 5 |
| 7 | 3-aminopropyltrimethoxysilane | 1 | 1 | 1 | 1 |
| 8 | TiPOSS | 0.1 | 0.05 | 0.1 | 0.05 |
| 9 | bismuth neodecanoate | — | 0.083 | — | 0.083 |
| 10 | skin formation time [min]¹ | 90 | 90 | 180 | 180 |
| 11 | tack-free time [min]² | 280 | 280 | 450 | 420 |
| 12 | curing time [h]³ | 22 | 16 | 24 | 20 |
| 13 | Shore A [after 7 days]⁴ | 10 | 7 | 6 | 4 |
| 14 | tensile strength [kPa]⁵ | 250 | 250 | 320 | 300 |
| 15 | elongation at break [%]⁵ | 375 | 425 | 600 | 700 |

^{1 to 4}See footnote to Table 1

As can be seen from above, the user has the following advantages, when silicone polymers, comprising TiPOSS, are catalytically modified with the additional use of metal catalysts, such as bismuth neodecanoate, zinc(JJ) 2-ethylhexanoate, titanium tetraisopropylate, titanium tetrabutylate, aluminum tri-sec-butylate, zirconium tetraisopropylate, zirconium tetrabutylate or dibutyltin dilaurate:

1. The further addition of bismuth(III) tris(neodecanoate) causes faster curing or, more specifically, complete hardening of the silicone polymers. The skin formation time and the tack-free time are not as accelerated as much as when TiPOSS is added. This means a larger processing window, since the polymers can still be manipulated in the range of the skin formation time.
2. With the additional use of bismuth neodecanoate, significantly softer products are obtained, which also have a significantly higher level of elongation at break. This is particularly advantageous in applications, where components, which move a lot or in opposite directions, have to be sealed, glued or connected.
3. The additional addition of dibutyltin dilaurate to silicone polymer blends, which comprise TiPOSS, results in faster curing or, more specifically, complete hardening of the silicone polymers than with the use of just TiPOSS alone.
4. The use of metal catalysts, such as zinc(II) 2-ethylhexanoate, titanium tetraisopropylate, titanium tetrabutylate, aluminum tri-sec-butylate, zirconium tetraisopropylate and zirconium tetrabutylate, in a mixture with TiPOSS is suitable for covering the curing characteristics, known from the sole use of TiPOSS in silicone polymers, to their full extent.

### CONCLUSION

The skin formation time, the tack-free time and the curing time in silicone polymer systems that are produced with a pentanone oxime crosslinker (SP1), propanone oxime crosslinker (SP6) or acetoxy crosslinker (SP11) using TiPOSS as a catalyst are listed in Table 1. Further addition of TiPOSS to SP1, SP6 (0.05 parts by weight, respectively) or SP11 (0.0025 parts by weight) to initiate, for example, faster curing characteristics (SP2, SP7 and SP12) leads to a reduction in the skin formation and tack-free time, the curing time being otherwise unchanged.

The curing characteristics of corresponding silicone polymer systems, which, in analogy to SP2, are produced using exclusively the metal catalysts dibutyltin dilaurate, bismuth neodecanoate, zinc(II) 2-ethylhexanoate, titanium tetraisopropylate, titanium tetrabutylate, aluminum tri-sec-butylate, zirconium tetraisopropylate and zirconium tetrabutylate SP16 to SP23, are shown in Table 2. This table shows that silicone polymers using bismuth(III) tris (neodecanoate) (SP17), titanium tetrabutylate (SP20), aluminum tri-sec-butylate and zirconium tetrabutylate lead to faster curing, with comparatively the same or longer time for the skin formation and tack-free time. The DBTL-catalyzed silicone polymer (SP16) exhibits a faster skin formation time and tack-free time, compared to SP2, with a slower curing time.

The curing characteristics of silicone polymers, based on metal catalyst mixtures of TiPOSS and dibutyltin dilaurate, bismuth neodecanoate, zinc(II) 2-ethylhexanoate, titanium tetraisopropylate, titanium tetrabutylate, aluminum tri-sec-butylate, zirconium tetraisopropylate and zirconium tetrabutylate, are listed in SP3 to SP5, S8 to SP10, SP24 to SP35. On the whole, the addition of DBTL to SP1, SP6 (0.05 parts by weight) or SP11 (0.0025 parts by weight) results in accelerated curing characteristics, with a comparatively shortened curing time (SP3, SP8 and SP13). Particularly significant is the addition of bismuth(III) tris(neodecanoate) to SP1, SP6 (0.05 parts by weight) or SP11 (0.0025 parts by weight). Compared to TiPOSS and all of the other tested TiPOSS/metal catalyst mixtures, the result of such an addition is a smaller reduction in the skin formation and tack-free time, with a significant reduction in the curing time (SP4, SP9 and SP14). On the whole, it is apparent that the curing characteristics can be controlled over a wide range by means of the catalyst mixtures, composed of TiPOSS and dibutyltin dilaurate, bismuth neodecanoate, zinc(II) 2-ethylhexanoate, titanium tetraisopropylate, titanium tetrabutylate, aluminum tri-sec-butylate, zirconium tetraisopropylate and zirconium tetrabutylate, mentioned in Table 1 and Table 2.

A further increase in the amount of bismuth neodecanoate in SP5, SP9 (0.033 parts by weight) and SP15 (0.0015 parts by weight) results in a further shortening of the skin formation and tack-free times. A comparison with SP2, SP7 and SP12 shows that these values are on the same level, with significantly shorter curing times for SP5, SP10 and SP15. In addition to the aforementioned curing characteristics, these polymers are significantly softer and also have a significantly higher level of stretch (particularly pronounced in systems that were obtained on the basis of oxime crosslinkers (SP5 and SP 10)).

1. Composition, comprising at least one hydroxy-functionalized polyorganosiloxane compound, at least one crosslinker and at least two catalysts A and B, where the catalyst A is selected from the group of metal siloxane-silanol(ate) compounds; and catalyst B is selected from a group of catalysts that does not comprise metal siloxane-silanol(ate) compounds.

2. Composition, as claimed in claim 1, characterized in that the catalyst B is selected from the group of organometallic compounds.

3. Composition, as claimed in claim 1, characterized in that the catalyst B is selected from the group consisting of tetraalkyl titanates, such as tetramethyl titanate, tetraethyl titanate, tetra-n-propyl titanate, tetraisopropyl titanate, tetra-n-butyl titanate, tetraisobutyl titanate, tetra-sec-butyl titanate, tetraoctyl titanate, tetra(2-ethylhexyl)titanate, dialkyl titanates ((RO)₂TiO₂, where R stands, for example, for isopropyl, n-butyl, isobutyl), such as isopropyl-n-butyl titanate; titanium acetylacetonate chelates, such as diisopropoxy bis(acetylacetonate)titanate, diisopropoxy bis(ethyl acetylacetonate)titanate, di-n-butyl bis(acetylacetonate)titanate, di-n-butyl bis(ethyl acetoacetate)titanate, triisopropoxide bis(acetylacetonate)titanate, zirconium tetraalkylates, such as zirconium tetraethylate, zirconium tetrabutylate, zirconium tetrabutyrate, zirconium tetrapropylate, zirconium carboxylates, such as zirconium diacetate; zirconium acetylacetonate chelates, such as zirconium tetra(acetylacetonate), tributoxyzirconium acetylacetonate, dibutoxyzirconium (bisacetylacetonate), aluminum trisalicylates, such as aluminum triisopropylate, aluminum sec-butylate; aluminum acetylacetonate chelates, such as aluminum tris(acetylacetonate) and aluminum tris(ethyl acetylacetonate); organotin compounds, such as dibutyltin dilaurate (DBTL), dibutyltin maleate, dibutyltin diacetate, tin(II) 2-ethylhexanoate (tin octoate), tin naphthenate, dimethyltin dineodecanoate, dioctyltin dineodecanoate, dimethyltin dioleate, dioctyltin dilaurate, dimethyltin mercaptides, dibutyltin mercaptides, dioctyltin mercaptides, dibutyltin dithioglycolate, dioctyltin glycolate, dimethyltin glycolates; a solution of dibutyltin oxide, reaction products of zinc salts and organic carboxylic acids (carboxylates), such as zinc(II) 2-ethylhexanoate or zinc(II) neodecanoate, mixtures of bismuth and zinc carboxylates, reaction products of calcium salts and organic carboxylic acids (carboxylates), such as calcium bis(2-ethylhexanoate) or calcium neodecanoate, reaction products of sodium salts and organic carboxylic acids (carboxylates), such as sodium (2-ethylhexanoate) or sodium neodecanoate, mixtures of calcium and sodium carboxylates, reaction products of bismuth salts and organic carboxylic acids, such as bismuth(III) tris(2-ethylhexanoate) and bismuth(III) tris(neodecanoate) as well as bismuth complex compounds, organolead compounds, such as lead octylate, organovanadium compounds or mixtures thereof; selected preferably from bismuth, zinc, aluminum, calcium, sodium, and/or zirconium carboxylates; selected most preferably from dibutyltin dilaurate (DBTL), tin(II) 2-ethylhexanoate (tin octoate), zinc(II) 2-ethylhexanoate, zinc(II) neodecanoate (tin neodecanoate), bismuth(III) tris(2-ethylhexanoate), bismuth(III) tris(neodecanoate) (bismuth neodecanoate), titanium tetraisopropylate, titanium tetrabutylate, aluminum sec-butylate, zirconium tetraisopropylate, zirconium tetrabutylate, calcium bis(2-ethylhexanoate), sodium (2-ethylhexanoate) or mixtures thereof; extreme preference being given to bismuth(III) tris(neodecanoate), bismuth(III) tris(2-ethylhexanoate) or mixtures thereof; bismuth(III) tris(neodecanoate being extremely preferred.

4. Composition, as claimed in claim 1, characterized in that the hydroxy-functionalized polyorganosiloxane compound is an α,ω-dihydroxypolyorganosiloxane.

5. Composition, as claimed in claim 4, characterized in that the α,ω-dihydroxypolyorganosiloxane has a kinematic viscosity, according to DIN 53019-1:2008-09, of at least 10,000 cSt, preferably at least 20,000 cSt, more preferably at least 50,000 cSt, most preferably a kinematic viscosity of about 80,000 cSt.

6. Composition, as claimed in claim 1, characterized in that the crosslinker is selected from the group consisting of oxime crosslinkers, such as vinyl tris(2-pentanone oxime)silane, ethyl tris(2-propanone oxime)silane, methyl tris(2-pentanone oxime)silane, vinyl tris(2-propanone oxime)silane, methoxyvinyl di(2-propanone oxime)silane, dimethoxyvinyl (2-propanone oxime)silane, methyl tris(2-butanone oxime)silane, phenyl tris(2-butanone oxime)silane, vinyl tris(2-butanone oxime)silane and tetra(2-butanone oxime)silane or mixtures thereof; acetate crosslinkers, such as methyltriacetoxysilane, ethyltriacetoxysilane, propyltriacetoxysilane or vinyltriacetoxysilane or mixtures thereof; lactate crosslinkers, such as tris(ethyl lactate)methylsilane or tris(ethyl lactate)vinylsilane or mixtures thereof; salicylate crosslinkers, such as tris(2-ethylhexyl salicylate)vinylsilane, tris(2-ethylhexyl salicylate)methylsilane, tris(2-ethylhexyl salicylate)propylsilane or mixtures thereof; or a mixture of all of the aforementioned crosslinkers.

7. Composition, as claimed in claim 1, characterized in that the crosslinker is selected from the group consisting of oxime crosslinkers, such as vinyl tris(2-pentanone oxime)silane, ethyl tris(2-propanone oxime)silane, methyl tris(2-pentanone oxime)silane, vinyl tris(2-propanone oxime)silane, methoxyvinyl di(2-propanone oxime)silane, dimethoxyvinyl (2-propanone oxime)silane, methyl tris(2-butanone oxime)silane, phenyl tris(2-butanone oxime)silane, vinyl tris(2-butanone oxime)silane and tetra(2-butanone oxime)silane or mixtures thereof; acetate crosslinkers, such as methyltriacetoxysilane, ethyltriacetoxysilane, propyltriacetoxysilane or vinyltriacetoxysilane or mixtures thereof; or a mixture of all of the aforementioned crosslinkers.

8. Composition, as claimed in claim 1, characterized in that the crosslinker is selected from the group consisting of oxime crosslinkers, such as vinyl tris(2-pentanone oxime)silane, ethyl tris(2-propanone oxime)silane, methyl tris(2-pentanone oxime)silane, vinyl tris(2-propanone oxime)silane, methoxyvinyl di(2-propanone oxime)silane, dimethoxyvinyl (2-propanone oxime)silane, methyl tris(2-butanone oxime)silane, phenyl tris(2-butanone oxime)silane, vinyl tris(2-butanone oxime)silane and tetra(2-butanone oxime)silane or mixtures thereof.

9. Composition, as claimed in claim 1, characterized in that the metal siloxane-silanol(ate) compound has the general formula R*_{q}SiᵣOₛMₜ, where each R* is selected, independently of each other, from the group consisting of optionally substituted C1 to C20 alkyl, optionally substituted C3 to C6 cycloalkyl, optionally substituted C2 to C20 alkenyl, optionally substituted C6 to C10 aryl, —OH and —O—(C1 to C10 alkyl), each M being selected, independently of each other, from the group consisting of s and p block metals, d and f block transition metals, lanthanide and actinide metals and semimetals, in particular, from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi,
q is an integer from 4 to 19,
r is an integer from 4 to 10,
s is an integer from 8 to 30, and
t is an integer from 1 to 8.

10. Composition, as claimed in claim 9, characterized in that the metal siloxane-silanol(ate) compound is a metal silsesquioxane of the structure (IV), 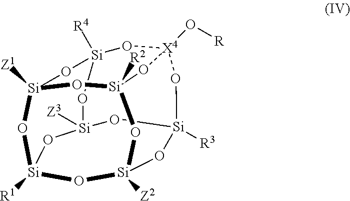
where
X⁴ is selected from the group selected from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi, particularly preferably from the group consisting of Zn, Ti, Zr, Hf, V, Fe, Sn and Bi, most preferably from the group consisting of Ti and Sn, Ti being most preferred, and
X⁴ is linked to OR, where R is selected from the group consisting of H, methyl, ethyl, propyl, butyl, octyl, isopropyl and isobutyl; Z¹, Z² and Z³ each denote, independently of each other, C1 to C20 alkyl, C3 to C8 cycloalkyl, C2 to C20 alkenyl and C5 to C10 aryl; in particular, are selected from the group consisting of methyl, ethyl, propyl, isopropyl, butyl, isobutyl, hexyl, heptyl, octyl, vinyl, allyl, butenyl and phenyl, and benzyl; and R¹, R², R³ and R⁴ each denote, independently of each other, C1 to C20 alkyl, C3 to C8 cycloalkyl, C2 to C20 alkenyl, and C5 to C10 aryl, in particular, are selected from the group consisting of methyl, ethyl, propyl, isopropyl, butyl, isobutyl, hexyl, heptyl, octyl, vinyl, allyl, butenyl and phenyl, and benzyl.

11. Composition, as claimed in claim 10, characterized in that the metal siloxane-silanol(ate) compound is a metal silsesquioxane of the structure (IVb), 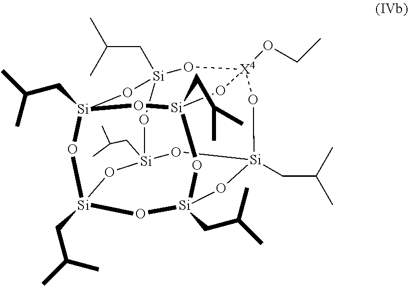
where
X⁴ is selected from the group consisting of metals of the 1st, 2nd, 3rd, 4th, 5th, 8th, 10th and 11th subgroup and metals of the 1st, 2nd, 3rd, 4th and 5th main group, preferably from the group consisting of Na, Zn, Sc, Nd, Ti, Zr, Hf, V, Fe, Pt, Cu, Ga, Sn and Bi; particularly preferably from the group consisting of Zn, Ti, Zr, Hf, V, Fe, Sn and Bi; most preferably from the group consisting of Ti (and is, therefore, heptaisobutyl POSS titanium(IV) ethoxide (TiPOSS)) and Sn (and is, therefore, heptaisobutyl POSS tin(IV) ethoxide (SnPOSS)), and most preferably Ti (and is, therefore, heptaisobutyl POSS titanium(IV) ethoxide (TiPOSS)).

12. Composition, as claimed in claim 1, characterized in that the metal siloxane-silanol(ate) compound is present in a molar concentration in the range of 0.000001 to 0.01 mol/kg, in particular, 0.00005 to 0.005 mol/kg or 0.00007 to 0.001 mol/kg, in each case based on the total weight of the composition.

13. Composition, as claimed in claim 1, characterized in that the metal siloxane-silanol(ate) compound is present in a proportion by weight of 0.001 to 0.5%, preferably 0.006 to 0.1%.

14. Composition, as claimed in claim 1, characterized in that the crosslinker is selected from the group consisting of oxime crosslinkers, such as vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane or mixtures thereof; or acetate crosslinkers, such as methyltriacetoxysilane; and catalyst A is selected from the group consisting of mononuclear metallized silsesquioxanes of the structural formula (IV) or mixtures thereof; and catalyst B is selected from the group consisting of dibutyltin dilaurate (DBTL), tin(II) 2-ethylhexanoate (tin octoate), zinc(II) 2-ethylhexanoate, zinc(II) neodecanoate, calcium bis(2-ethylhexanoate), sodium (2-ethylhexanoate), bismuth(III) tris(2-ethylhexanoate), bismuth(III) tris(neodecanoate), titanium tetraisopropylate, titanium tetrabutylate, aluminum sec-butylate, zirconium tetraisopropylate, zirconium tetrabutylate or mixtures thereof.

15. Composition, as claimed in claim 1, characterized in that the catalysts A and B are present in a relative ratio between 1:10 and 10:1; more preferably the catalysts A and B are present in a relative ratio between 1:8 and 8:1; particularly preferably the catalysts A and B are present in a relative ratio between 1:5 and 5:1, even more preferably the catalysts A and B are present in a relative ratio between 1:2 to 2:1; most preferably in a relative ratio of 0.9:1.1 to 1.1:0.9; extremely preferably in a relative ratio of 1:1, based on percent by weight.

16. Composition, as claimed in claim 15, characterized in that catalyst A is TiPOSS or SnPOSS; and catalyst B is selected from the group consisting of bismuth(III) tris(neodecanoate), dibutyltin dilaurate (DBTL), zinc(II) 2-ethylhexanoate, zirconium tetraisopropylate, zirconium tetrabutylate or mixtures thereof; catalyst A is particularly preferably TiPOSS; and catalyst B is bismuth(III) tris(neodecanoate).

17. Method for producing a composition, wherein said method comprises the following process steps:
a. providing a composition comprising
i. at least one α,ω-dihydroxypolyorganosiloxane, which has a kinematic viscosity, according to DIN 53019-1:2008-09, of at least 50,000 cSt,
ii. a catalyst A, where the catalyst is TiPOSS or SnPOSS, TiPOSS being preferred,
iii. a catalyst B, where the catalyst is dibutyltin dilaurate (DBTL), tin(II) 2-ethylhexanoate (tin octoate), zinc(II) 2-ethylhexanoate, zinc(II) neodecanoate, bismuth(III) tris(2-ethylhexanoate), bismuth(III) tris(neodecanoate), titanium tetraisopropylate, titanium tetrabutylate, aluminum sec-butylate, zirconium tetraisopropylate, zirconium tetrabutylate or mixtures thereof, bismuth(III) tris(neodecanoate) being preferred,
iv. at least one crosslinker selected from the group consisting of oxime crosslinkers, such as vinyl tris(2-pentanone oxime)silane, methyl tris(2-pentanone oxime)silane, vinyl tris(2-propanone oxime)silane, methoxyvinyl di(2-propanone oxime)silane and dimethoxyvinyl (2-propanone oxime)silane or mixtures thereof; or acetate crosslinkers, such as methyltriacetoxysilane,
b. mixing the composition, provided in a., using mechanical and/or thermal energy.

18. Composition, obtainable by a method, as claimed in claim 16.

19. Sealant formulation comprising the following components:
at least one hydroxy-functionalized polyorganosiloxane compound,
at least one crosslinker,
at least two catalysts A and B,
at least one plasticizer,
at least one filler and
at least one adhesion promoter.

20. Use of at least two catalysts A and B, as claimed in claim 2, for the production of silicone compositions having a Shore A hardness of <50, preferably <25, particularly preferably ≤15.

21. Use, as claimed in claim 20, for the production of silicone compounds having an elongation at break, according to DIN 53504:2017-03, S2 test geometry, of at least 150%, preferably at least 200%, particularly preferably at least 250%.

22. Sealants after the use of at least two catalysts A and B, as claimed in claim 2, wherein the sealants have a curing time, the period of time, in which a 4 mm thick polymer test specimen is no longer gel-like internally and has hardened completely, of a maximum of 48 hours, preferably a maximum of 36 hours, particularly preferably a maximum of 24 hours.
